(19) United States
(12) Patent Application Publication
(10) Pub. No.: US 2011/0254822 A1
(43) Pub. Date: Oct. 20, 2011

(54) DRIVE CIRCUIT, DISPLAY DEVICE AND METHOD FOR SELF-DETECTING AND SELF-REPAIRING DRIVE CIRCUIT

(76) Inventors: Shinsuke Anzai, Osaka (JP); Hiroaki Fujino, Osaka (JP); Masafumi Katsutani, Osaka (JP)

(21) Appl. No.: 13/131,419

(22) PCT Filed: Nov. 25, 2009
(86) PCT No.: PCT/JP2009/069839

§ 371 Date: May 26, 2011

(30) Foreign Application Priority Data
Nov. 28, 2008 (JP) 2008-304735

(51) Int. Cl. G09G 5/00

(52) U.S. Cl. 345/211; 345/204

(57) ABSTRACT

A drive circuit (20) of the present invention includes an output circuit block (30), a spare output circuit block (40), a reference output circuit block (41), a comparing and determining circuit (50), and switching circuits (60) and (61). During self-detection, the switching circuit (60) selects one output circuit from the output circuit block (40), disconnects the selected output circuit from a data line of a display panel (80), and connects the spare output circuit block (40) to the data line of the display panel (80). The comparing and determining circuit (50) compares a test output signal from the selected output circuit with a reference output signal from the reference output circuit block (41) and, in accordance with a result of the comparison, determines whether or not the selected output circuit is defective or not. This achieves a drive circuit capable of detecting a failure in an output circuit while driving a display panel without causing a defect in display.

### TECHNICAL FIELD

The present invention relates to a display device including a drive circuit having a self-detecting and self-repairing function.

### BACKGROUND ART

In a liquid crystal display device or the like, a display is carried out by mounting, on a display panel, a plurality of drive circuits constituted by semiconductor integrated circuits (LSI) and causing the drive circuits to output gray-scale voltages to the display panel.

In such a display device, a failure in any of the drive circuits is recognized directly by a user as a defect in display. When such a failure occurs, it is necessary for the display device's manufacturer to promptly repair the failed part and, if possible, it is desirable that the manufacturer quickly finish repairing in the place where the user uses the display device. Such a control substrate as to process display signals would be easily replaced as it is connected to the display panel through a connector. However, the drive circuit, connected directly to the display panel without a connector or the like therebetween, can hardly be replaced in the place where the user uses the display device.

Further, it is hard to replace or repair a drive circuit after completion of a product in which the drive circuit has been integrated with a display panel.

For this reason, Patent Literature 1 discloses a technique for allowing redundancy for a drive circuit of a product in which the drive circuit has been integrated with a display panel and making it possible to repair the drive circuit even after completion of the product. Further, Patent Literature 1 also discloses a technique for, by providing a spare output circuit in the drive circuit, comparing an output of one output circuit in the drive circuit with an output of the spare output circuit, and determining whether those outputs are equal to each other, carrying out self-detection to confirm that the output circuit is normal, and for, during the self-detection, driving the display panel by using the spare output circuit instead of the output circuit under detection.

### CITATION LIST

Patent Literature 1
Japanese Translation of PCT International Publication Tokuhyo No. 2004-511022 A (Publication Date: Apr. 8, 2004)

### SUMMARY OF INVENTION

### Technical Problem

In Patent Literature 1, the display panel is driven by the spare output circuit with the output circuit under detection disconnected from the display panel, and the quality of the output circuit under detection is determined by comparing the output of the output circuit under detection with the output of the spare output circuit. However, because the output circuit under detection and the spare output circuit simultaneously receive gray-scale data by which a display is carried out, there is a limit to data for use in comparison.

According to the technique described in Patent Literature 1, when an analog clamp voltage is selected and outputted, it is considered to be possible to detect a difference between the output of the output circuit under detection and the output of the spare output circuit by comparing part of display data with the analog clamp voltage. On the other hand, in a drive circuit in which multiple tones are achieved by digital data, DA conversion circuits (DAC circuits) are needed which output gray-scale voltages corresponding to the digital data and, in a 256-tone-display drive circuit, DAC circuits are needed which select 256 levels of gray-scale data. Because, for detection of a failure in any of the DAC circuits, it is necessary to compare all input data based on which 256 levels of gray-scale voltage are outputted, it is necessary to detect a failure by supplying the output circuit under detection and the spare output circuit with data irrelevant to the display data, with the output circuit under detection and the spare output circuit put in such a state as not to drive the display panel.

However, when, for detection of a failure in the output circuit, the output circuit under detection and the spare output circuit are put in such a state as not to drive the display panel, that data line of the display panel which is supposed to be driven by the output circuit under detection is not driven, with the result that there occurs a defect in display.

The present invention has been made in view of the foregoing problems, and it is an object of the present invention to achieve a drive circuit capable of detecting a failure in an output circuit while driving a display panel without causing a defect in display.

### Solution to Problem

In order to solve the foregoing problems, a drive circuit according to the present invention is a drive circuit having n (where n is a natural number of 2 or greater) output terminals through which video signals are outputted to a display device and means for detecting and repairing a defect in the drive circuit, the drive circuit including: n first output circuits, connected disconnectably to the output terminals, which convert input data into video signals; p or more (where p is a natural number of 1 to n) second output terminals, connected disconnectably to the output terminals, which convert input data into video signals; a third output circuit, not connected to any of the output terminals, which coverts input data into a video signal; switching means for selecting p output circuit(s) from among the first output circuits, disconnecting the p output circuit(s) from the output terminal(s), and connecting p output circuit(s) from among the second output circuits to the output terminal(s); comparing means for comparing the video signal from the first output circuit thus selected or each of the video signals from the first output circuits thus selected with the video signal from the third output circuit; and decision means for determining, in accordance with a comparison result sent from the comparing means, whether the first output circuit thus selected or any of the first output circuits thus selected is defective or not.

According to the foregoing configuration, the first output circuits are connected disconnectably to the output terminals and, during a normal operation, the switching means connects all of the first output circuits to a data line and none of the second output circuits to the data line. On the other hand, during self-detection, the switching means selects a first output circuit, disconnects it from the output terminal to which it has been connected, and connects a second output circuit to the output terminal. At this point in time, the comparing means compares the video signal from the selected first output circuit, disconnected from the output terminal, with the video signal from the third output circuit, and the decision means determines, in accordance with the comparison result, whether the selected first output circuit is defective or not.

That is, during self-detection, the first output circuits, excluding the selected first output circuit, and the second output circuit are connected to the output terminals to drive the display panel. Since the second output circuit takes care of driving the display panel instead of the selected first output circuit, which is to be subjected to failure detection, such an effect is brought about which makes it possible to achieve a drive circuit capable of detecting a failure in an output circuit while driving a display panel without causing a defect in display.

The drive circuit according to the present invention is preferably configured such that when the switching means selects the qth to q+p−1th (where q+p−1 is a natural number that is less than or equal to n) ones of the first output circuits, the switching means connects the rth (where r is a natural number that is less than q) one of the first output circuits to the rth one of the output terminals, connects the s+pth (where s is a natural number of q to n−p) one of the first output circuits to the sth one of the output terminals, and connects the second output circuit(s) to the tth (t is a natural number that is greater than n−p and less than or equal to n) one of the output terminals.

According to the foregoing configuration, when one of the first output circuits is selected (p=1), for example, those output circuits from a column of output circuits next to the selected first output circuit to the last column of output circuits output video signals during self-detection to those output terminals to which those output circuits from the selected first output circuit to a column of output circuits immediately preceding the last column of output circuits would be connected during normal driving, respectively. Further, during self-detection, the second output circuit outputs a video signal to the output terminal to which the last column of output circuits would be connected during normal driving. That is, to those output terminals from the output terminal to which the selected first output circuit is connected during normal driving to an output terminal immediately preceding the last column, the output circuits adjacent to those output circuits which would be connected to those output terminals during normal driving are connected; to the last column of output circuits, the second output circuit is connected. This makes it possible, even during self-detection, to use the first output circuits, excluding the selected first output circuit, and the second output circuit to drive the display panel without causing a defect in display.

The drive circuit according to the present invention is preferably configured such that the switching means connects the second output circuit(s) to the output terminal(s) from which the first output circuit(s) thus selected has/have been disconnected.

According to the foregoing configuration, during self-detection, the second output circuit outputs a video signal to the output terminal to which the selected first output circuit would be connected during normal driving. This makes it possible, even during self-detection, to use the first output circuits, excluding the selected first output circuit, and the second output circuit to drive the display panel without causing a defect in display.

The drive circuit according to the present invention is preferably configured to further include control means for inputting the input data to the first to third output circuits through a data bus through which the input data is supplied, wherein the control means carries out control so that the input data that is inputted to the first output circuit(s) thus selected and the input data that is inputted to the third output circuit take on different values.

The drive circuit according to the present invention is preferably configured such that: the data bus is constituted by first to third data buses; and the control means inputs the input data through the first data bus to the first output circuits excluding the first output circuit(s) thus selected and to the second output circuit(s), inputs the input data through the second data bus to the first output circuit(s) thus selected, and inputs the input data through the third data bus to the third output circuit.

The foregoing configuration makes it possible to supply input data for use in self-detection through the second and third data buses, thus making possible to shorten an amount of time for self-detection as compared with the case of supply of input data through a single data bus.

The drive circuit according to the present invention is preferably configured such that the control means inputs the input data to the first to third output circuits through a single data bus.

The foregoing configuration makes it possible to reduce the area of the drive circuit as compared with the case of provision of a plurality of data buses.

The drive circuit according to the present invention is preferably configured such that: the video signals are gray-scale voltages and the first to third output circuits include digital analog converters that convert the input data into the gray-scale voltages; and the comparing compares the gray-scale voltage(s) from the digital analog converter(s) included in the first output circuit(s) thus selected with the gray-scale voltage from the digital analog converter included in the third output circuit.

The drive circuit according to the present invention is preferably configured such that: the first output circuits include operational amplifiers as output buffers for the digital analog converters; each of the operational amplifiers operates as a comparator when that one of the first output circuits which includes that operational amplifier is selected by the switching means and is not connected to any one of the output terminals; and the comparing means is an operational amplifier that operates as the comparator.

Because, according to the foregoing configuration, the operational amplifiers of the first circuits can be used as comparing means, it is not necessary to provide comparing means separately from the first output circuits. This makes it possible to reduce the area of the drive circuit.

The drive circuit according to the present invention is preferably configured such that the third output circuit is connected to the operational amplifier that operates as the comparator.

The foregoing configuration makes it possible, with the operational amplifier, to compare a gray-scale voltage from the selected first output circuit with a gray-scale voltage from the third output circuit.

The drive circuit according to the present invention is preferably configured such that each of the operational amplifiers operates as a voltage follower when that one of the first output circuits which includes that operational amplifier is connected to one of the output terminals.

The drive circuit according to the present invention is preferably configured such that the decision means has a comparison result from the comparing means stored therein as an expected value in association with the input data inputted to the first output circuit thus selected or each of the first outputs thus selected and the third output circuit and, when the comparison result and the expected value are different, determines that the first output circuit thus selected is defective.

For example, an input signal having a gray scale of m is inputted to the selected first output circuit, and an input signal having a gray scale of m+1 is inputted to the third output circuit. It should be noted that a gray-scale voltage having a gray scale of m is lower than a gray-scale voltage having a gray scale of m+1. If the selected first output circuit is normal, the comparing means outputs a signal indicating that the gray-scale voltage inputted from the third output circuit is higher. On the other hand, if the selected first output circuit has a defect, and if the selected first output circuit can only output a high gray-scale voltage even upon receiving a signal having a gray scale of m, the comparing means outputs a signal indicating that the gray-scale voltage inputted from the selected first output circuit is higher.

In this way, the comparing means compares gray-scale voltages outputted from the selected first output circuit and the third output circuit, and output signals of different values depending on whether or not the selected first output circuit has a defect. Further, the decision means determines, in accordance with a signal outputted from the comparing means, whether the selected first output circuit is defective or not. Specifically, in such a case as mentioned above where an input signal having a gray scale of m is inputted to the selected first output circuit and an input signal having a gray scale of m+1 is inputted to the third output circuit, and if the decision means receives, from the comparing means, a signal indicating that the gray-scale voltage inputted from the selected first output circuit is higher, the decision means determines that the selected first output circuit is defective. On the other hand, if the decision means receives, from the comparing means, a signal indicating that the gray-scale voltage inputted from the third output circuit is higher, the decision means determines that the selected first output circuit is not defective.

This makes it possible to easily detect a defect in an output circuit and, if there is a defect in an output circuit, self-repair the defect.

A drive circuit according to the present invention is a drive circuit having n (where n is a natural number of 2 or greater) output terminals through which video signals are outputted to a display device and means for detecting and repairing a defect in the drive circuit, the drive circuit including: n first output circuits, connected disconnectably to the output terminals, which convert input data into video signals; u or more (where u is an even number of 2 to n) second output terminals, connected disconnectably to the output terminals, which convert input data into video signals; switching means for selecting u output circuits from among the first output circuits, disconnecting the u output circuits from the output terminals, and connecting u output circuits from among the second output circuits to the output terminals; comparing means for, with any two of the first output circuits thus selected serving as first and second selected output circuits respectively, comparing the video signal from the second selected output circuit; and decision means for determining, in accordance with a comparison result sent from the comparing means, whether any of the first output circuits thus selected is defective or not.

According to the foregoing configuration, the first output circuits are connected disconnectably to the output terminals and, during a normal operation, the switching means connects all of the first output circuits to the output terminals and none of the second output circuits to the output terminals. On the other hand, during self-detection, the switching means selects u first output circuits, disconnects them from the output terminals to which they have been connected, and connects u second output circuits to the output terminals. At this point in time, the comparing means compares two video signals from first and second selected output circuits selected from among the selected first output circuits disconnected from the output terminals, and the decision means determines, in accordance with the comparison result, whether any of the selected first output circuits is defective or not.

That is, during self-detection, the first output circuits, excluding the selected first output circuits, and the second output circuits are connected to the output terminals to drive the display panel. Since the second output circuits take care of driving the display panel instead of the selected first output circuits, which are to be subjected to failure detection, such an effect is brought about which makes it possible to achieve a drive circuit capable of detecting a failure in an output circuit while driving a display panel without causing a defect in display.

The drive circuit according to the present invention is preferably configured such that when the switching means selects the vth to v+u−1 th (where v+u−1 is a natural number that is less than or equal to n) ones of the first output circuits, the switching means connects the wth (where w is a natural number that is less than v) one of the first output circuits to the wth one of the output terminals, connects the x+uth (where x is a natural number of v to n−u) one of the first output circuits to the xth one of the output terminals, and connects the second output circuit(s) to the yth (y is a natural number that is greater than n−u and less than or equal to n) one of the output terminals.

According to the foregoing configuration, when two of the first output circuits are selected (u=2), for example, those output circuits from a column of output circuits next to the latter one of the selected first output circuits to the last column of output circuits output video signals during self-detection to those output terminals to which those output circuits from the selected first output circuit to a column of output circuits before one immediately preceding the last column of output circuits would be connected during normal driving, respectively. Further, during self-detection, the two second output circuits output video signals to the output terminals to which the last column of output circuits and its immediately preceding column of output circuits would be connected during normal driving. That is, to those output terminals from the output terminals to which the selected first output circuits would be connected during normal driving to an output terminal before one immediately preceding the last column, the output circuits adjacent but one to those output circuits which would be connected to those output terminals during normal driving are connected; to the last column of output circuits and its immediately preceding column of output circuits, the second output circuits are connected. This makes it possible, even during self-detection, to use the first output circuits, excluding the selected first output circuits, and the second output circuits to drive the display panel without causing a defect in display.

The drive circuit according to the present invention is preferably configured such that the switching means connects the second output circuits to the output terminals from which the first output circuits thus selected have been disconnected.

According to the foregoing configuration, during self-detection, the second output circuits output video signals to the output terminals to which the selected first output circuits would be connected during normal driving. This makes it possible, even during self-detection, to use the first output circuits, excluding the selected first output circuits, and the second output circuits to drive the display panel without causing a defect in display.

The drive circuit according to the present invention is preferably configured to further include control means for inputting the input data to the first and second output circuits, wherein the control means carries out control so that the input data that is inputted to the first selected output circuit and the input data that is inputted to the second selected output circuit take on different values.

The drive circuit according to the present invention may be configured such that: the video signals are gray-scale voltages and the first output circuits include digital analog converters that convert the input data into the gray-scale voltages; and the comparing means compares the gray-scale voltage from the digital analog converter included in the first selected output circuit and the gray-scale voltage from the digital analog converter included in the second selected output circuit.

The drive circuit according to the present invention is preferably configured such that: the first output circuits include operational amplifiers as output buffers for the digital analog converters; each of the operational amplifiers operates as a comparator when that one of the first output circuits which includes that operational amplifier is selected by the switching means and is not connected to any one of the output terminals; and the comparing means is an operational amplifier that operates as the comparator.

Because, according to the foregoing configuration, the operational amplifiers of the first circuits can be used as comparing means, it is not necessary to provide comparing means separately from the first output circuits. This makes it possible to reduce the area of the drive circuit.

The drive circuit according to the present invention is preferably configured such that each of the operational amplifiers operates as a voltage follower when that one of the first output circuits which includes that operational amplifier is connected to one of the output terminals.

The drive circuit according to the present invention is preferably configured the decision means has a comparison result from the comparing means stored therein as an expected value in association with the input data inputted to the first selected output circuit and the second selected output circuit and, when the comparison result and the expected value are different, determines that the first output circuit thus selected is defective.

For example, an input signal having a gray scale of m is inputted to the first selected output circuit, and an input signal having a gray scale of m+1 is inputted to the second selected output circuit. It should be noted that a gray-scale voltage having a gray scale of m is lower than a gray-scale voltage having a gray scale of m+1. If the first selected output circuit is normal, the comparing means outputs a signal indicating that the gray-scale voltage inputted from the second selected output circuit is higher. On the other hand, if either of the selected first output circuits has a defect, and if the selected first output circuit can only output a high gray-scale voltage even upon receiving a signal having a gray scale of m, the comparing means outputs a signal indicating that the gray-scale voltage inputted from the selected first output circuit is higher.

In this way, the comparing means compares gray-scale voltages outputted from the first and second selected output circuits, and output signals of different values depending on whether or not either of the selected first output circuits has a defect. Further, the decision means determines, in accordance with a signal outputted from the comparing means, whether either of the selected first output circuits is defective or not. Specifically, in such a case as mentioned above where an input signal having a gray scale of m is inputted to the first selected output circuit and an input signal having a gray scale of m+1 is inputted to the second selected output circuit, and if the decision means receives, from the comparing means, a signal indicating that the gray-scale voltage inputted from the first selected output circuit is higher, the decision means determines that either of the selected first output circuits is defective. On the other hand, if the decision means receives, from the comparing means, a signal indicating that the gray-scale voltage inputted from the second selected output circuit is higher, the decision means determines that the selected first output circuits are not defective.

This makes it possible to easily detect a defect in an output circuit and, if there is a defect in an output circuit, self-repair the defect.

The drive circuit according to the present invention may be configured to further include control means for inputting the first and second output circuits, wherein: the control means carries out control so that the input data that is inputted to the first selected output circuit and the input data that is inputted to the second selected output circuit take on different values; and the first output circuits include (i) sampling circuits that load the input data in a time-sharing manner and retain the input data and (ii) hold circuits that load in a time-sharing manner the input data retained in the sampling circuits and output the input data to the digital analog converters; and the control means inputs the input data to the sampling circuits during normal driving and, during self-detection, inputs the input data to the digital analog converters of the first output circuits thus selected.

A display device according to the present invention includes such a drive circuit as described above.

The foregoing configuration makes it possible to achieve a display device capable of detecting a failure in an output circuit of the drive circuit while carrying out a display without causing a defect in display.

A self-detecting and self-repairing method according to the present invention is a self-detecting and self-repairing method for detecting and repairing a defect in a drive circuit including (i) n (where n is a natural number of 2 or greater) output terminals through which video signals are outputted to a display device, (ii) n first output circuits, connected disconnectably to the output terminals, which convert input data into video signals, (iii) p or more (where p is a natural number of 1 to n) second output terminals, connected disconnectably to the output terminals, which convert input data into video signals, and (iv) a third output circuit, not connected to any of the output terminals, which coverts input data into a video signal, the self-detecting and self-repairing method including: a switching step of selecting p output circuit(s) from among the first output circuits, disconnecting the p output circuit(s) from the output terminal(s), and connecting p output circuit(s) from among the second output circuits to the output terminal(s); a comparing step of comparing the video signal from the first output circuit thus selected or each of the video signals from the first output circuits thus selected with the video signal from the third output circuit; and a decision step of determining, in accordance with a comparison result of the comparing step, whether the first output circuit thus selected or any of the first output circuits thus selected is defective or not.

According to the foregoing configuration, the first output circuits are connected disconnectably to the output terminals and, during a normal operation, all of the first output circuits are connected to the output terminals, and none of the second output circuits is connected to the output terminals. On the other hand, at the switching step, a selected first output circuit is disconnected from the output terminal to which it has been connected, and a second output circuit is connected to the output terminal. At the comparing step, the video signal from the selected first output circuit, disconnected from the output terminal, is compared with the video signal from the third output circuit, and at the decision step, it is determined, in accordance with the comparison result, whether the selected first output circuit is defective or not.

That is, during self-detection, the first output circuits, excluding the selected first output circuit, and the second output circuits are connected to the output terminals to drive the display panel. Since the second output circuit take care of driving the display panel instead of the selected first output circuit, which is to be subjected to failure detection, it is possible to achieve a drive circuit capable of detecting a failure in an output circuit while driving a display panel without causing a defect in display.

A self-detecting and self-repairing method according to the present invention is a self-detecting and self-repairing method for detecting and repairing a defect in a drive circuit including (i) n (where n is a natural number of 2 or greater) output terminals through which video signals are outputted to a display device, (ii) n first output circuits, connected disconnectably to the output terminals, which convert input data into video signals; (iii) u or more (where u is an even number of 2 to n) second output terminals, connected disconnectably to the output terminals, which convert input data into video signals, the self-detecting and self-repairing method including: a switching step of selecting u output circuits from among the first output circuits, disconnecting the u output circuits from the output terminals, and connecting u output circuits from among the second output circuits to the output terminals; a comparing step of, with any two of the first output circuits thus selected serving as first and second selected output circuits respectively, comparing the video signal from the first selected output circuit and the video signal from the second selected output circuit; and a decision step of determining, in accordance with a comparison result of the comparing step, whether any of the first output circuits thus selected is defective or not.

According to the foregoing configuration, the first output circuits are connected disconnectably to the output terminals and, during a normal operation, all of the first output circuits to are connected to the output terminals, and none of the second output circuits are connected to the output terminals. On the other hand, at the switching step, selected first output circuits are disconnected from the output terminals to which they have been connected, and second output circuits are connected to the output terminals. At the comparing step, video signals from one and the other of the selected first output circuits disconnected from the output terminals are compared with each other, and at the decision step, it is determined, in accordance with the comparison result, whether any of the selected first output circuits is defective or not.

That is, during self-detection, the first output circuits, excluding the selected first output circuits, and the second output circuits are connected to the output terminals to drive the display panel. Since the second output circuits take care of driving the display panel instead of the selected first output circuits, which are to be subjected to failure detection, it is possible to achieve a drive circuit capable of detecting a failure in an output circuit while driving a display panel without causing a defect in display.

### Advantageous Effects of Invention

As described above, a drive circuit according to the present invention is a drive circuit having n (where n is a natural number of 2 or greater) output terminals through which video signals are outputted to a display device and means for detecting and repairing a defect in the drive circuit, the drive circuit including: n first output circuits, connected disconnectably to the output terminals, which convert input data into video signals; p or more (where p is a natural number of 1 to n) second output terminals, connected disconnectably to the output terminals, which convert input data into video signals; a third output circuit, not connected to any of the output terminals, which coverts input data into a video signal; switching means for selecting p output circuit(s) from among the first output circuits, disconnecting the p output circuit(s) from the output terminal(s), and connecting p output circuit(s) from among the second output circuits to the output terminal(s); comparing means for comparing the video signal from the first output circuit thus selected or each of the video signals from the first output circuits thus selected with the video signal from the third output circuit; and decision means for determining, in accordance with a comparison result sent from the comparing means, whether the first output circuit thus selected or any of the first output circuits thus selected is defective or not.

As described above, a drive circuit according to the present invention is a drive circuit having n (where n is a natural number of 2 or greater) output terminals through which video signals are outputted to a display device and means for detecting and repairing a defect in the drive circuit, the drive circuit including: n first output circuits, connected disconnectably to the output terminals, which convert input data into video signals; u or more (where u is an even number of 2 to n) second output terminals, connected disconnectably to the output terminals, which convert input data into video signals; switching means for selecting u output circuits from among the first output circuits, disconnecting the u output circuits from the output terminals, and connecting u output circuits from among the second output circuits to the output terminals; comparing means for, with any two of the first output circuits thus selected serving as first and second selected output circuits respectively, comparing the video signal from the first selected output circuit and the video signal from the second selected output circuit; and decision means for determining, in accordance with a comparison result sent from the comparing means, whether any of the first output circuits thus selected is defective or not.

As described above, a self-detecting and self-repairing method according to the present invention is a self-detecting and self-repairing method for detecting and repairing a defect in a drive circuit including (i) n (where n is a natural number of 2 or greater) output terminals through which video signals are outputted to a display device, (ii) n first output circuits, connected disconnectably to the output terminals, which convert input data into video signals, (iii) p or more (where p is a natural number of 1 to n) second output terminals, connected disconnectably to the output terminals, which convert input data into video signals, and (iv) a third output circuit, not connected to any of the output terminals, which coverts input data into a video signal, the self-detecting and self-repairing method including: a switching step of selecting p output circuit(s) from among the first output circuits, disconnecting the p output circuit(s) from the output terminal(s), and connecting p output circuit(s) from among the second output circuits to the output terminal(s); a comparing step of comparing the video signal from the first output circuit thus selected or each of the video signals from the first output circuits thus selected with the video signal from the third output circuit; and a decision step of determining, in accordance with a comparison result of the comparing step, whether the first output circuit thus selected or any of the first output circuits thus selected is defective or not.

As described above, a self-detecting and self-repairing method according to the present invention is a self-detecting and self-repairing method for detecting and repairing a defect in a drive circuit including (i) n (where n is a natural number of 2 or greater) output terminals through which video signals are outputted to a display device, (ii) n first output circuits, connected disconnectably to the output terminals, which convert input data into video signals; (iii) u or more (where u is an even number of 2 to n) second output terminals, connected disconnectably to the output terminals, which convert input data into video signals, the self-detecting and self-repairing method including: a switching step of selecting u output circuits from among the first output circuits, disconnecting the u output circuits from the output terminals, and connecting u output circuits from among the second output circuits to the output terminals; a comparing step of, with any two of the first output circuits thus selected serving as first and second selected output circuits respectively, comparing the video signal from the first selected output circuit and the video signal from the second selected output circuit; and a decision step of determining, in accordance with a comparison result of the comparing step, whether any of the first output circuits thus selected is defective or not.

This brings about an effect of making it possible to detect a failure in an output circuit while driving a display panel without causing a defect in display.

### BRIEF DESCRIPTION OF DRAWINGS

FIG. 1 is a block diagram showing the configuration of a liquid crystal television according to an embodiment of the present invention.

FIG. 2 is a block diagram schematically showing the configuration of a display device according to a first embodiment of the present invention.

FIG. 3 is an explanatory diagram showing the configuration of a drive circuit according to the first embodiment of the present invention.

FIG. 4 is a circuit diagram showing a test signal generation circuit for generating test signals test and inversion test signals test B.

FIG. 5 shows the waveforms of a reset signal RESET, a signal TESTSP, a signal TESTCK, and test signals test1 to testn during an operation check test in the drive circuit shown in FIG. 3.

FIG. 6 shows the waveforms of a reset signal RESET, a signal TESTSP, a signal TESTCK, and a test signals test1 to testn, and a signal Flag2 during an operation check test in the drive circuit shown in FIG. 3.

FIG. 7 is a circuit diagram showing another test signal generation circuit for generating test signals test and inversion test signals testB.

FIG. 8 is a flow chart showing a first procedure in an operation check test according to the first embodiment of the present invention.

FIG. 9 is a flow chart showing a second procedure in the operation check test according to the first embodiment of the present invention.

FIG. 10 is a flow chart showing a third procedure in the operation check test according to the first embodiment of the present invention.

FIG. 11 is a flow chart showing a fourth procedure in the operation check test according to the first embodiment of the present invention.

FIG. 12 is a flow chart showing a fifth procedure in the operation check test according to the first embodiment of the present invention.

FIG. 13 is a flow chart showing a self-repairing procedure according to the first embodiment of the present invention.

FIG. 14 is a block diagram schematically showing the configuration of a display device according to a second embodiment of the present invention.

FIG. 15 is an explanatory diagram showing the configuration of a drive circuit according to the second embodiment of the present invention.

FIG. 16 is a block diagram schematically showing the configuration of a display device according to a third embodiment of the present invention.

FIG. 17 is an explanatory diagram showing the configuration of a drive circuit according to the third embodiment of the present invention.

FIG. 18 is a circuit diagram showing another test signal generation circuit for generating test signals test and inversion test signals testB.

FIG. 19 shows the waveforms of a reset signal RESET, a signal TESTSP, a signal TESTCK, and test signals test1 to test(n/2) during an operation check test in the drive circuit shown in FIG. 17.

FIG. 20 shows the waveforms of a reset signal RESET, a signal TESTSP, a signal TESTCK, and a test signals test1 to testn, and a signal Flag2 during an operation check test in the drive circuit shown in FIG. 17.

FIG. 21 is a block diagram schematically showing the configuration of a display device according to a fourth embodiment of the present invention.

FIG. 22 is an explanatory diagram showing the configuration of a drive circuit according to the fourth embodiment of the present invention.

FIG. 23 is a block diagram schematically showing the configuration of a display device according to a fifth embodiment of the present invention.

FIG. 24 is an explanatory diagram showing the configuration of a drive circuit according to the fifth embodiment of the present invention.

FIG. 25 shows the waveforms of sampling signals STR1 to STR3, outputs from sampling circuits 6-1 to 6-3, a signal LS, outputs from hold circuits 7-1 to 7-3, and outputs from output terminals OUT during an operation check test in the drive circuit shown in FIG. 24.

FIG. 26 shows the waveforms of a signal LS, signals TCLK1 and TCLK2, gate signals TA1 to TA3 and TB1 to TB3, test signals test1 to test3, and test signals testA1 to testA3 during an operation check test in the drive circuit shown in FIG. 24.

FIG. 27 shows the waveforms of the signal LS, the signals TCLK1 and TCLK2, the gate signal TA1, the test signal testA1, the gate signal TB1, the test signal test1, and signals TSTR1 and TSTR2 before and after a period of time during which the signals TCLK1 and TCLK2 shown in FIG. 26 rise to a “H” level alternately.

### DESCRIPTION OF EMBODIMENTS

In the following, embodiments according to the present invention are described with reference to the drawings.

### Embodiment 1

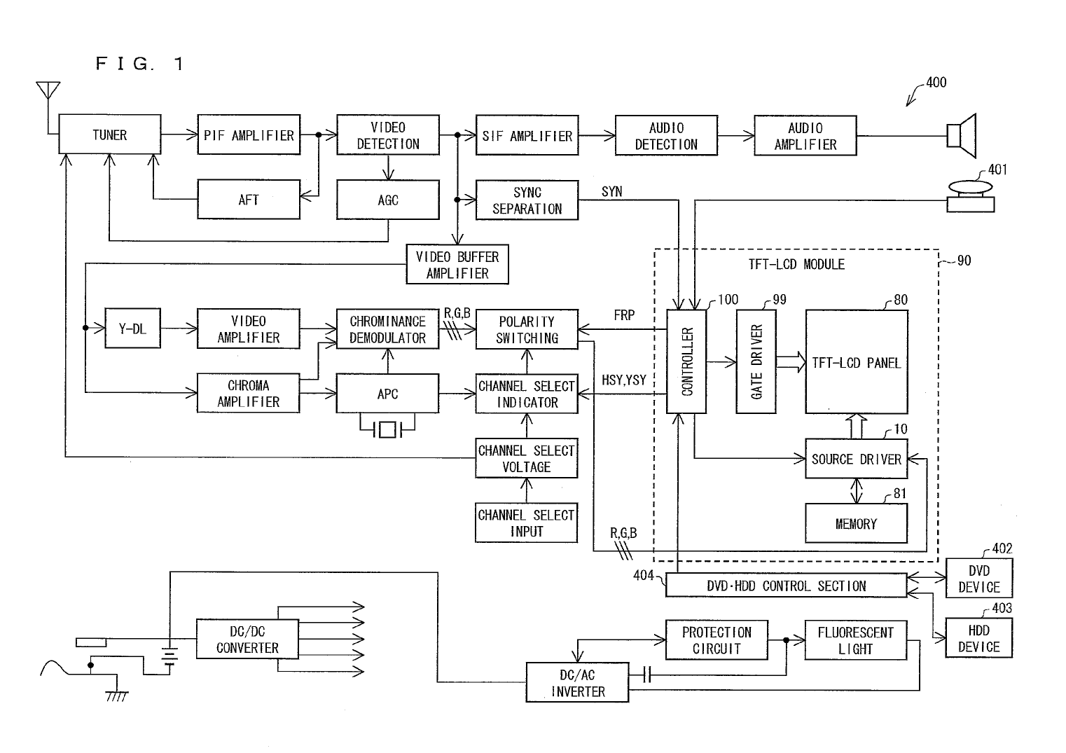

A first embodiment of the present invention is described with reference to FIGS. 1 through 13.

(Liquid Crystal Television 400)

Typical examples of display devices in which display drive circuits are used may include flat-screen televisions as typified by liquid crystal televisions. In a liquid crystal television (liquid crystal display device), a display is carried out by mounting, on a display panel, a plurality of drive circuits constituted by semiconductor integrated circuits (LSI). In such a display device, a failure in any of the display driving circuits is recognized directly by a user as a defect in display. When such a failure occurs, it is necessary to promptly repair the failed part and, if possible, it is desirable to quickly finish repairing in the place where the user uses the display device. Such a control substrate as to process display signals would be easily replaced as it is connected to the display panel through a connector. However, the display driving circuit, connected directly to the display panel without a connector or the like therebetween, can hardly be replaced in the place where the user uses the product.

For this reason, the Applicant proposed a drive circuit having a self-diagnostic and self-repairing function (self-detecting and self-repairing function) to address a failure in the display driving circuit (e.g., Japanese Patent Application 2007-302289, Japanese Patent Application 2008-048639, Japanese Patent Application 2008-048640, Japanese Patent Application 2008-054130, Japanese Patent Application 2008-130848, Japanese Patent Application 2008-246724, Japanese Patent Application 2008-246725, Japanese Patent Application 2008-246726, and Japanese Patent Application 2008-246727, all of which were confirmed unpublished at a point in time prior of the filing of the present application).

FIG. 1 is a block diagram showing the configuration of a liquid crystal television 400 according to the present invention. As shown in FIG. 1, the liquid crystal television 400 includes a TFT-LCD module (display device) 90, a switch button 401, a DVD device 402, a HDD device 403, and a DVD and HDD control device 404. Furthermore, the display device 90 includes a source driver (drive circuit) 10, a TFT-LCD panel (display panel) 80, a gate driver 99, and a controller 100. Moreover, the source driver 10 serves as a display driving circuit that has the aforementioned self-detecting and self-repairing function.

(Configuration of the Display Device 90)

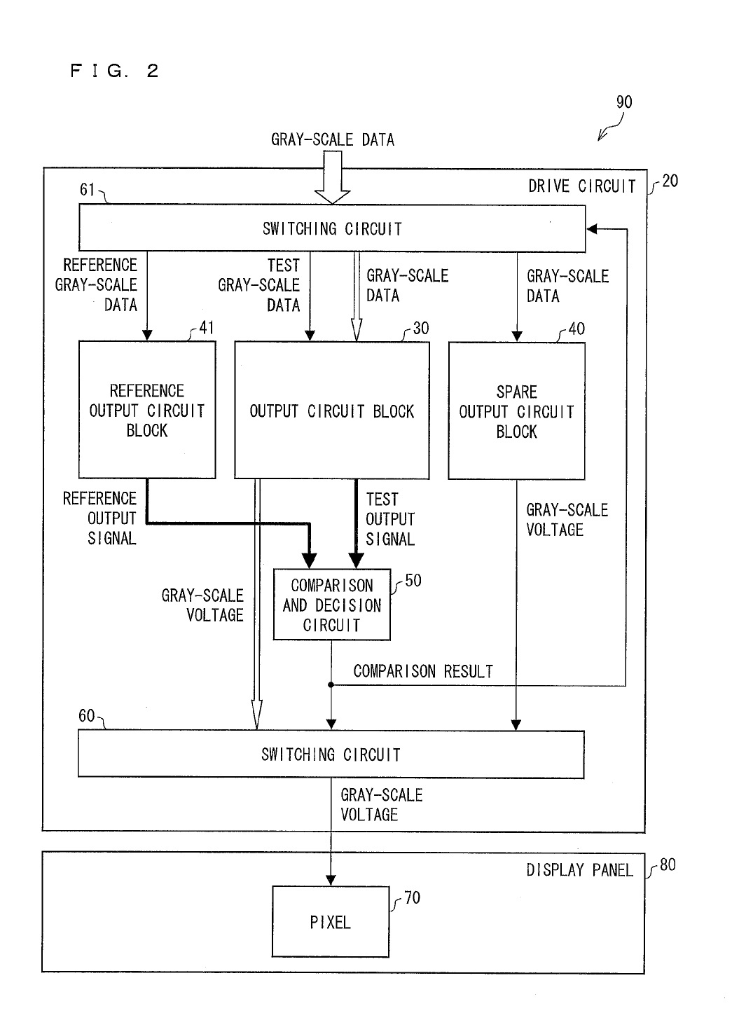

The configuration of the display device 90 according to the present embodiment is schematically described with reference to FIG. 2. FIG. 2 is a block diagram schematically showing the configuration of the display device 90 shown in FIG. 1.

As shown in FIG. 2, the display device 90 includes a display panel 80 and a display driving circuit (hereinafter referred to as “drive circuit”) 20 that drives the display panel 80 in accordance with gray-scale data inputted from an outside source. Further, the drive circuit 20 includes a switching circuit 60 (switching means), a switching circuit 61 (control means), an output circuit block 30 (first output circuit), a spare output circuit block 40 (second output circuit), a reference output circuit block 41 (third output circuit), and a comparison and decision circuit 50 (comparing means, decision means, self-detecting and self-repairing means). Further, the display panel 80 includes a pixel 70 to which a gray-scale voltage from the drive circuit 20 is applied. As will be described later, the output circuit block 30 includes n (where n is an even number) columns of output circuits connected in parallel to a data bus through which the gray-scale data is supplied.

(Basic Operation of the Display Device 90)

Next, a basic operation in the display device 90 is described. In the display device 90, the drive circuit 20 receives gray-scale data from an outside source and converts the gray-scale data into a gray-scale voltage (output signal), and the display panel 80 carries out a normal operation of displaying an image in accordance with the gray-scale voltage. Also, the drive circuit 20 detects whether the output circuit block 30 is defective or not and, if there is a defective output circuit in the output circuit block 30, carries out a self-detecting and repairing operation of self-repairing itself.

In the following, a self-detecting and repairing operation that is carried out by the drive circuit 20 is schematically described. First, when the drive circuit 20 carries out a self-detecting and repairing operation, the switching circuit 61 selects one output circuit from the output circuit block 30, sends test gray-scale data to the output circuit, and sends reference gray-scale data to the reference output circuit block 41. The test gray-scale data and the reference gray-scale data are different from each other.

At this point in time, the selected output circuit is disconnected from the pixel 70 so as not to drive the display panel 80. Instead, the switching circuits 60 and 61 are used to change states of connection so that the remaining output circuits of the output circuit block 30 and the spare output circuit block 40 are connected to the pixel 70. This makes it possible to ongoingly drive the display panel 80 even while carrying out a self-detecting and repairing operation.

The selected output circuit converts the received test gray-scale data into a test output signal and sends it to the comparison and decision circuit 50. Further, the reference output circuit block 41 converts the received reference gray-scale data into a reference output signal and sends it to the comparison and decision circuit 50. The comparison and decision circuit 50 compares the test output signal with the reference output signal to show which one of them is greater than the other, confirms whether the magnitude relation is one set in advance for the different data, and determines whether the selected output circuit is defective or not.

The switching circuit 61 changes from selecting one output circuit to selecting another output circuit in sequence from the output circuit block 30 so that it is determined in the same manner for each of the output circuits whether the output circuit is defective or not.

Furthermore, the comparison and decision circuit 50 sends, to the switching circuits 61 and 60, a result of determination indicating whether the output circuit block 30 is defective or not. In accordance with the result of determination sent from the comparison and decision circuit 50, the switching circuit 61 redirects the gray-scale data from the outside source. Meanwhile, the switching circuit 60 receives gray-scale voltages from the output circuit block 30 and the spare output circuit block 40 and, in accordance with the result of determination sent from the comparison and decision circuit, selects a gray-scale voltage from among the received gray-scale voltages to be sent to the display panel 80.

More specifically, upon receiving a result of determination indicating that an output circuit selected from the output circuit block 30 is defective, the switching circuit 61 stops the use of the output circuit determined to be defective. At this point in time, the gray-scale data which would during a normal operation be inputted to the selected output circuit is inputted to the next column of output circuits, and the gray-scale data which would during a normal operation be inputted to the next column of output circuits is inputted to a column of output circuits after the next. Similarly, the gray-scale data is inputted to a column of output circuits next to the column of output circuits to which it would be inputted during a normal operation, and the gray-scale data which would during a normal operation be inputted to the last column of output circuits is inputted to the spare output circuit block 40.

The switching circuit 61 maintains this state of connection, whereby even if any one of the output circuits of the output circuit block 30 becomes defective, the drive circuit 20 can send a normal gray-scale voltage to the display panel 80 by using the spare output circuit block instead of the output circuit determined to be defective.

As described above, by including the comparison and decision circuit 50 and the switching circuits 60 and 61, the drive circuit 20 of the present embodiment can detect a failure in itself and further self-repair such a failure in itself. In other words, the drive circuit 20 includes a self-detecting and self-repairing circuit (self-detecting and self-repairing means) for detecting a failure in the drive circuit 20 and further self-repairing such a failure in the drive circuit 20.

(Configuration of the Drive Circuit 20)

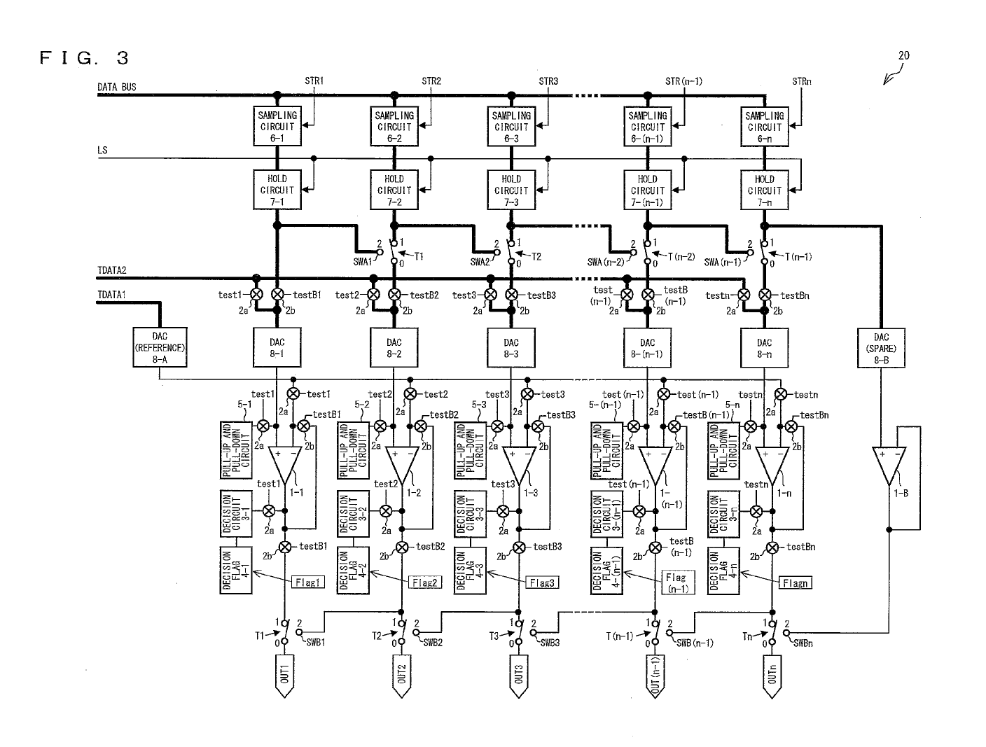

The configuration of the drive circuit 20 is described with reference to FIG. 3. FIG. 3 is a block diagram schematically showing the configuration of the drive circuit 20.

As shown in FIG. 3, the drive circuit 20 includes: n sampling circuits 6-1 to 6-n (hereinafter sometimes collectively referred to as “sampling circuits 6” in the present embodiment), which receive gray-scale data corresponding to n liquid crystal driving signal output terminals OUT1 to OUT n (hereinafter sometimes collectively referred to as “output terminals OUT” in the present embodiment) from a gray-scale data input terminal (not illustrated) through the data bus, respectively; n hold circuits 7-1 to 7-n (hereinafter sometimes collectively referred to as “hold circuits 7” in the present embodiment); n DAC circuits 8-1 to 8-n and a spare DAC circuit 8-B (hereinafter sometimes collectively referred to as “DAC circuits 8” in the present embodiment), which convert gray-scale data into gray-scale voltage signals; and a reference DAC circuit 8-A, which converts reference gray-scale data into a reference output signal; n operational amplifiers 1-1 to 1-n and a spare operational amplifier 1-B (hereinafter sometimes collectively referred to as “operational amplifiers 1” in the present embodiment), which serve as buffer circuits for the gray-scale voltage signals from the DAC circuits 8; n decision circuits 3-1 to 3-n (hereinafter sometimes collectively referred to as “decision circuits 3” in the present embodiment); n decision flags 4-1 to 4-n (hereinafter sometimes collectively referred to as “decision flags 4” in the present embodiment); and n pull-up and pull-down circuits 5-1 to 5-n (hereinafter sometimes collectively referred to as “pull-up and pull-down circuits 5” in the present embodiment).

Furthermore, as shown in FIG. 3, the drive circuit 20 includes: a plurality of switches 2a, which switch between ON and OFF according to test signals test (test1 to testn), respectively; a plurality of switches 2b, which switch between ON and OFF according to inversion test signals testB (testB1 to testBn) obtained by inverting the test signals test, respectively; (n−1) switches SWA1 to SWA(n−1) (hereinafter sometimes collectively referred to as “switches SWA” in the present embodiment), which change connections according to gate signals T1 to T(n−1), respectively; and n switches SWB1 to SWBn (hereinafter sometimes collectively referred to as “switches SWB” in the present embodiment), which change connections according to the gate signals T1 to Tn, respectively.

Each of the switches 2a and 2b becomes ON upon receiving a “H” level signal and becomes OFF upon receiving a “L” level signal.

Further, each of the switches SWA and SWB is a switch circuit which includes a terminal 0, a terminal 1, and a terminal 2 and which has two states of connection, namely a state of connection where the terminal 0 is connected to the terminal 1 and a state of connection where the terminal 0 is connected to the terminal 2. Specifically, the switch SWAi (i=1 to n−1) has its terminals 0, 1, and 2 connected to the DAC circuit 8-(i+1), the hold circuit 7-(i+1), and the hold circuit 7-i, respectively. Further, the switch SWBi (i=1 to n−1) has its terminals 0, 1, and 2 connected to the output terminal OUTi, the output terminal of the operational amplifier 1-i, and the output terminal of the operational amplifier 1-(i+1), respectively; the switch SWBn has its terminals 0, 1, and 2 connected to the output terminal OUTn, the output terminal of the operational amplifier 1-n, and the output terminal of the spare operational amplifier 1-B, respectively.

Each of the switches SWA and SWB switches its states of connection according to the value of a gate signal. Specifically, the terminal 0 is connected (conducted) to the terminal 2 when the gate signal is “H”, and the terminal 0 is connected (conducted) to the terminal 1 when the gate signal is “L”. The gate signals T1 to Tn are represented by logical formulas shown in Math. 1 as follows:

$$\begin{matrix}\begin{matrix}\begin{matrix}\begin{matrix}\begin{matrix}T 1 = test 1 \\ T 2 = test 1 + test 2\end{matrix} \\ T 3 = test 1 + test 2 + test 3\end{matrix} \\ ⋮\end{matrix} \\ T ( n - 1 ) = test 1 + test 2 + test 3 + … + test ( n - 1 )\end{matrix} \\ Tn = test 1 + test 2 + test 3 + … + testn\end{matrix} \qquad [ Math . 1 ]$$

That is, the gate signal Tk (k=1 to n) is the logical sum of the test signals test1 to testk.

It should be noted, in FIG. 3, that the DAC circuits 8 and the operational amplifiers 1 correspond to the output circuit block 30 shown in FIG. 2, that the reference DAC circuit 8-A corresponds to the reference output circuit block 41 shown in FIG. 2, and that the spare DAC circuit 8-B corresponds to the spare output circuit block 40 shown in FIG. 2. Further, the operational amplifiers 1, the decision circuits 3, and the decision flags 4 correspond to the comparison and decision circuit 50 shown in FIG. 2, and the operational amplifiers 1 serve both as buffers of the output circuit block 30 and comparators of the comparison and decision circuit 50. Further, the switches SWA and those switches 2a, and 2b connected to the input terminals of the DAC circuits 8-1 to 8-n correspond to the switching circuit 61 shown in FIG. 2. Further, the switches SWB correspond to the switching circuit 60 shown in FIG. 2. It should be noted that the drive circuit 20 shown in FIG. 2 is connected to the display panel 80 shown in FIG. 2 through the output terminals OUT1 to OUTn and that FIG. 3 omits to illustrate the display panel 80.

During a normal operation, each operational amplifier 1 feeds back an output to its negative input to function as a voltage follower buffer. Meanwhile, during an operation check, connections are changed so that each operational amplifier 1 functions as a comparator by receiving through its positive input terminal an output from a DAC circuit 8 connected in series to that operational amplifier 1 and further receiving an output from the reference DAC circuit 8-A through its negative input terminal. Specifically, as shown in FIG. 3, the operational amplifier 1-1 receives an output from the DAC circuit 8-1 through its positive input terminal and receives an output from the reference DAC circuit 8-A through its negative input terminal via the switch 2a that is controlled by the test signal test1. Similarly, the operational amplifier 1-2 receives an output from the DAC circuit 8-2 through its positive input terminal and receives an output from the reference DAC circuit 8-A through its negative input terminal via the switch 2a that is controlled by the test signal test2. That is, the operational amplifier 1-k (k=1 to n) receives an output from the DAC circuit 8-k through its positive input terminal and receives an output from the reference DAC circuit 8-A through its negative input terminal via the switch 2a that is controlled by the test signal testk.

(Normal Operation of the Drive Circuit 20)

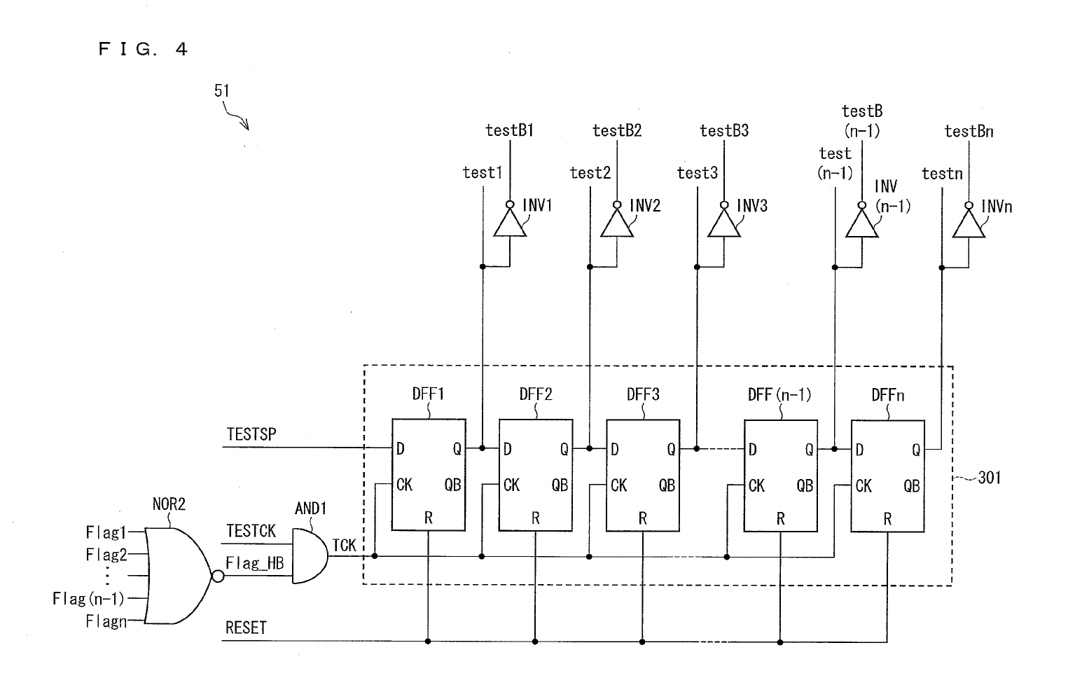

FIG. 4 is a circuit diagram showing a test signal generation circuit 51 for generating test signals test and inversion test signals testB. The test signal generation circuit 51 includes n D-type flip-flops DFF1 to DFFn, one NOR gate NOR1, one AND gate AND1, and n inverters INV1 to INVn, and the D-type flip-flops DFF1 to DFFn constitute a shift register 301.

The flip-flops DFF1 to DFFn receive a reset signal RESET through their reset terminals R. During the normal operation of the drive circuit 20, the reset signal RESET is retained at a “H” level so that the shift register 301 is in a reset state. Further, the flip-flops DFF1 to DFFn receive a clock TCK from the AND gate AND1 through their clock terminals CK. Further, the first flip-flop DFF1 receives a signal TESTSP through its data input terminal D. Each flip-flop DFFk (k=1 to n) comes to output a test signal testk as its output signal through its output terminal Q, and the output signal is inverted by the inverter INVk to become an inversion test signal testBk. Accordingly, the shift register 301 is reset, then the test signals test1 to testn fall to a “L” level and the inversion test signal testB1 to testBn rise to a “H” level. At this point in time, according to Math. 1, the gate signals T1 to T(n−1) all fall to a “L” level.

Further, the AND gate AND1 receives a signal TESTCK through one of its two input terminals and receives a signal Flag_HB from the NOR gate OR1 through the other input terminal. The NOR gate NOR1, which has n input terminals, receives signals Flag1 to Flagn (hereinafter sometimes collectively referred to as “signals Flag” in the present embodiment) from the decision flags 4-1 to 4-n shown in FIG. 3 through its input terminals, respectively. As will be described later, the signals Flag rise to a “H” level only when an operational abnormality in the operational amplifiers 1 is detected. Therefore, during a normal operation, the signal Flag_HB is at a “H” level.

See FIG. 3. In order to sample the gray-scale data supplied to the data bus, the sampling circuits 6-1 to 6-n receive sampling signals STR1 to STRn (hereinafter sometimes collectively referred to as “sampling signals STR” in the present embodiment) from a pointer shift register (not illustrated) through their gates as the sampling signals STR1 to STRn rise to a “H” level in sequence. The sampling circuits 6 are constituted by latch circuits that load the gray-scale data during a period of time when their gates are at a “H” level. During a period of time when the sampling signals STR are at a “H” level, the sampling circuits load the gray-scale data from the data bus, and during a period of time when the sampling signals STR are at a “L” level, the sampling circuits retain the gray-scale data loaded during the “H” level period.

After the sampling circuits 6-1 to 6-n have finished loading the data, a signal LS line connected to the hold circuits 7 is supplied with a signal LS at a “H” level. The signal LS is supplied to the gates of the hold circuits 7-1 to 7-n, and during a period of time when the gates are at a “H” level, the hold circuits 7-1 to 7-n load the gray-scale data retained by the sampling circuits 6-1 to 6-n connected thereto, respectively. Further, the hold circuits 7-1 to 7-n retain the loaded gray-scale data after the signal LS has fallen to a “L” level.

In the drive circuit 20, it is necessary to carry out a display even while loading the gray-scale data. For this reason, the hold circuits 7 retain the loaded gray-scale data as described above, and output display drive signals in accordance with the retained data. Further, the hold circuits 7 are designed to load the data from the data bus while outputting the display drive signals.

Since the gate signals T1 to T(n−1) that are inputted to the switches SWA1 to SWA(n−1) are all at a “L” level, each of the switches SWA connects its terminal 0 to its terminal 1. This causes the gray-scale data to be sent from the hold circuits 7-1 to 7-n to the DAC circuits 8-1 to 8-n, respectively. This in turn causes the DAC circuits 8-1 to 8-n to convert the gray-scale data retained in the hold circuits 7-1 to 7-n into gray-scale voltage signals and send them as gray-scale voltages to the positive input terminals of the operational amplifiers 1-1 to 1-n, respectively.

It should be noted here that since the switches 2b are ON, the operational amplifiers 1-1 to 1-n have their outputs fed negatively back to their negative input terminals, respectively. This allows the operational amplifiers 1-1 to 1-n to function as voltage followers. As such, the operational amplifiers 1-1 to 1-n buffer the gray-scale voltages sent from the DAC circuits 8-1 to 8-n and send them to the corresponding output terminals OUT1 to OUTn, respectively.

(Outline of an Operation Check Test)

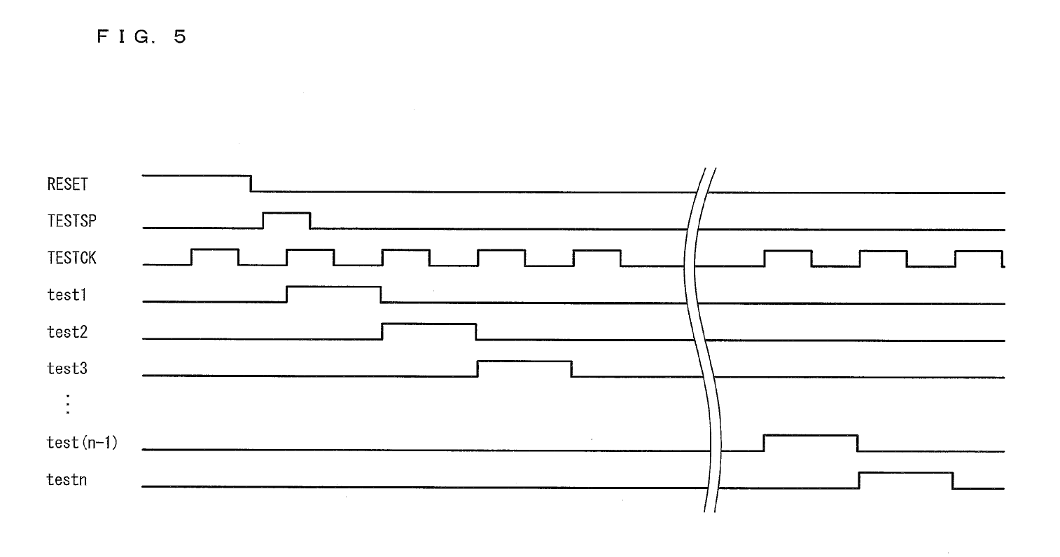

FIG. 5 shows the waveforms of a reset signal RESET, a signal TESTSP, a signal TESTCK, and test signals test1 to testn during an operation check test in the drive circuit 20. An operation check test is started by raising the signal TESTSP to a “H” level. A rise in the signal TESTCK causes the flip-flop DFF1 to recognize that the signal TESTSP is at a “H” level. This causes the flip-flops DFF1 to DFFn of the shift register 301 to output pulse signals in sequence as the test signals test1 to testn and the inversion test signals testB1 to testBn in synchronization with rises in the signal TESTCK.

See FIG. 3. At this point in time, when the test signal test1 is at a “H” level (i.e., when the inversion test signal testB1 is at a “L” level), the gate signals T1 to Tn all rise to a “H” level according to Math. 1, whereby each of the switches SWA1 to SWAn and SWB1 to SWBn comes to have its terminal 0 connected to its terminal 2. This shifts connections forward in sequence to cause the hold circuit 7-1 to be connected to the DAC circuit 8-2, the hold circuit 7-2 to the DAC circuit 8-3, and, lastly, the hold circuit 7-n to the spare DAC circuit 8-B. This also shifts connections forward in sequence to cause the output terminal OUT1 to be connected to the operational amplifier 1-2, the output terminal OUT2 to the operational amplifier 1-3, and, lastly, the output terminal OUTn to the spare operational amplifier 1-B.

By thus changing the states of connection in the switches SWA and SWB, the DAC circuit 8-1 and the operational amplifier 1-1 are disconnected from the hold circuit 7-1 and the output terminal OUT1, respectively, whereby the DAC circuit 8-1 and the operational amplifier 1-1 become irrelevant to the driving of the display panel. Since the test signal test1 is “H”, those switches 2a and 2b connected to the input and output terminals of the operational amplifier 1-1 become “ON” and “OFF”, respectively. Accordingly, the operational amplifier 1-1 comes to have its negative input terminal disconnected from its output terminal and connected to the reference DAC circuit 8-A. This connection allows the operational amplifier 1-1 to function as a comparator to compare the voltage of the DAC circuit 8-1 with the voltage of the reference DAC circuit 8-A and send its output to the decision circuit 3-1. Further, the operational amplifier 1-1 comes to have its positive input terminal connected to the pull-up and pull-down circuit 5-1 as well as the DAC circuit 8-1.

Meanwhile, the DAC circuit 8-1 comes to have its input switched from the hold circuit 7-1 to a test data bus TDATA2. Further, the reference DAC circuit 8-A has its input connected to a test data bus TDATA1 that is different from the test data bus TDATA2.

This causes the reference DAC circuit 8-A and the DAC circuit 8-1 to receive reference gray-scale data and test gray-scale data from the test data buses TDATA1 and TDATA2, respectively. In response, the reference DAC circuit 8-A and the DAC circuit 8-1 output a reference output signal and a test output signal, respectively. Accordingly, the operational amplifier 1-1 receives the reference output signal from the reference DAC circuit 8-A through its negative input terminal and receives the test output signal from the DAC circuit 8-1 through its positive input terminal. Since the reference gray-scale data and the test gray-scale data are different from each other, the reference output signal from the reference DAC circuit 8-A and the test output signal from the DAC circuit 8-1 are different in voltage from each other.

Since the operational amplifier 1-1 functions as a comparator, the output of the operational amplifier 1-1 becomes “H” if the operational amplifier 1-1 receives a higher input voltage through its positive input terminal than through its negative input terminal, i.e., if the test output signal from the DAC circuit 8-1 is higher than the reference gray-scale data from the reference DAC circuit 8-A. On the other hand, the output of the operational amplifier 1-1 becomes “L” if the operational amplifier 1-1 receives a lower input voltage through its positive input terminal than through its negative input terminal, i.e., if the test output signal from the DAC circuit 8-1 is lower than the reference gray-scale data from the reference DAC circuit 8-A.

Whether the output voltage of the operational amplifier is “H” or “L” depending on the gray-scale data inputted to the reference DAC circuit 8-A and the DAC circuit 8-1 can be set in advance as an expected value. The decision circuit 3-1, which has such an expected value stored therein, determines whether or not the output of the operational amplifier 1-1 matches the expected value and, if the output of the operational amplifier 1-1 is different from the expected value, sends a “H” level signal to the decision flag 4-1, so that the signal Flag1 from the decision flag 4-1 rises to a “H” level.

As described above, during a period of time when the test signal test1 is “H”, a switch in connection in the switches SWA and SWB causes the hold circuit 7-i (i=1 to n−1) to be connected to the DAC circuit 8-(i+1), the last hold circuit 7-n to the spare DAC circuit 8-B, the operational amplifiers 1-j (j=2 to n) to the output terminal OUT(j−1), and the spare operational amplifier 1-B to the last output terminal OUTn. That is, the operational amplifiers 1-2 to 1-n and the spare operational amplifier 1-B function as normal-operation buffers. This makes it possible to check the functional operation of the DAC circuit 8-1 while driving the display panel 80 by converting gray-scale data sent from the normal-operation data bus into gray-scale voltages and outputting them through the output terminals OUT.

Next, when the test signal test2 rises to a “H” level and the inversion test signal testB2 falls to a “L” level, the gate signal T1 falls to a “L” level and the gate signals T2 to Tn rise to a “H” level according to Math. 1. Since the gate signal T1 is at a “L” level, the hold circuit 7-1 and the operational amplifier 1-1 are connected to the DAC circuit 8-1 and the output terminal OUT1, respectively, as in the case of a normal operation.

Meanwhile, since the gate signals T2 to Tn are at a “H” level, this shifts connections forward in sequence to cause the hold circuit 7-2 to be connected to the DAC circuit 8-3, the hold circuit 7-3 to the DAC circuit 8-4, and, lastly, the hold circuit 7-n to the spare DAC circuit 8-B. This also shifts connections forward in sequence to cause the output terminal OUT2 to be connected to the operational amplifier 1-3, the output terminal OUT3 to the operational amplifier 1-4, and, lastly, the output terminal OUTn to the spare operational amplifier 1-B.

By thus changing the states of connection in the switches SWA and SWB, the DAC circuit 8-2 and the operational amplifier 1-2 are disconnected from the hold circuit 7 and the output terminal OUT1, respectively, whereby the DAC circuit 8-2 and the operational amplifier 1-2 become irrelevant to the display operation. Since the test signal test2 is at a “H” level, those switches 2a and 2b connected to the input ant output terminals of the operational amplifier 1-2 become “ON” and “OFF”, respectively. Accordingly, the operational amplifier 1-2 comes to have its negative input terminal disconnected from its output terminal and connected to the reference DAC circuit 8-A. This switch in connection allows the operational amplifier 1-2 to function as a comparator to compare the voltage of the DAC circuit 8-2 with the voltage of the reference DAC circuit 8-A and send its output to the decision circuit 3-2. Further, the operational amplifier 1-2 comes to have its positive input terminal connected to the pull-up and pull-down circuit 5-2 as well as the DAC circuit 8-2.

Meanwhile, the DAC circuit 8-2 comes to have its input switched from the hold circuit 7-2 to the test data bus TDATA2. This causes the reference DAC circuit 8-A and the DAC circuit 8-2 to receive, from the test data buses TDATA1 and TDATA2, reference gray-scale data and test gray-scale data that are different from each other, respectively. The operational amplifier 1-2 receives the test gray-scale data from the DAC circuit 8-2 through its positive input terminal, receives the reference gray-scale data from the reference DAC circuit 8-A through its negative input terminal, and functions as a comparator.

Since the reference output signal from the reference DAC circuit 8-A and the test output signal from the DAC circuit 8-2 are different in voltage from each other, the output of the operational amplifier 1-2 becomes “H” if the test output signal from the DAC circuit 8-2 is higher than the reference gray-scale data from the reference DAC circuit 8-A, and the output of the operational amplifier 1-2 becomes “L” if the test output signal from the DAC circuit 8-2 is lower than the reference gray-scale data from the reference DAC circuit 8-A. Whether the output voltage of the operational amplifier is “H” or “L” depending on the gray-scale data inputted to the reference DAC circuit 8-A and the DAC circuit 8-2 can be set in advance as an expected value. Therefore, the decision circuit 3-2 determines whether or not the output of the operational amplifier 1-2 matches the expected value, and if the output of the operational amplifier 1-2 is different from the expected value, the signal Flag2 from the decision flag 4-2 rises to a “H” level.

As described above, the operation of the DAC circuit 8-2 can be checked while the display panel being driven.

Similarly, during periods of time when the test signals test 3 to testn are at a “H” level, the operations of the DAC circuits 8-3 to 8-n are checked by making changes in connection, respectively. If the signals Flag outputted from the decision flags 4 are all at a “L” level, the operations of the DAC circuits up to 8-n are checked. On the other hand, if any of the signals Flag rises to a “H” level in the middle of the checking of operations, i.e., if any of the output circuits is determined to be defective, the following operation is carried out. As an example, a case where the operational amplifier 1-2 is determined to be defective and the signal Flag2 rises to a “H” level is described.

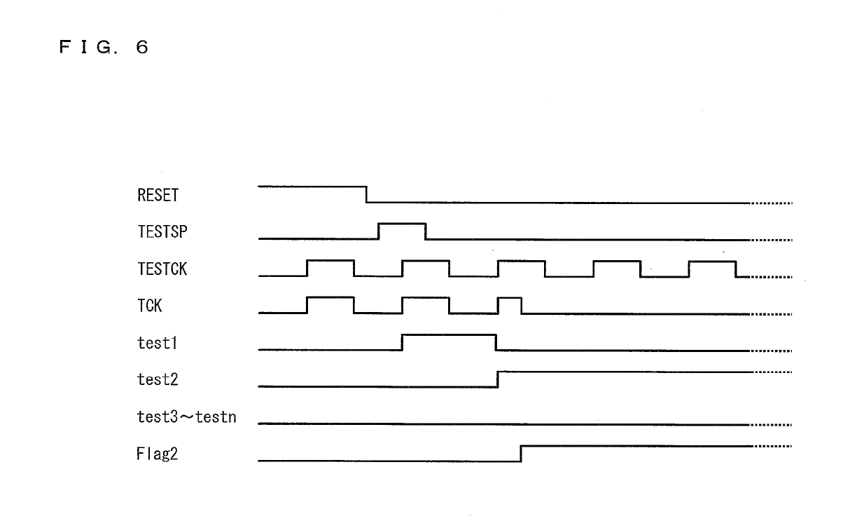

FIG. 6 shows the waveforms of a reset signal RESET, a signal TESTSP, a signal TESTCK, and test signals test1 to testn, and a signal Flag2. Since the inversion test signal testB2 falls to a “L” level when the test signal test2 rises to “H” level, the DAC circuits 8 excluding the DAC circuit 8-2 (i.e., the DAC circuits 8-1 and 8-3 to 8-n and the spare DAC circuit 8-B) and the operational amplifiers 1 excluding the operational amplifier 1-2 (i.e., the operational amplifiers 1-1 and 1-3 to 1-n and the spare operational amplifier 1-B) carry out normal display driving.

When the signal Flag2 rises to a “H” level, the output signal FlagHB of the NOR gate NOR1 shown in FIG. 4 falls to a “L” level. For this reason, as shown in FIG. 6, the clock TCK by which the shift register 301 operates falls to a “L” level and is kept at that level. Accordingly, the test signal test2 is kept in a “H” state, and the inversion test signal testB2 is kept in a “L” state. This allows the display panel to be ongoingly driven in the state of connection established at the point in time when the signal Flag2 rose to a “H” level. That is, the DAC circuits 8 excluding the DAC circuit 8-2 and the operational amplifiers 1 excluding the operational amplifier 1-2 carry out normal display driving. Therefore, the operational amplifier 1-2, which has now been determined to be defective in operation, drops out of use, and the other operational amplifiers 1 drive the display panel.

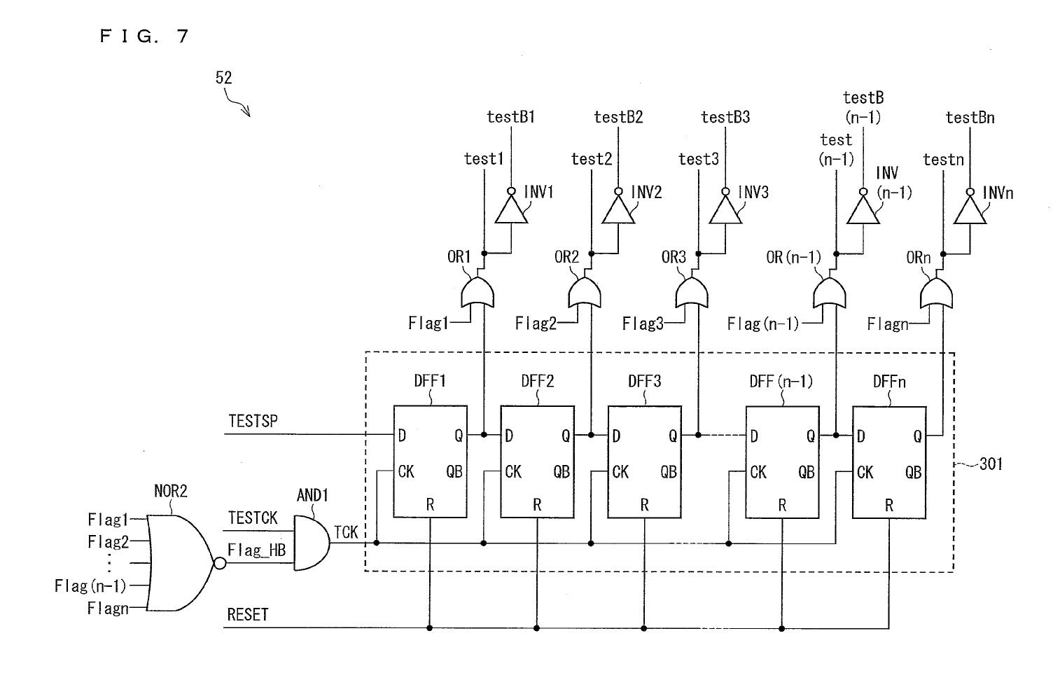

Because, in the test signal generation circuit 51 shown in FIG. 4, a change in value of the shift register 301 due to stoppage of power source supply or the like makes it impossible to retain a state of connection established at a point in time when a signal Flag rose to a “H” level, it is necessary to configure the settings for the signal Flag by again checking operations. To meet such a need, the following describes, with reference to FIG. 7, a configuration in which once an operational amplifier is detected defective in operation, the state of connection at the time of the detection is retained even in the face of a change in value of the shift register 301 so that the need to reconfigure the settings for a signal Flag is eliminated.

FIG. 7 is a circuit diagram showing a test signal generation circuit 52 for generating test signals test and inversion test signals testB. The test signal generation circuit 52 is configured by further providing n OR gates OR1 to ORn in the test signal generation circuit 51 shown in FIG. 4. Each of the OR gates OR1 to ORn has two input terminals one of which is connected to the output terminal Q of a corresponding one of the flip-flops DFF1 to DFFn, and receives a corresponding one of the signals Flag1 to Flagn through the other input terminal. Thus, the OR gates OR1 to ORn output the test signals test1 to testn, respectively.

The decision flags 4 shown in FIG. 3 are constituted by nonvolatile storage devices. When an operational amplifier is detected defective in operation and a signal Flag at a “H” level is stored in the corresponding decision flag 4, there is no change in value of that signal Flag even if the power source supply is stopped. Since the test signal generation circuit 52 outputs the test signals test1 to testn through the OR gates OR1 to ORn, an OR gate to which a signal Flag at a “H” level is inputted outputs a test signal at a “H” level even if the shift register 301 is reset. This eliminates the need to reconfigure the settings for the signal Flag.

(Operation Check Test 1 of Embodiment 1)

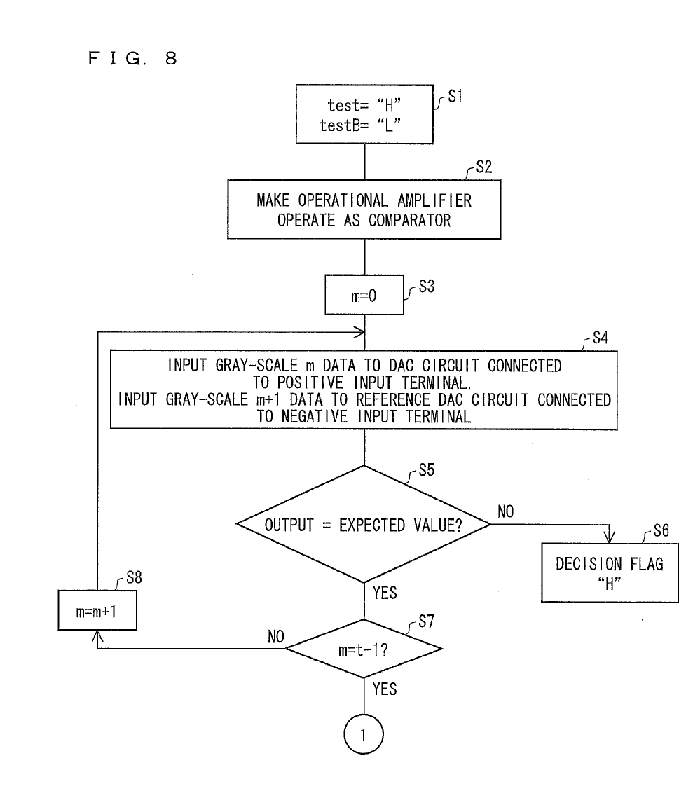

Next, a first procedure in an operation check test according to the first embodiment is described below with reference to FIG. 8. FIG. 8 is a flow chart showing the first procedure in the operation check test according to the first embodiment.

In Step S1 (hereinafter abbreviated as “S1”) shown in FIG. 8, the test signal test1 is raised to a “H” level, and the inversion test signal testB1 is lowered to a “L” level (S1), whereby the operational amplifier 1-1 functions as a comparator (S2).

Next, a control circuit (not illustrated) sets the expected value of the decision circuit 3-1 at a “L” level and initializes its counter m to 0 (S3).

Then, the control circuit inputs test gray-scale data having a gray scale of m to the DAC circuit 8-1 connected to the positive input terminal of the operational amplifier 1-1 and inputs test gray-scale data having a gray scale of m+1 to the reference DAC circuit 8-A connected to the negative input terminal of the operational amplifier 1-1 (S4).

When the counter m has a value of 0, the operational amplifier 1-1 receives a test output signal having a gray scale of 0 from the DAC circuit 8-1 through its positive input terminal, and receives a reference output signal having a gray scale of 1 from the reference DAC circuit 8-A through its negative input terminal. If the DAC circuit 8-1 connected to the two input terminals of the operational amplifier 1-1 is normal, the output of the operational amplifier 1-1 falls to a “L” level, because the gray scale of m is lower in voltage value than the gray scale of m+1.

Next, the decision circuit 3-1 determines whether the level of the output signal from the operational amplifier 1-1 matches the expected value stored in the decision circuit 3-1 (S5). If the output from the operational amplifier 1-1 is different from the expected value, the decision circuit 3-1 sends a “H” level signal to the decision flag 4-1, and the decision flag 4-1 outputs a signal Flag at a “H” level (S6).

These steps S4 to S6 are repeated with increments of 1 in value of the counter m until the counter m takes on a value of t−1 (S7, S8). It should be noted that “t” is the number of tones that the drive circuit 20 can output.

(Operation Check Test 2 of Embodiment 1)

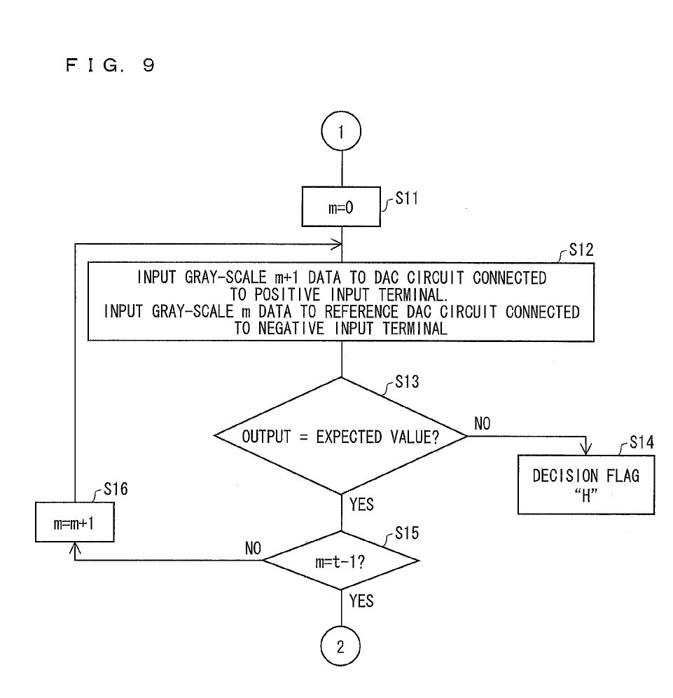

Next, a second procedure in the operation check test according to the first embodiment is described below with reference to FIG. 9. FIG. 9 is a flow chart showing the second procedure in the operation check test according to the first embodiment. This operation check test 2 is opposite to the operation check test 1 in terms of the voltage relationship between the test output signal and the reference output signal that are inputted through the positive input terminal and the negative input terminal respectively.

First, the control circuit (not illustrated) sets the expected value of the decision circuit 3-1 at a “H” level and initializes its counter m to 0 (S11).

Then, the control circuit inputs test gray-scale data having a gray scale of m+1 to the DAC circuit 8-1 connected to the positive input terminal of the operational amplifier and inputs test gray-scale data having a gray scale of m to the reference DAC circuit 8-A connected to the negative input terminal of the operational amplifier (S12). If the DAC circuit 8-1 connected to the two input terminals of the operational amplifier 1 is normal, the output of the operational amplifier 1 rises to a “H” level, because the gray scale of m+1 is higher in voltage value than the gray scale of m.

Next, the decision circuit 3-1 determines whether the level of the output signal from the operational amplifier 1 matches the expected value stored in the decision circuit 3-1 (S13). If the output from the operational amplifier 1-1 is different from the expected value, the decision circuit 3-1 sends a “H” level signal to the decision flag 4-1, and the decision flag 4-1 outputs a signal Flag at a “H” level (S14).

These steps S12 to S14 are repeated with increments of 1 in value of the counter m until the counter m takes on a value of t−1 (S15, S16).

(Operation Check Test 3 of Embodiment 1)

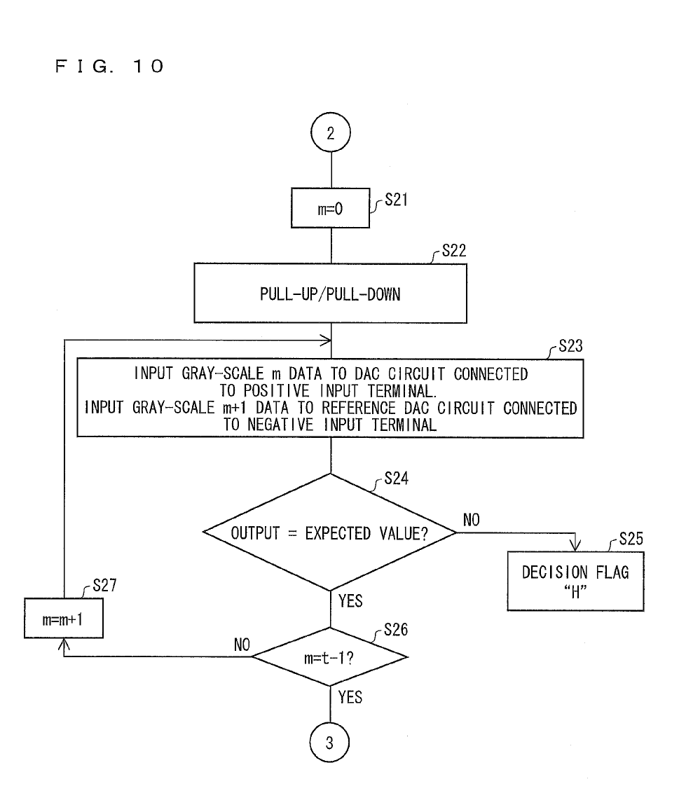

Next, a third procedure in the operation check test according to the first embodiment is described below with reference to FIG. 10.

When the DAC circuit 8-1 has such a failure as to have its output open, the operational amplifier 1-1 continues to retain a gray-scale voltage inputted thereto by an executed check test, so that a failure may not be detected by the operation check tests 1 and 2. The operation check test 1 is designed to detect a positive input terminal being lower in voltage than a negative input terminal. However, even when part of the gray scale voltage from a DAC circuit connected to the positive input terminal is not outputted, the previously outputted voltage is retained by a parasitic capacitor or the like; therefore, the positive input terminal becomes lower in voltage than the negative input terminal. For this reason, for the discovery of an open defect in the DAC circuit, the output of the DAC circuit is raised to a “H” level first, and then the DAC circuit is made to output a voltage according to the gray-scale data through its output.

FIG. 10 is a flow chart showing the third procedure in the operation check test according to the first embodiment.

First, as in the operation check tests 1 and 2, the control circuit (not illustrated) initializes its counter m to 0 (S21). Further, the drive circuit 20 has its pull-up and pull-down circuit 5-1 connected to the positive input terminal of the DAC circuit 8-1. The control circuit sets the expected value of the decision circuit 3-1 at a “L” level.

At this point in time, the control circuit controls the pull-up and pull-down circuit 5-1 so that the potential of the positive input terminal of the operational amplifier 1-1 is pulled up (S22).

Next, making the pull-up and pull-down circuit 5-1 disconnected, the control circuit inputs test gray-scale data having a gray scale of m to the DAC circuit 8-1 connected to the positive input terminal of the operational amplifier 1-1 and inputs test gray-scale data having a gray scale of m+1 to the reference DAC circuit 8-A connected to the negative input terminal of the operational amplifier 1-1 (S23).

If the DAC circuit 8-1 connected to the positive input terminal is normal, a voltage having a gray scale of m is outputted but, in the case of an open defect, the voltage supplied by the pull-up and pull-down circuit 5-1 is kept retained. Because the pulled-up voltage is higher than a voltage having a gray scale of m+1, the output of the operational amplifier 1-1 rises to a “H” level. Further, if the DAC circuit 8-1 connected to the two input terminals of the operational amplifier 1-1 is normal, the output of the operational amplifier 1-1 falls to a “L” level, because the gray scale m is lower in voltage value than the gray scale of m+1.

Next, the decision circuit 3-1 determines whether the level of the output signal from the operational amplifier 1-1 matches the expected value stored in the decision circuit 3-1 (S24). If the output from the operational amplifier 1-1 is different from the expected value, the decision circuit 3-1 sends a “H” level signal to the decision flag 4-1, and the decision flag 4-1 outputs a signal Flag at a “H” level (S25). These steps S22 to S25 are repeated with increments of 1 in value of the counter m until the counter m takes on a value of t−1 (S26, S27).

(Operation Check Test 4 of Embodiment 1)

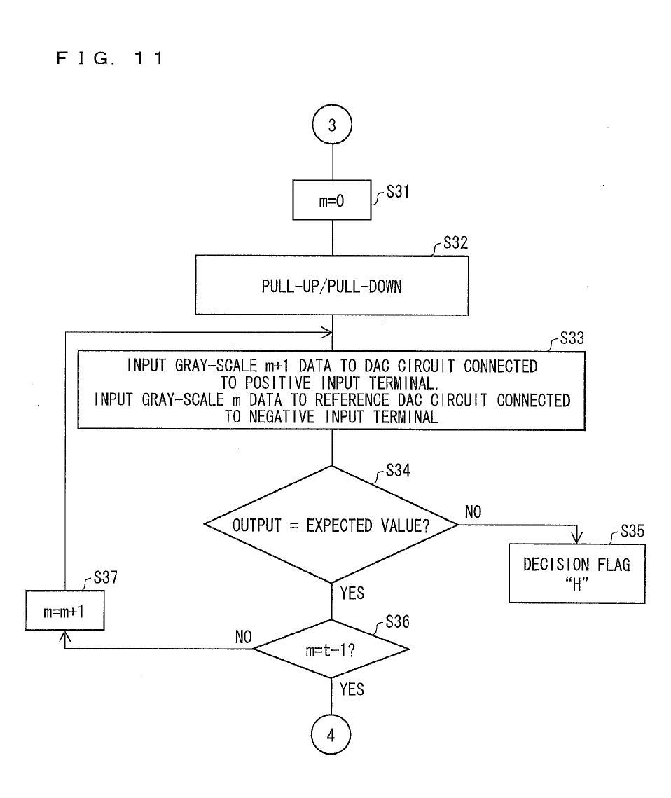

Next, a fourth procedure in the operation check test according to the first embodiment is described below with reference to FIG. 11. FIG. 11 is a flow chart showing the fourth procedure in the operation check test according to the first embodiment.

The operation check test 4 is designed to detect a failure of the same kind as the operation check test 3. First, as in the operation check test 3, the control circuit (not illustrated) initializes its counter m to 0 (S31). Further, the drive circuit 20 has its pull-up and pull-down circuit 5-1 connected to the positive input terminal of the DAC circuit 8-1. The control circuit sets the expected value of the decision circuit 3-1 at a “H” level.

At this point in time, the control circuit controls the pull-up and pull-down circuit 5-1 so that the potential of the positive input terminal of the operational amplifier 1-1 is pulled down (S33).

Next, making the pull-up and pull-down circuit 5-1 disconnected, the control circuit inputs test gray-scale data having a gray scale of m+1 to the DAC circuit 8-1 connected to the positive input terminal of the operational amplifier 1-1 and inputs test gray-scale data having a gray scale of m to the reference DAC circuit 8-A connected to the negative input terminal of the operational amplifier 1-1 (S33).

If the DAC circuit 8-1 connected to the positive input terminal is normal, a voltage having a gray scale of m+1 is outputted but, in the case of an open defect, the voltage supplied by the pull-up and pull-down circuit 5-1 is kept retained. Because the pulled-up voltage is lower than a voltage having a gray scale of m, the output of the operational amplifier 1-1 falls to a “L” level. Further, if the DAC circuit 8-1 connected to the two input terminals of the operational amplifier 1-1 is normal, the output of the operational amplifier 1-1 rises to a “H” level, because the gray scale m+1 is higher in voltage value than the gray scale of m.

Next, the decision circuit 3-1 determines whether the level of the output signal from the operational amplifier 1-1 matches the expected value stored in the decision circuit 3-1 (S34). If the output from the operational amplifier 1-1 is different from the expected value, the decision circuit 3-1 sends a “H” level signal to the decision flag 4-1, and the decision flag 4-1 outputs a signal Flag at a “H” level (S35). These steps S32 to S35 are repeated with increments of 1 in value of the counter m until the counter m takes on a value of t−1 (S36, S37).

(Operation Check Test 5 of Embodiment 1)

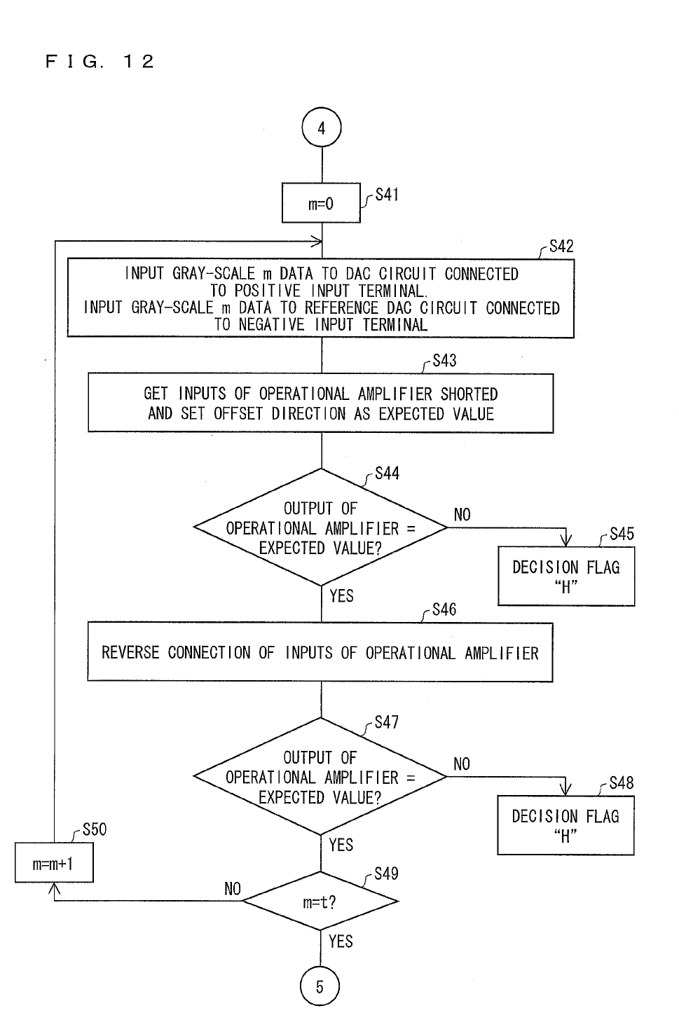

Next, a fifth procedure in the operation check test according to the first embodiment is described below with reference to FIG. 12. FIG. 12 is a flow chart showing the fifth procedure in the operation check test according to the first embodiment.

A DAC circuit may have such a failure as to have its two adjacent tones shorted. In such a case where two adjacent tones are shorted, the DAC circuit ends up outputting an intermediate voltage between the two shorted tones. In the case of such a failure, the DAC circuit outputs a gray-scale voltage shifted by not more than 1 tone from a gray-scale voltage that is outputted in a normal case; therefore, such a failure cannot be detected by the operation check tests 1 to 4. Accordingly, the operation check test 5 is designed to detect such a failure in a DAC circuit having its two adjacent tones shorted.

First, the control circuit (not illustrated) initializes its counter m to 0 (S41). Next, test gray-scale data and reference gray-scale data that are inputted to the DAC circuit 8-1 and the reference DAC circuit 8-A connected to the positive input terminal and negative input terminal of the operational amplifier 1-1, respectively, are made to have a gray scale of m. That is, gray-scale voltages of the same gray scale of m are outputted to the DAC circuit 8-1 and the reference DAC circuit 8-A (S142).

Next, the control circuit makes the positive input terminal and negative input terminal of the operational amplifier 1-1 short-circuited through a switch (not illustrated). By thus making the positive input terminal and negative input terminal of the operational amplifier 1-1 short-circuited, identical voltages are inputted to the positive input terminal and negative input terminal of the operational amplifier 1-1; therefore, an offset of the operational amplifier 1-1 causes the output of the operational amplifier 1-1 to rise to a “H” or “L” level. Next, the decision circuit 3-1 stores, as an expected value, the level of the output of the operational amplifier 1-1 as attained when the positive input terminal and negative input terminal of the operational amplifier 1-1 are short-circuited (S43).

Next, turning OFF the switch (not illustrated), the control circuit makes the positive input terminal and negative input terminal of the operational amplifier 1-1 no longer short-circuited. Then, gray-scale voltages having a gray scale of m are inputted to the positive input terminal and negative input terminal of the operational amplifier 1-1. At this point in time, the decision circuit 3-1 compares the output from the operational amplifier 1-1 with the expected value stored in the decision circuit 3-1 (S44).

Furthermore, if the output from the operational amplifier 1-1 is different from the expected value stored in the decision circuit 3-1, the decision flag 4-1 outputs a signal Flag at a “H” level (S45). Furthermore, the decision flag 4-1 stores therein the “H” flag sent from the decision circuit 3-1.

Next, the control circuit uses the switch (not illustrated) to swap the signals that are inputted to the positive input terminal and negative input terminals of the operational amplifier 1-1 with each other (S46). After that, a step identical to the step S44 is carried out (S47). Further, as in S45, if the output from the operational amplifier 1-1 is different from the expected value stored in the decision circuit 3-1, the decision flag 4-1 outputs a signal Flag at a “H” level (S48).

These steps S142 to S148 are repeated with increments of 1 in value of the counter m until the counter m takes on a value of t (S49, S50).

(Self-Repairing of Embodiment 1)

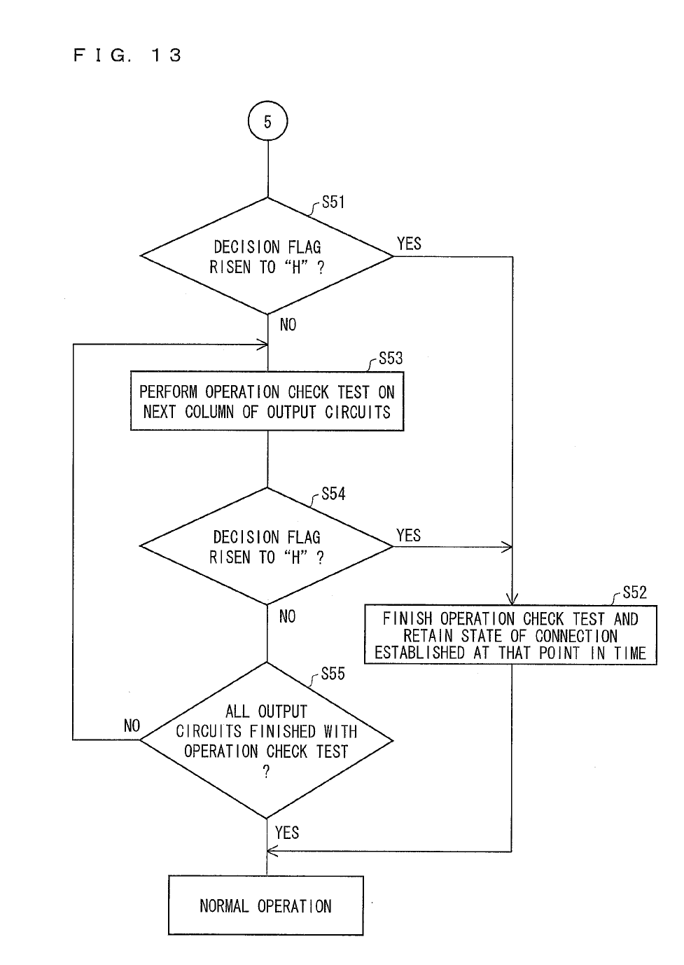

Next, self-repairing that is carried out when a decision flag 4 has a signal Flag at a “H” level stored therein or, in other word, when a decision circuit 3 determines, in the operation check tests 1 to 5, that there is a failure in a DAC circuit 8 is described below with reference to FIG. 13. FIG. 13 is a flow chart showing a self-repairing procedure according to the first embodiment.

The operation check test on the first column of output circuits is terminated with the operation check tests 1 to 5. If, during these operation check tests 1 to 5, the decision flag 4-1 outputs the signal Flag1 at a “H” level, i.e., if a transition is made to any one of the steps S6, S14, S25, S35, S45, and S48 (“YES” in S51), the operation check is terminated, and the state of connection at the point in time when the decision flag 4-1 outputted the signal Flag1 at a “H” level is retained (S55). This allows the DAC circuits 8 excluding the DAC circuit 8-1 and the operational amplifiers 1 excluding the operational amplifier 1-1 to carry out normal driving of the display panel, with the connection kept broken between the DAC circuit 8-1 determined to be failed and the display panel.

On the other hand, if, during the operation check tests 1 to 5, the decision flag 4-1 does not output the signal Flag1 at a “H” level (“NO” in S51), an operation check test on the next column of output circuits (the DAC circuits 8-2 and the operational amplifier 1-2) is carried out in the same manner as the operation check tests 1 to 5 (S53). In this case, too, if the decision flag 4-2 outputs the signal Flag2 at a “H” level (“YES” in S54), the operation check is terminated, and the state of connection at the point in time when the decision flag 4-2 outputted the signal Flag2 at a “H” level is retained (S55).

The steps S53 and S54 are repeated up to the last stage of output circuits (the DAC circuit 8-n and the operational amplifier 1-n) and, if checking of operations of all of the output circuits is terminated (“YES” in S55) with no one of the decision flags 4 having outputted a signal Flag at a “H” level, the test signals test and the inversion test signals testB all fall to a “L” level and at a “H” level, respectively, whereby a transition is made to normal operation.

### Embodiment 2

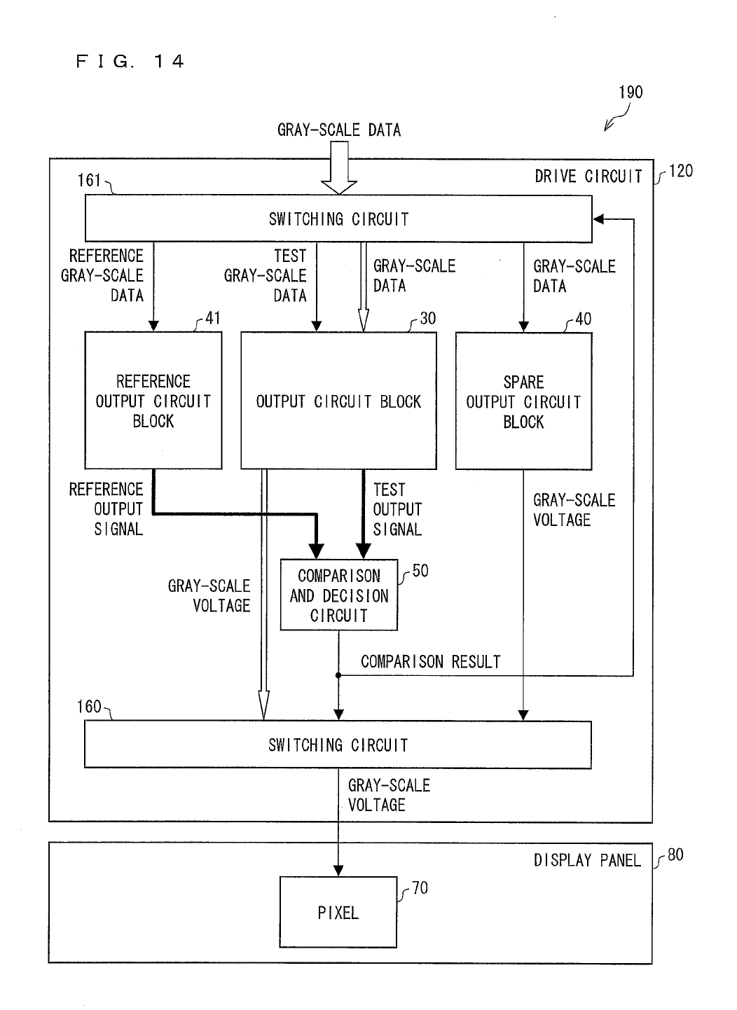

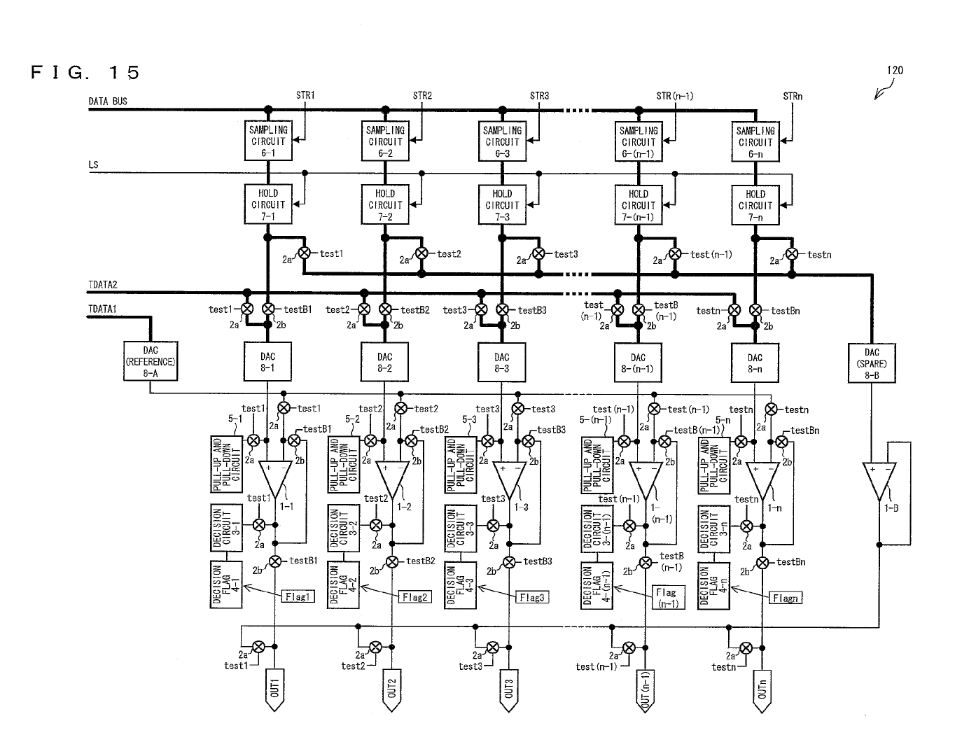

A second embodiment of the present invention is described below with reference to FIGS. 14 and 15. The present embodiment describes a display device 190, which is a modification of the display device 90 according to the first embodiment.

(Configuration of the Display Device 190)

The configuration of the display device 190 according to the present embodiment is schematically described with reference to FIG. 14. FIG. 14 is a block diagram schematically showing the configuration of the display device 190. The display device 190 includes a display panel 80 and a drive circuit 120. The drive circuit 120 is configured by replacing the switching circuits 60 and 61 of the drive circuit 20 shown in FIG. 2 with switching circuits 160 and 161, respectively.

The drive circuit 20 shown in FIG. 2 is configured such that for an operation check test, an output circuit whose operation is to be checked is disconnected from the display panel by the switching circuits 60 and 61 switching states of connection so that the gray-scale data from the outside source is inputted to a column of output circuits next to the column of output circuits to which it would be inputted during a normal operation and the gray-scale data which would be inputted to the last column of output circuits during a normal operation is inputted to the spare output circuit block 40. Meanwhile, the switching circuits 160 and 161 shown in FIG. 14 are configured such that an output circuit whose operation is to be checked is disconnected from driving of the display panel by inputting, to a spare output circuit, input data which would during a normal operation be inputted to the output circuit whose operation is to be checked and connecting, to the spare output circuit, an output terminal which would during a normal operation be connected to the output circuit whose operation is to be checked.

(Configuration of the Drive Circuit 120)

The configuration of the drive circuit 120 is described with reference to FIG. 15. FIG. 15 is a block diagram schematically showing the configuration of the drive circuit 120.

As shown in FIG. 15, the drive circuit 20 includes: n sampling circuits 6-1 to 6-n (hereinafter sometimes collectively referred to as “sampling circuits 6” in the present embodiment), which receive gray-scale data corresponding to n liquid crystal driving signal output terminals OUT1 to OUT n (hereinafter sometimes collectively referred to as “output terminals OUT” in the present embodiment) from a gray-scale data input terminal (not illustrated) through the data bus, respectively; n hold circuits 7-1 to 7-n (hereinafter sometimes collectively referred to as “hold circuits 7” in the present embodiment); n DAC circuits 8-1 to 8-n and a spare DAC circuit 8-B (hereinafter sometimes collectively referred to as “DAC circuits 8” in the present embodiment), which convert gray-scale data into gray-scale voltage signals, and a reference DAC circuit 8-A, which converts reference gray-scale data into a reference output signal; n operational amplifiers 1-1 to 1-n and a spare operational amplifier 1-B (hereinafter sometimes collectively referred to as “operational amplifiers 1” in the present embodiment), which serve as buffer circuits for the gray-scale voltage signals from the DAC circuits 8; n decision circuits 3-1 to 3-n (hereinafter sometimes collectively referred to as “decision circuits 3” in the present embodiment); n decision flags 4-1 to 4-n (hereinafter sometimes collectively referred to as “decision flags 4” in the present embodiment); and n pull-up and pull-down circuits 5-1 to 5-n (hereinafter sometimes collectively referred to as “pull-up and pull-down circuits 5” in the present embodiment).

Furthermore, as shown in FIG. 15, the drive circuit 20 includes: a plurality of switches 2a, which switch between ON and OFF according to test signals test (test1 to testn), respectively; and a plurality of switches 2b, which switch between ON and OFF according to inversion test signals testB (testB1 to testBn) obtained by inverting the test signals test, respectively. Each of the switches 2a and 2b becomes ON upon receiving a “H” level signal and becomes OFF upon receiving a “L” level signal.

It should be noted, in FIG. 15, that the DAC circuits 8 and the operational amplifiers 1 correspond to the output circuit block 30 shown in FIG. 14, that the reference DAC circuit 8-A corresponds to the reference output circuit block 41 shown in FIG. 14, and that the spare DAC circuit 8-B corresponds to the spare output circuit block 40 shown in FIG. 14. Further, the operational amplifiers 1, the decision circuits 3, and the decision flags 4 correspond to the comparison and decision circuit 50 shown in FIG. 14, and the operational amplifiers 1 serve both as buffers of the output circuit block 30 and comparators of the comparison and decision circuit 50. Further, those switches 2a provided between the hold circuits 7 and the spare DAC circuit 8-B, those switches 2b provided between the hold circuits 7-1 to 7-n and the DAC circuits 8-1 to 8-n, and those switches 2a provided between the DAC circuits 8-1 to 8-n and a test data bus correspond to the switching circuit 161 shown in FIG. 14. Further, the switches SWB correspond to the switching circuit 160 shown in FIG. 14. It should be noted that the drive circuit 120 shown in FIG. 14 is connected to the display panel 80 shown in FIG. 14 through the output terminals OUT1 to OUTn and that FIG. 15 omits to illustrate the display panel 80.

Test signals test and inversion test signals testB are generated by the test signal generation circuit 51 shown in FIG. 4. That is, the waveforms of the test signals test and inversion test signals testB in the present embodiment are identical to the waveforms of the test signals test and inversion test signals testB in the first embodiment. It should be noted that the test signals test and inversion test signals testB in the present embodiment may be generated by the test signal generation circuit 52 shown in FIG. 7.

(Normal Operation of the Drive Circuit 120)

Since, during a normal operation, the test signal generation circuit 51 shown in FIG. 4 has its shift register reset, the test signals test1 to testn are all at a “L” level.

See FIG. 15. In order to sample the gray-scale data supplied to the data bus, the sampling circuits 6-1 to 6-n receive sampling signals STR1 to STRn (hereinafter sometimes collectively referred to as “sampling signals STR” in the present embodiment) from a pointer shift register (not illustrated) through their gates as the sampling signals STR1 to STRn rise to a “H” level in sequence. The sampling circuits 6 are constituted by latch circuits that load the data during a period of time when their gates are at a “H” level. During a period of time when the gate signals are at a “H” level, the sampling circuits 6 load the data from the data bus, and during a period of time when the gate signals are at a “L” level, the sampling circuits 6 retain the data loaded during the “H” level period.

After the sampling circuits 6-1 to 6-n have finished loading the data, a signal LS line connected to the hold circuits 7 is supplied with a signal LS at a “H” level. The signal LS is supplied to the gates of the hold circuits 7, and during a period of time when the gates are at a “H” level, the hold circuits 7 load the data retained by the sampling circuits 6 connected thereto, respectively. Further, the hold circuits 7 retain the loaded data after the signal LS has fallen to a “L” level.

Since, at this point in time, the test signals test1 to testn are all at a “L” level, the inversion test signals testB1 to testBn are all at a “H” level. This causes the gray-scale data to be sent from the hold circuits 7-1 to 7-n to the DAC circuits 8-1 to 8-n, respectively. This in turn causes the DAC circuits 8-1 to 8-n to convert the gray-scale data retained in the hold circuits 7-1 to 7-n into gray-scale voltage signals and send them as gray-scale voltages to the positive input terminals of the operational amplifiers 1-1 to 1-n, respectively.

It should be noted here that since the switches 2b are ON, the operational amplifiers 1-1 to 1-n have their outputs fed negatively back to their negative input terminals, respectively. This allows the operational amplifiers 1-1 to 1-n to function as voltage followers. As such, the operational amplifiers 1-1 to 1-n buffer the gray-scale voltages sent from the DAC circuits 8-1 to 8-n and send them to the corresponding output terminals OUT1 to OUTn, respectively.

(Outline of an Operation Check Test)

When an operation check test is started, the test signal test1 rises to a “H” level, and the inversion test signal testB1 falls to a “L” level. At this point in time, the switch 2a provided between the output of the hold circuit 7-1 and the DAC circuit 8-B becomes ON, whereby the hold circuit 7-1 is connected to the spare DAC circuit 8-B. The other hold circuits 7-2 to 7-n are connected to the DAC circuits 8-2 to 8-n in the same manner as in the case of a normal operation.

Further, the switch 2a provided between the output terminal OUT1 and the operational amplifier 1-B becomes ON, whereby the output terminal OUT1 is connected to the spare operational amplifier 1-B. The other output circuits OUT2 to OUTn are connected to the operational amplifiers 1-2 to 1-n in the same manner as in the case of a normal operation.

Since the inversion test signal testB1 is at a “L” level, the switches 2b provided between the DAC circuit 8-1 and the hold circuit 7-1 and between the operational amplifier 1-1 and the output terminal OUT1 become OFF. This causes the DAC circuit 8-1 and the operational amplifier 1-1 to be disconnected from the hold circuit 7-1 and the output terminal OUT1, respectively, whereby the DAC circuit 8-1 and the operational amplifier 1-1 become irrelevant to the driving of the display panel.

The subsequent operation check test on the operational amplifier 1-1 and the DAC circuit 8-1 is identical in concrete content to the operation check tests 1 to 5 of the first embodiment. That is, since the test signal test1 is at a “H” level, those switches 2a and 2b connected to the input and output terminals of the operational amplifier 1-1 become “ON” and “OFF”, respectively. Accordingly, the operational amplifier 1-1 comes to have its negative input terminal disconnected from its output terminal and connected to the reference DAC circuit 8-A. This connection allows the operational amplifier 1-1 to function as a comparator to compare the voltage of the DAC circuit 8-1 with the voltage of the reference DAC circuit 8-A and send its output to the decision circuit 3-1. Further, the operational amplifiers 1-2 to 1-n and the spare operational amplifier 1-B function as normal-operation buffers. This makes it possible to drive the display panel while carrying out the operation check test.

When the checking of operations of the DAC circuit 8-1 and the operational amplifier 1-1 is terminated, the test signal test2 rises to a “H” level, and the inversion test signal testB2 falls to a “L” level. At this point in time, the switch 2a provided between the output of the hold circuit 7-2 and the DAC circuit 8-B becomes ON, whereby the hold circuit 7-2 is connected to the spare DAC circuit 8-B. The other hold circuits 7-1 and 7-3 to 7-n are connected to the DAC circuits 8-1 and 8-3 to 8-n in the same manner as in the case of a normal operation.

Further, the switch 2a provided between the output terminal OUT2 and the spare operational amplifier 1-B becomes ON, whereby the output terminal OUT2 is connected to the spare operational amplifier 1-B. The other output circuits OUT1 and OUT3 to OUTn are connected to the operational amplifiers 1-1 and 1-3 to 1-n in the same manner as in the case of a normal operation.

Since, during a period of time when the test signal test2 is at a “H” level, the inversion test signal testB2 is at a “L” level, the switches 2b provided between the DAC circuit 8-2 and the hold circuit 7-2 and between the operational amplifier 1-2 and the output terminal OUT2 become OFF. This causes the DAC circuit 8-2 and the operational amplifier 1-2 to be disconnected from the hold circuit 7-2 and the output terminal OUT2, respectively, whereby the DAC circuit 8-2 and the operational amplifier 1-2 become irrelevant to the driving of the display panel.

The subsequent operation check test on the operational amplifier 1-2 and the DAC circuit 8-2 is identical in concrete content to the operation check tests 1 to 5 of the first embodiment. Further, the operational amplifiers 1-1 and 1-3 to 1-n and the spare operational amplifier 1-B function as normal-operation buffers. This makes it possible to drive the display panel while carrying out the operation check test.

Similarly, during periods of time when the test signals test 3 to testn are at a “H” level, the operations of the DAC circuits 8-3 to 8-n are checked by making changes in connection, respectively. If the signals Flag outputted from the decision flags 4 are all at a “L” level, or if any of the signals Flag rises to a “H” level in the middle of the checking of operations, a process is carried out which is identical in concrete content to that of the first embodiment.

### Embodiment 3

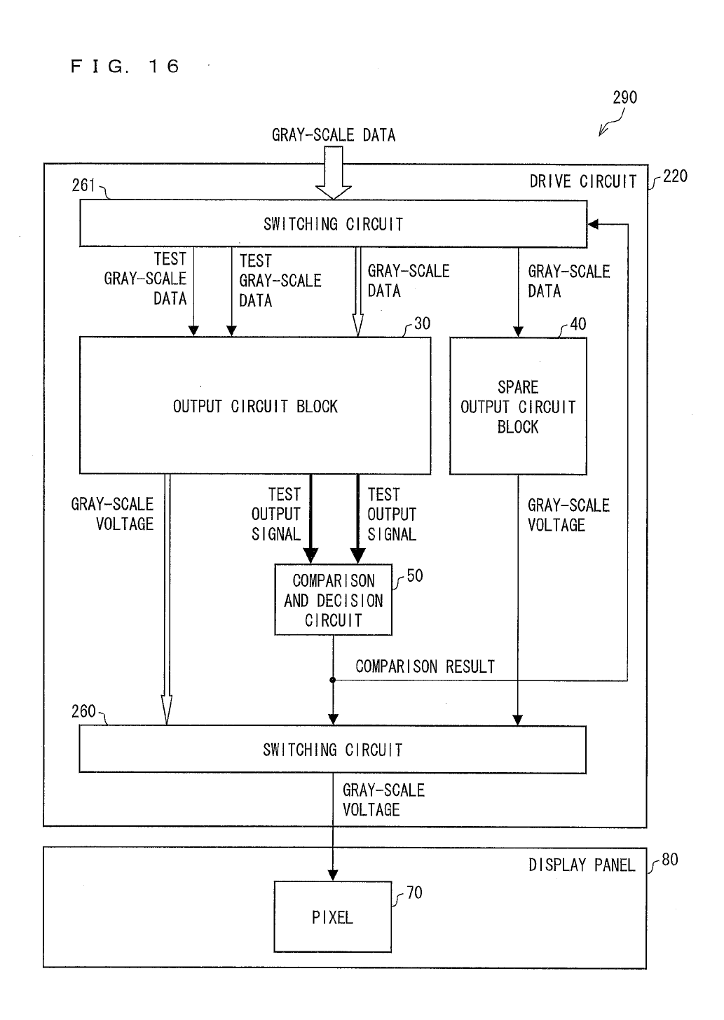

A third embodiment of the present invention is described below with reference to FIGS. 16 through 19. The present embodiment describes a display device 290, which is another modification of the display device 90 according to the first embodiment.

(Configuration of the Display Device 290)

First, the configuration of the display device 290 according to the present embodiment is schematically described with reference to FIG. 16. FIG. 16 is a block diagram schematically showing the configuration of the display device 290. The display device 290 includes a display panel 80 and a drive circuit 220. The drive circuit 220 is configured by omitting the reference output circuit block 41 from the drive circuit 20 shown in FIG. 2 and replacing the switching circuits 60 and 61 of the drive circuit 20 shown in FIG. 2 with switching circuits 260 and 261, respectively.

The drive circuit 20 shown in FIG. 2 is configured to, during an operation check test, compare an output signal from an output circuit selected from the output circuit block 30 with a reference output signal from the reference output circuit block 41. Meanwhile, the drive circuit 220 shown in FIG. 16 is configured to detect a defect in an output circuit by comparing test output signals from two output circuits selected from the output circuit block 30.

(Configuration of the Drive Circuit 220)

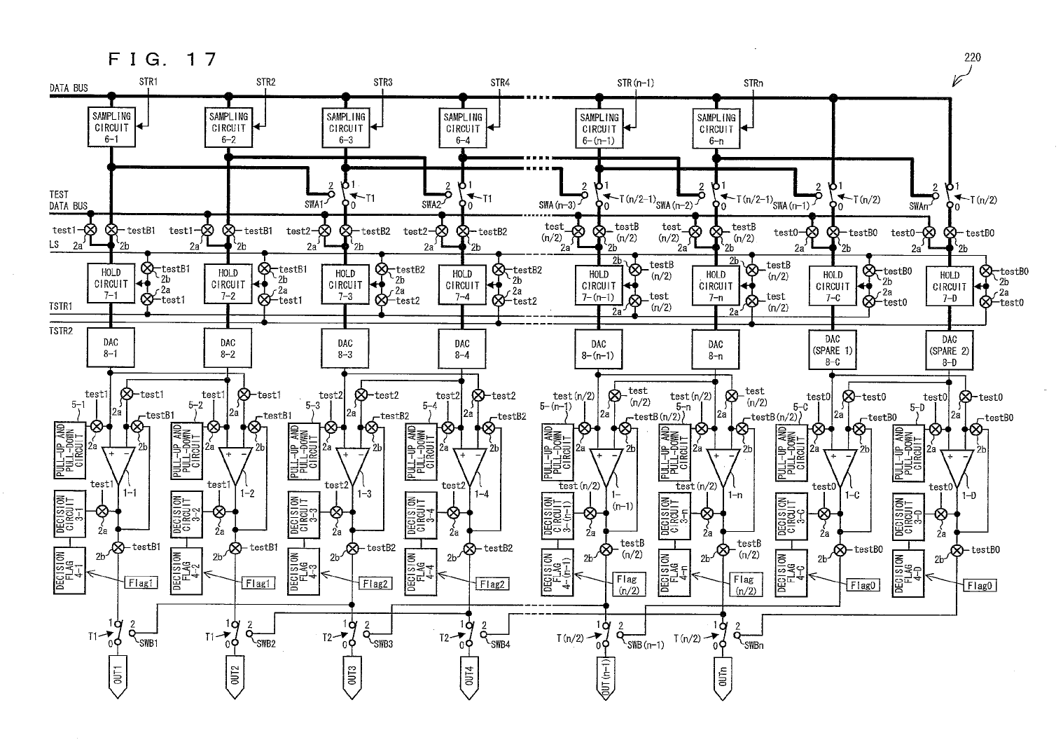

The configuration of the drive circuit 220 is described with reference to FIG. 17. Whereas the drive circuit 20 shown in FIG. 3 is configured to switch connections between the hold circuits 7 and the DAC circuits 8 for an operation check test, the drive circuit 220 shown in FIG. 17 is configured to switch connections between the sampling circuits 6 and the hold circuits 7.

As shown in FIG. 17, the drive circuit 220 includes: n sampling circuits 6-1 to 6-n (hereinafter sometimes collectively referred to as “sampling circuits 6” in the present embodiment), which receive gray-scale data corresponding to n liquid crystal driving signal output terminals OUT1 to OUT n (hereinafter sometimes collectively referred to as “output terminals OUT” in the present embodiment) from a gray-scale data input terminal (not illustrated) through the data bus, respectively; n hold circuits 7-1 to 7-n and two spare hold circuits 7-C and 7-D (hereinafter sometimes collectively referred to as “hold circuits 7” in the present embodiment); n DAC circuits 8-1 to 8-n and two spare DAC circuits 8-C and 8-D (hereinafter sometimes collectively referred to as “DAC circuits 8” in the present embodiment), which convert gray-scale data into gray-scale voltage signals; n operational amplifiers 1-1 to 1-n and two spare operational amplifier 1-C and 1-D (hereinafter sometimes collectively referred to as “operational amplifiers 1” in the present embodiment), which serves as buffer circuits for the gray-scale voltage signals from the DAC circuits 8; n decision circuits 3-1 to 3-n and two spare decision circuits 3-C and 3-D (hereinafter sometimes collectively referred to as “decision circuits 3” in the present embodiment); n decision flags 4-1 to 4-n and two spare decision flags 4-C and 4-D (hereinafter sometimes collectively referred to as “decision flags 4” in the present embodiment); and n pull-up and pull-down circuits 5-1 to 5-n and two spare pull-up and pull-down circuits 5-C and 5-D (hereinafter sometimes collectively referred to as “pull-up and pull-down circuits 5” in the present embodiment).

Furthermore, as shown in FIG. 17, the drive circuit 220 includes: a plurality of switches 2a, which switch between ON and OFF according to test signals test (test0 to test(n/2)), respectively; a plurality of switches 2b, which switch between ON and OFF according to inversion test signals testB (testB0 to testB(n/2)) obtained by inverting the test signals test, respectively; n switches SWA1 to SWAn (hereinafter sometimes collectively referred to as “switches SWA” in the present embodiment), which change connections according to gate signals T1 to T(n/2−1), respectively; and n switches SWB1 to SWBn (hereinafter sometimes collectively referred to as “switches SWB” in the present embodiment), which change connections according to the gate signals T1 to T(n/2), respectively. Each of the switches 2a and 2b becomes ON upon receiving a “H” level signal and becomes OFF upon receiving a “L” level signal.

Further, each of the switches SWA and SWB is a switch circuit which includes a terminal 0, a terminal 1, and a terminal 2 and which has two states of connection, namely a state of connection where the terminal 0 is connected to the terminal 1 and a state of connection where the terminal 0 is connected to the terminal 2. Specifically, the switch SWAh (h=1 to n−2) has its terminal 0 connected to the hold circuit 7-(h+2) through a switch 2b, and has its terminals 1 and 2 connected to the sampling circuits 6-(h+2) and 6-i, respectively. Further, the switch SWA(n−1) has its terminal 0 connected to the spare hold circuit 7-C through a switch 2b, and has its terminals 1 and 2 connected to the data bus and the sampling circuit 6-(n−1), respectively. Further, the switch SWAn has its terminal 0 connected to the spare hold circuit 7-D through a switch 2b, and has its terminals 1 and 2 connected to the data bus and the sampling circuit 6-n, respectively.

Meanwhile, the switch SWBh (h=1 to n−2) has its terminals 0, 1, and 2 connected to the output terminal OUTh, the output terminal of the operational amplifier 1-h, and the output terminal of the operational amplifier 1-(h+2), respectively. Further, the switch SWB(n−1) has its terminals 0, 1, and 2 connected to the output terminal OUT(n−1), the output terminal of the operational amplifier 1-(n−1), and the output terminal of the spare operational amplifier 1-C, respectively. Further, the switch SWBn has its terminals 0, 1, and 2 connected to the output terminal OUTn, the output terminal of the operational amplifier 1-n, and the output terminal of the spare operational amplifier 1-D, respectively.

Each of the switches SWA and SWB switches its states of connection according to the value of a gate signal. Specifically, the terminal 0 is connected (conducted) to the terminal 2 when the gate signal is “H”, and the terminal 0 is connected (conducted) to the terminal 1 when the gate signal is “L”. The gate signals T1 to Tn are represented by logical formulas shown in Math. 2 as follows:

$$\begin{matrix}\begin{matrix}\begin{matrix}\begin{matrix}\begin{matrix}T 1 = test 1 \\ T 2 = test 1 + test 2\end{matrix} \\ T 3 = test 1 + test 2 + test 3\end{matrix} \\ ⋮\end{matrix} \\ T ( n / 2 - 1 ) = test 1 + test 2 + test 3 + … + test ( n / 2 - 1 )\end{matrix} \\ T ( n / 2 ) = test 1 + test 2 + test 3 + … + test ( n / 2 )\end{matrix} \qquad [ Math . 2 ]$$

It should be noted, in FIG. 17, that the DAC circuits 8 and the operational amplifiers 1 correspond to the output circuit block 30 shown in FIG. 16 and that the spare DAC circuits 8-C and 8-D correspond to the spare output circuit block 40 shown in FIG. 16. Further, the operational amplifiers 1, the decision circuits 3, and the decision flags 4 correspond to the comparison and decision circuit 50 shown in FIG. 14, and the operational amplifiers 1 serve both as buffers of the output circuit block 30 and comparators of the comparison and decision circuit 50. Further, those switches 2a provided between the hold circuits 7 and the spare DAC circuit 8-D and those switches SWA, 2a, and 2b connected to the hold circuits 7 correspond to the switching circuit 261 shown in FIG. 16. Further, the switches SWB correspond to the switching circuit 260 shown in FIG. 16. It should be noted that the drive circuit 220 shown in FIG. 16 is connected to the display panel 80 shown in FIG. 16 through the output terminals OUT1 to OUTn and that FIG. 17 omits to illustrate the display panel 80.

During a normal operation, each operational amplifier 1 feeds back an output to its negative input to function as a voltage follower buffer. Meanwhile, during an operation check, connections are changed so that each operational amplifier 1 functions as a comparator by receiving through its positive input terminal an output from a DAC circuit 8 connected in series to that operational amplifier 1 and receiving through its negative input terminal an output from an DAC circuit 8 adjacent to that DAC circuit 8.

Specifically, as shown in FIG. 17, the operational amplifier 1-1 receives an output from the DAC circuit 8-1 through its positive input terminal and receives an output from the DAC circuit 8-2 through its negative input terminal via the switch 2a that is controlled by the test signal test1. Similarly, the operational amplifier 1-2 receives an output from the DAC circuit 8-2 through its positive input terminal and receives an output from the DAC circuit 8-1 through its negative input terminal via the switch 2a that is controlled by the test signal test1.

(Normal Operation of the Drive Circuit 220)

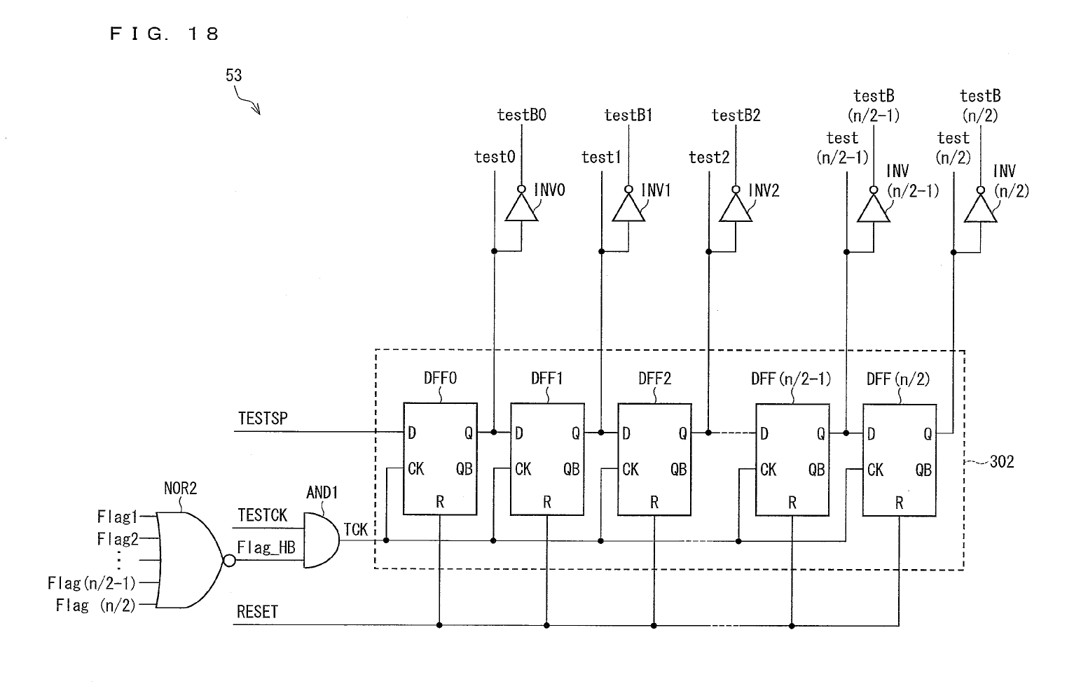

FIG. 18 shows a test signal generation circuit 53 for generating test signals test and inversion test signals testB. The test signal generation circuit 53 is configured by replacing the shift register 301 and NOR gate NOR1 of the test signal generation circuit 51 shown in FIG. 4 with a shift register 302 and a NOR gate NOR2, respectively.

The shift register 302 is constituted by (n/2)+1 D-type flip-flops DFF0 to DFF(n/2). Further, the NOR gate NOR2, which has (n/2) input terminals, receives signals Flag1 to Flag(n/2) (hereinafter sometimes collectively referred to as “signals Flag” in the present embodiment) from the decision flags 4-1 to 4-n shown in FIG. 17 through its input terminals, respectively. As will be described later, the signals Flag rise to a “H” level only when an operational abnormality in the operational amplifiers 1 is detected. Therefore, during a normal operation, the signal Flag_HB is at a “H” level.

During the normal operation of the drive circuit 20, the reset signal RESET is retained at a “H” level so that the shift register 302 is in a reset state. Accordingly, the test signals test1 to test(n/2) fall to a “L” level and the inversion test signal testB1 to testB(n/2) rise to a “H” level. At this point in time, according to Math. 2, the gate signals T1 to T(n/2) all fall to a “L” level.

See FIG. 17. In order to sample the gray-scale data supplied to the data bus, the sampling circuits 6-1 to 6-n receive sampling signals STR1 to STRn (hereinafter sometimes collectively referred to as “sampling signals STR” in the present embodiment) from a pointer shift register (not illustrated) through their gates as the sampling signals STR1 to STRn rise to a “H” level in sequence. The sampling circuits 6 are constituted by latch circuits that load the data during a period of time when their gates are at a “H” level. During a period of time when the sampling signals STR are at a “H” level, the sampling circuits load the gray-scale data from the data bus, and during a period of time when the sampling signals STR are at a “L” level, the sampling circuits retain the gray-scale data loaded during the “H” level period.

Since the gate signals T1 to T(n/2) are all at a “L” level, each of the switches SWA connects its terminal 0 to its terminal 1. Therefore, the sampling circuits 6-1 to 6-n are connected to the hold circuits 7-1 to 7-n, respectively.

After the sampling circuits 6-1 to 6-n have finished loading the data, a signal LS line connected to the hold circuits 7-1 to 7-n is supplied with a signal LS at a “H” level. At this point in time, the inversion test signals testB are all at a “H” level; therefore, the signal LS is supplied to the gates of the hold circuits 7-1 to 7-n, and during a period of time when the gates are at a “H” level, the hold circuits 7-1 to 7-n load the gray-scale data retained by the sampling circuits 6-1 to 6-n connected thereto, respectively. Further, the hold circuits 7-1 to 7-n retain the loaded gray-scale data after the signal LS has fallen to a “L” level.

In the drive circuit 220, it is necessary to carry out a display even while loading the gray-scale data. For this reason, the hold circuits 7 retain the loaded gray-scale data as described above, and output display drive signals in accordance with the retained data. Further, the hold circuits 7 are designed to load the data from the data bus while outputting the display drive signals.

This causes the DAC circuits 8-1 to 8-n to convert the gray-scale data retained in the hold circuits 7-1 to 7-n into gray-scale voltage signals and send them as gray-scale voltages to the positive input terminals of the operational amplifiers 1-1 to 1-n, respectively. It should be noted here that since the switches 2b are ON, the operational amplifiers 1-1 to 1-n have their outputs fed negatively back to their negative input terminals, respectively. This allows the operational amplifiers 1-1 to 1-n to function as voltage followers. As such, the operational amplifiers 1-1 to 1-n buffer the gray-scale voltages sent from the DAC circuits 8-1 to 8-n and send them to the corresponding output terminals OUT1 to OUTn, respectively.

(Outline of an Operation Check Test)

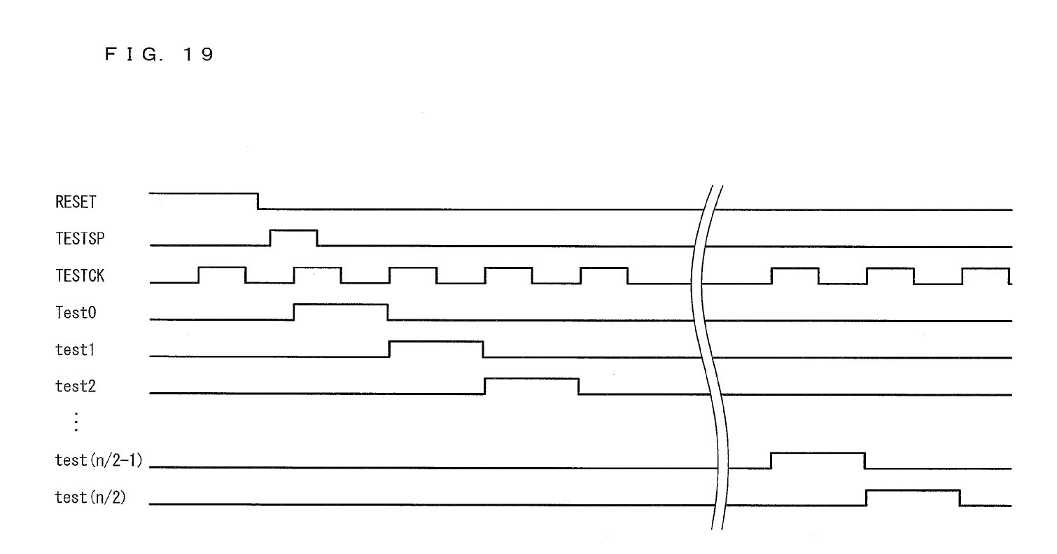

FIG. 19 shows the waveforms of a reset signal RESET, a signal TESTSP, a signal TESTCK, and test signals test1 to test(n/2) during an operation check test in the drive circuit 220. An operation check test is started by raising the signal TESTSP to a “H” level. A rise in the signal TESTCK causes the flip-flop DFF0 to recognize that the signal TESTSP is at a “H” level. This causes the flip-flops DFF0 to DFF(n/2) of the shift register 302 to output pulse signals in sequence as the test signals test0 to test(n/2) and the inversion test signals testB1 to testB(n/2) in synchronization with rises in the signal TESTCK.

See FIG. 17. At this point in time, when the test signal test0 is at a “H” level (i.e., when the inversion test signal testB0 is at a “L” level), the gate signals T1 to Tn all fall to a “L” level according to Math. 2, whereby each of the switches SWA1 to SWAn and SWB1 to SWBn comes to have its terminal 0 connected to its terminal 1. That is, the period of time during which the test signal test0 is at a “H” level is a period of time during which an operation check test is performed on the spare output circuits.

At this point in time, the spare hold circuits 7-A and 7-B have their input terminals connected to the test data bus, whereby the spare hold circuit 7-C receives through its gate a signal TSTR1 that is a sampling signal for use in operation check testing and the spare hold circuit 7-D receives through its gate a signal TSTR2 that is a sampling signal for use in operation check testing. These signals TSTR1 and TSTR2 correspond to the test gray-scale data shown in FIG. 16.

By setting gray-scale data in the test data bus and raising the signal TSTR1 to a “H” level, the spare hold circuit 7-A is made to retain the gray-scale data. Then, by setting different gray-scale data in the test data bus and raising the signal TSTR2 to a “H” level, the spare hold circuit 7-B can be made to retain the different gray-scale data. Since the gray-scale data retained in the spare hold circuit 7-A and the gray-scale data retained in the spare hold circuit 7-B are different from each other, the spare DAC circuits 8-C and 8-D output test output signals as different voltages.

This causes the spare operational amplifier 1-C to receive the test output signal from the spare DAC circuit 8-C through its positive input terminal and receive the test output signal from the spare DAC circuit 8-D through its negative input terminal. The spare operational amplifier 1-C operates as a comparator, and if the spare operational amplifier 1-C receives a higher input voltage through its positive input terminal than through its negative input terminal, the spare operational amplifier 1-C makes its output “H”, or in the reverse case, the spare operational amplifier 1-C makes its output “L”. Whether the output voltage of the spare operational amplifier 1-C is at a “H” or “L” level depending on the gray-scale data inputted to the spare DAC circuits 8-C and 8-B can be set in advance as an expected value.

Accordingly, the spare decision circuit 3-C determines whether or not the output of the spare operational amplifier 1-C matches the expected value and, if the output of the spare operational amplifier 1-C is different from the expected value, sends a “H” level signal to the spare decision flag 4-C. Similarly, the spare operational amplifier 1-D sends an output to the spare decision circuit 3-D, and the spare decision circuit 3-D compares the output with its expected value and sends a result of determination to the spare decision flag 4-D. Since the logical sum of the results of determination from the spare decision circuit 3-C and 3-D is a signal Flag0, the signal Flag0 rises to a “H” level if either of the results of determination in the spare operational amplifier 1-D and spare decision circuit 3-D indicates a “H” level.

This is how checking of operations of the spare output circuits is carried out. This checking of operations is substantially identical in concrete content to an operation check test of the first embodiment although the former is carried out by supplying gray-scale data to the hold circuits, while the latter is carried out by supplying gray-scale data to the DAC circuits.

Then, when the test signal test1 rises to a “H” level and the inversion test signal testB1 falls to a “L” level, the gate signals T1 to T(n/2) all rise to a “H” level according to Math. 2. This causes the sampling circuits 6-1 and 6-2 to be connected to the hold circuits 7-3 and 7-4, respectively, and also causes the connections of the other sampling circuits 6 to the other hold circuits 7 to be shifted forward in sequence. That is, the sampling circuit 6-h (h=1 to n−2) is connected to the hold circuit 7-(h+2), the sampling circuit 6-(n−1) to the hold circuit 7-C, and the last sampling circuit 6-n to the hold circuit 7-D.

Further, the output terminals OUT1 and OUT2 are connected to the operational amplifiers 1-3 and 1-4, respectively, and the connections of the other output terminals OUT to the other operational amplifiers 1 are also shifted forward in sequence. That is, the output terminal OUTh (h=1 to n−2) is connected to the operational amplifier 1-(h+2), the output terminal OUT(n−1) to the spare operational amplifier 1-A, and the last output terminal OUTn to the spare operational amplifier 1-B.

By thus changing the states of connection in the switches SWA and SWB, the sampling circuits 6-1 and 6-2 are disconnected from the hold circuits 7-1 and 7-2, respectively, and the output terminal OUT1 and OUT2 are disconnected from the operational amplifiers 1-1 and 1-2, respectively, whereby the hold circuit 7-1, the DAC circuit 8-1, the output terminal OUT1, the hold circuit 7-2, the DAC circuit 8-2, and the output terminal OUT2 become irrelevant to the driving of the display panel.

Since the test signal test1 is at a “H” level, those switches 2a and 2b connected to the input and output terminals of the operational amplifiers 1-1 and 1-2 become “ON” and “OFF”, respectively. The operational amplifier 1-1 comes to have its negative input terminal disconnected from its output terminal and connected to the DAC circuit 8-2. This connection allows the operational amplifier 1-1 to function as a comparator to compare the test output signals from the DAC circuits 8-1 and 8-2 and have its output connected to the decision circuit 3-1.

Similarly, the operational amplifier 1-2 comes to have its negative input terminal connected to the DAC circuit 8-1. This allows the operational amplifier 1-2 to function as a comparator to compare the test output signals from the DAC circuits 8-2 and 8-1 and have its output connected to the decision circuit 3-2. Further, the operational amplifiers 1-1 and 1-2 come to have their positive input terminals connected to the pull-up and pull-down circuits 5-1 and 5-2 as well as the DAC circuits 8-1 and 8-2, respectively.

The hold circuits 7-1 and 7-2 come to have their inputs switched from the sampling circuits 6-1 and 6-2 to the test data bus. This causes the hold circuits 7-1 and 7-2 to receive the signals TSTR1 and TSTR2 through their gates, respectively.

By setting gray-scale data in the test data bus and raising the signal TSTR1 to a “H” level, the hold circuit 7-1 is made to retain the gray-scale data. Then, by setting different gray-scale data in the test data bus and raising the signal TSTR2 to a “H” level, the hold circuit 7-2 can be made to retain the different gray-scale data. Since the gray-scale data retain in the spare hold circuit 7-1 and the gray-scale data retain in the spare hold circuit 7-2 are different from each other, the DAC circuits 8-1 and 8-2 output gray-scale voltage signals different from each other. The DAC circuits 8-1 and 8-2 output test output signals as different voltages.

This causes the operational amplifier 1-1 to receive the test output signal from the DAC circuit 8-1 through its positive input terminal and receive the test output signal from the DAC circuit 8-2 through its negative input terminal. The operational amplifier 1-1 operates as a comparator, and if the operational amplifier 1-1 receives a higher input voltage through its positive input terminal than through its negative input terminal, the operational amplifier 1-1 makes its output “H”, or in the reverse case, the operational amplifier 1-1 makes its output “L”. Whether the output voltage of the operational amplifier 1-1 is at a “H” or “L” level depending on the gray-scale data inputted to the DAC circuits 8-1 and 8-2 can be set in advance as an expected value.

Accordingly, the decision circuit 3-1 determines whether or not the output of the operational amplifier 1-1 matches the expected value and, if the output of the operational amplifier 1-1 is different from the expected value, sends a “H” level signal to the decision flag 4-1. Similarly, the operational amplifier 1-2 sends an output to the decision circuit 3-2, and the decision circuit 3-2 compares the output with its expected value and sends a result of determination to the decision flag 4-2. Since the logical sum of the results of determination from the decision circuit 3-1 and 3-2 is a signal Flag1, the signal Flag1 rises to a “H” level if either of the results of determination in the operational amplifier 1-2 and decision circuits 3-2 indicates a “H” level.

This is how checking of operations of the first and second columns of output circuits is carried out. During a period of time when the test signal test1 is “H”, a switch in state of connection in the switches SWA and SWB causes the sampling circuits 6-1 to 6-n, the hold circuits 7-3 to 7-n and spare hold circuits 7-C and 7-D, the DAC circuits 8-3 to 8-n and spare DAC circuits 8-C and 8-D, the operational amplifiers 1-3 to 1-n and spare operational amplifiers 1-C and 1-D, and the output terminals OUT1 to OUTn to be connected to one another, respectively. During this period of time, the operational amplifiers 1-3 to 1-n and spare operational amplifiers 1-C and 1-D function as buffers to amplify gray-scale voltages from the DAC circuits 8-3 to 8-n and spare DAC circuits 8-C and 8-D, respectively. This makes it possible to check the operations of the hold circuits 7-1 and 7-1, DAC circuits 8-1 and 8-2, and operational amplifiers 1-1 and 1-2 while driving the display panel 80.

The key to the present embodiment is the timing of a switch in state of connection. As described in (Normal Operation of the Drive Circuit 220), the drive circuit 220 constantly drives the display panel 80 and, even during data sampling, outputs display drive signals according to data retained in the hold circuits 7. In the drive circuit 220, there is no switch in connection between the hold circuits 7 and the DAC circuits 8, and a change in data of the hold circuits 7 is only made possible by the signal LS. A switch in state of connection by the test signals test causes a switch in state of connection between the DAC circuits 8 and the output terminals OUT but does not cause a switch in gray-scale data of the hold circuits 7. As a result, there occurs a defect in display. In order to prevent such a defect in display, it is necessary, in making a switch in state of connection by the test signals test, to input data from the sampling circuits 6 to the hold circuits 7 again by inputting the signal LS.

A possible concrete measure is to make the signal TESTCK, which is inputted to the AND gate AND1 shown in FIG. 18, a signal synchronized with the signal LS. This causes the shift register 302 to output the test signals test0 to test(n/2) at a “H” level in sequence every time the signal LS rises to a “H” level; therefore, the switch in state of connection by the test signals test is made in synchronization with the signal LS.

It should be noted that even signals that change logically at the same time will not change completely at the same time in an actual circuit due to a difference in load carrying capacity. However, since the hold circuits 7 load gray-scale data during a period of time when the signal LS is at a “H” level, it is only necessary to design circuitry so that the switch in state of connection by the test signals test and the loading of gray-scale data by the hold circuits 7 are completed within a period of time during which the signal LS is at a “H” level.

Next, when the test signal test2 rises to a “H” level and the inversion test signal testB2 falls to a “L” level, the gate signal T1 falls to a “L” level and the gate signals T2 to T(n/2) rise to a “H” level according to Math. 2. Since the gate signal T1 is at a “L” level, the sampling circuits 6-1 and 6-2 are connected to the hold circuits 7-1 and 7-2, respectively, as in the case of a normal operation.

Meanwhile, since the gate signals T2 to T(n/2) are at a “H” level, the sampling circuits 6-3 and 6-4 are connected to the hold circuits 7-5 and 7-6, respectively, and the connection of the other sampling circuits 6 to the other hold circuits 7 are also shifted forward in sequence. That is, the sampling circuit 6-f (f=3 to n−2) is connected to the hold circuit 7-(f+2), the sampling circuit 6-(n−1) to the spare hold circuit 7-C, and the last sampling circuit 6-n to the spare hold circuit 7-D.

Further, the output terminals OUT1 and OUT2 are connected to the operational amplifiers 1-1 and 1-2, respectively, as in the case of a normal operation. Meanwhile, the output terminals OUT3 and OUT4 are connected to the operational amplifiers 1-5 and 1-6, respectively, and the connections of the other output terminals OUT to the other operational amplifiers 1 are also shifted forward in sequence. That is, the output terminal OUTf (f=3 to n−2) is connected to the operational amplifier 1-(f+2), the output terminal OUT(n−1) to the spare operational amplifier 1-A, and the last output terminal OUTn to the spare operational amplifier 1-B.

By thus changing the states of connection in the switches SWA and SWB, the sampling circuits 6-3 and 6-4 are disconnected from the hold circuits 7-3 and 7-4, respectively, and the output terminal OUT3 and OUT4 are disconnected from the operational amplifiers 1-3 and 1-4, respectively, whereby the hold circuit 7-3, the DAC circuit 8-3, the output terminal OUT3, the hold circuit 7-4, the DAC circuit 8-4, and the output terminal OUT4 become irrelevant to the driving of the display panel 80.

Since the test signal test2 is at a “H” level, those switches 2a and 2b connected to the input and output terminals of the operational amplifiers 1-3 and 1-4 become “ON” and “OFF”, respectively. The operational amplifier 1-3 comes to have its negative input terminal disconnected from its output terminal and connected to the DAC circuit 8-4. This connection allows the operational amplifier 1-3 to function as a comparator to compare the test output signals from the DAC circuits 8-3 and 8-4 and have its output connected to the decision circuit 3-3.

Similarly, the operational amplifier 1-4 comes to have its negative input terminal connected to the DAC circuit 8-3. This allows the operational amplifier 1-4 to function as a comparator to compare the test output signals from the DAC circuits 8-4 and 8-3 and have its output connected to the decision circuit 3-4. Further, the operational amplifiers 1-3 and 1-4 come to have their positive input terminals connected to the pull-up and pull-down circuits 5-3 and 5-4 as well as the DAC circuits 8-3 and 8-4, respectively.

The hold circuits 7-3 and 7-4 come to have their inputs switched from the sampling circuits 6-3 and 6-4 to the test data bus. This causes the hold circuits 7-3 and 7-4 to receive the signals TSTR1 and TSTR2 through their gates, respectively.

By setting gray-scale data in the test data bus and raising the signal TSTR1 to a “H” level, the hold circuit 7-3 is made to retain the gray-scale data. Then, by setting different gray-scale data in the test data bus and raising the signal TSTR2 to a “H” level, the hold circuit 7-4 can be made to retain the different gray-scale data. Since the gray-scale data retained in the spare hold circuit 7-3 and the gray-scale data retained in the spare hold circuit 7-4 are different from each other, the DAC circuits 8-3 and 8-4 output gray-scale voltage signals different from each other. The DAC circuits 8-3 and 8-4 output test output signals as different voltages.

This causes the operational amplifier 1-3 to receive the test output signal from the DAC circuit 8-3 through its positive input terminal and receive the test output signal from the DAC circuit 8-4 through its negative input terminal. The operational amplifier 1-3 operates as a comparator, and if the operational amplifier 1-3 receives a higher input voltage through its positive input terminal than through its negative input terminal, the operational amplifier 1-3 makes its output “H”, or in the reverse case, the operational amplifier 1-3 makes its output “L”. Whether the output voltage of the operational amplifier 1-3 is at a “H” or “L” level depending on the gray-scale data inputted to the DAC circuits 8-3 and 8-4 can be set in advance as an expected value.

Accordingly, the decision circuit 3-3 determines whether or not the output of the operational amplifier 1-3 matches the expected value and, if the output of the operational amplifier 1-3 is different from the expected value, sends a “H” level signal to the decision flag 4-3. Similarly, the operational amplifier 1-4 sends an output to the decision circuit 3-4, and the decision circuit 3-4 compares the output with its expected value and sends a result of determination to the decision flag 4-4. Since the logical sum of the results of determination from the decision circuit 3-3 and 3-4 is a signal Flag2, the signal Flag2 rises to a “H” level if either of the results of determination in the operational amplifier 1-4 and decision circuits 3-4 indicates a “H” level. At this point in time, the waveforms of signals in the test signal generation circuit 53 shown in FIG. 18 come to look as described below.

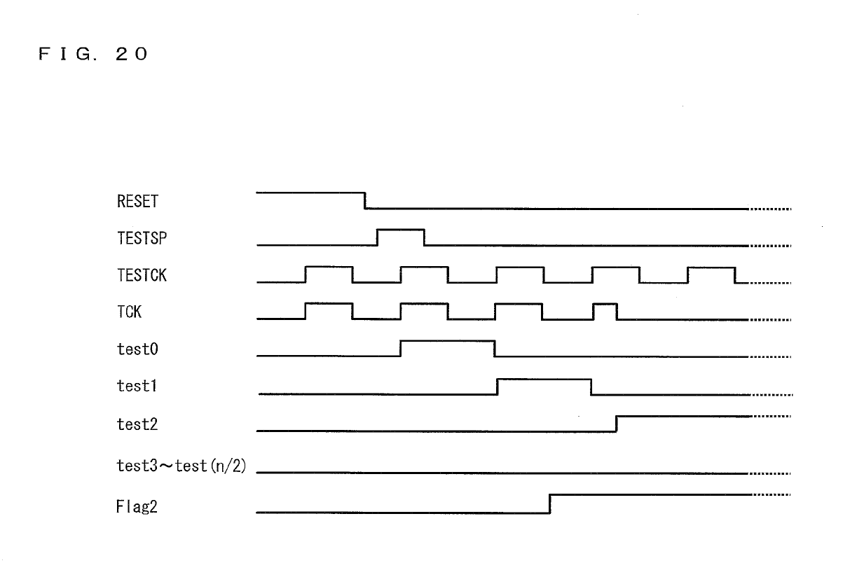

FIG. 20 shows the waveforms of a reset signal RESET, a signal TESTSP, a signal TESTCK, and test signals test1 to testn, and a signal Flag2. When the signal Flag 2 rises to a “H” level after the test signal test2 rises to a “H” level, the output signal FlagHB of the NOR gate NOR1 shown in FIG. 18 falls to a “L” level. For this reason, as shown in FIG. 20, the clock TCK by which the shift register 302 operates falls to a “L” level and is kept at that level. Accordingly, the test signal test2 is kept at a “H” level, and the inversion test signal testB2 is kept in a “L” state. This allows the display panel to be ongoingly driven in the state of connection established at the point in time when the signal Flag2 rose a “H” level. That is, the hold circuits 7 excluding the hold circuits 7-3 and 7-4, the DAC circuits 8 excluding the DAC circuits 8-3 and 8-4, and the operational amplifiers 1 excluding the operational amplifiers 1-3 and 1-4 carry out normal display driving. Therefore, the third and fourth columns of output circuits, which have now been determined to be defective in operation, drop out of use, and the other output circuits drive the display panel.

That is, during a period of time when the test signal test2 is at a “H” level, a switch in state of connection in the switches SWA and SWB causes the sampling circuits 6-1 to 6-n, the hold circuits 7-1, 7-2, and 7-5 to 7-n and spare hold circuits 7-C and 7-D, the DAC circuits 8-1, 8-2, and 8-5 to 8-n and spare DAC circuits 8-C and 8-D, the operational amplifiers 1-1, 1-2, and 1-5 to 1-n and spare operational amplifiers 1-C and 1-D, and the output terminals OUT1 to OUTn to be connected to one another, respectively. During this period of time, the operational amplifiers 1-1, 1-2, and 1-5 to 1-n and spare operational amplifiers 1-C and 1-D function as buffers to amplify gray-scale voltages from the DAC circuits 8-3 to 8-n and spare DAC circuits 8-C and 8-D, respectively. This makes it possible to check the operations of the hold circuits 7-3 and 7-4 and DAC circuits 8-3 and 8-4 while driving the display panel 80 by converting gray-scale data sent from the normal-operation data bus into gray-scale voltages and outputting them through the output terminals OUT.

This is how checking of operations of the third and fourth columns of output circuits and their self-repairing are carried out. During periods of time when the test signals test 3 to test(n/2) are at a “H” level, respectively, the checking of operations of all the output circuits is terminated by making a similar switch in state of connection. This process is substantially identical in content to an operation check test of the first embodiment although there are a few minor differences in circuitry when the signals Flag outputted from the decision flags 4 are all at a “L” level or when any of the signals Flag rises to a “H” level in the middle of the checking of operations.

### Embodiment 4

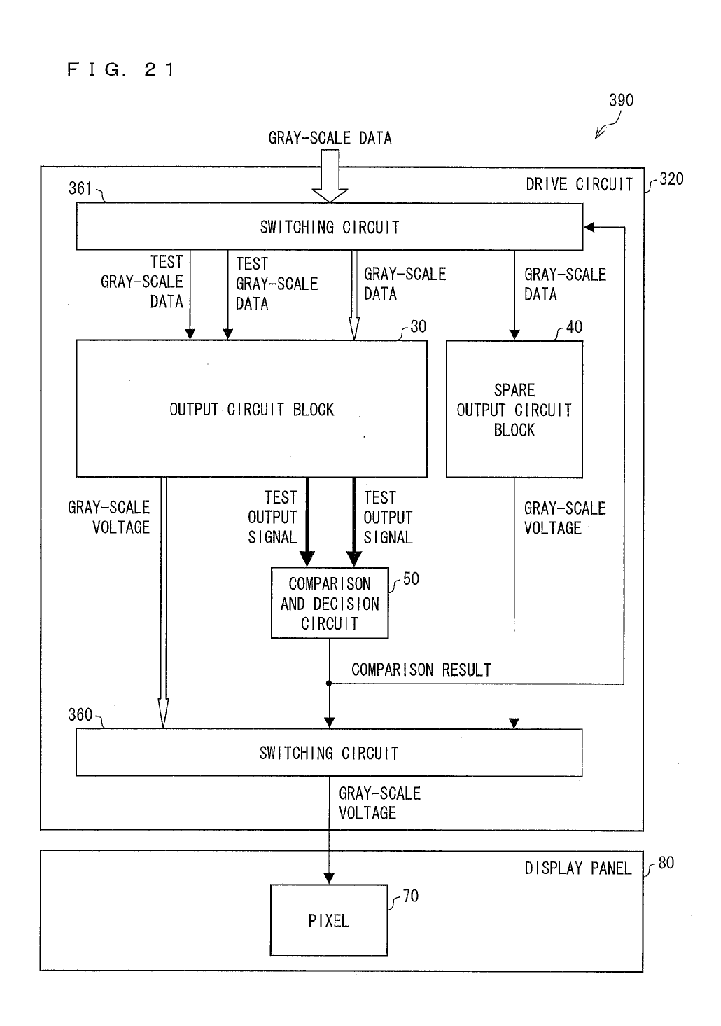

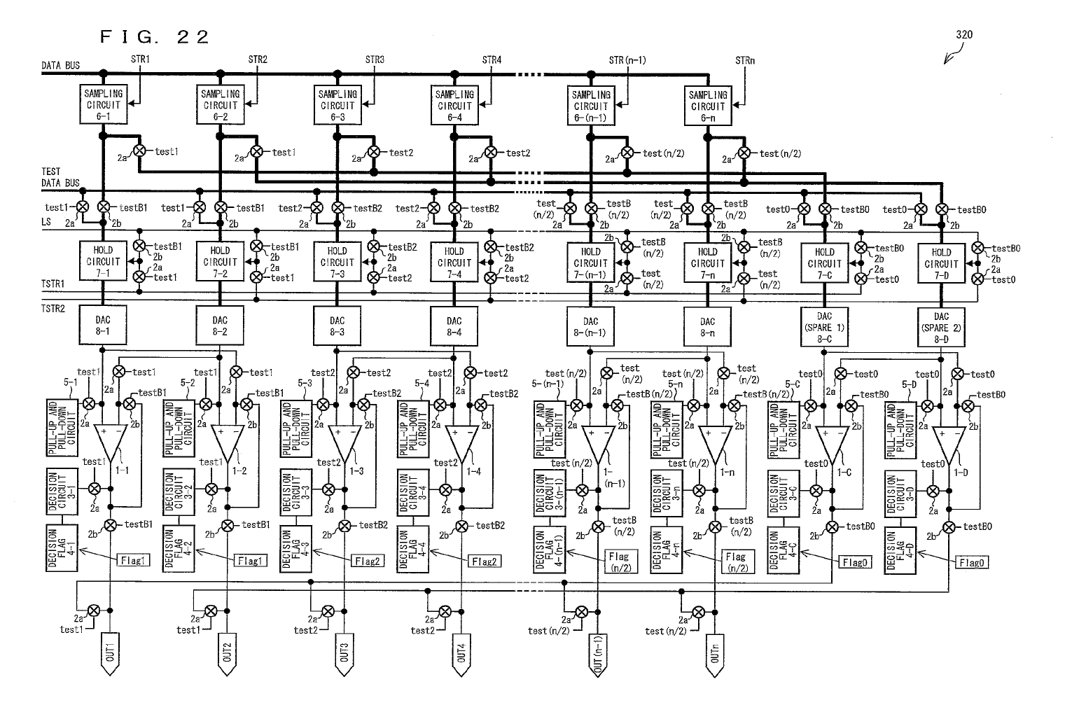

A fourth embodiment of the present invention is described below with reference to FIGS. 21 and 22. The present embodiment describes a display device 390, which is still another modification of the display device 90 according to the first embodiment.

(Configuration of the Display Device 390)

First, the configuration of the display device 390 according to the present embodiment is schematically described with reference to FIG. 21. FIG. 21 is a block diagram schematically showing the configuration of the display device 390. The display device 390 includes a display panel 80 and a drive circuit 320. The drive circuit 320 is configured by replacing the switching circuits 260 and 261 of the drive circuit 220 shown in FIG. 16 with switching circuits 360 and 361, respectively.

The drive circuit 220 according to the third embodiment is configured to shift connections forward in sequence so that gray-scale data which would during a normal operation be inputted to an output circuit whose operation is to be checked is inputted to an output circuit adjacent to the output circuit, that gray-scale data which would during the normal operation be inputted to the adjacent output circuit is inputted to a further adjacent output circuit, and, lastly, that gray-scale data which would during the normal operation be inputted to the last output circuit is inputted to a spare output circuit. Meanwhile, the drive circuit 320 according to the present embodiment is configured such that an output circuit whose operation is to be checked is disconnected from driving of the display panel by inputting, to a spare output circuit, gray-scale data which would during a normal operation be inputted to the output circuit whose operation is to be checked.

(Configuration of the Drive Circuit 320)

The configuration of the drive circuit 320 is described with reference to FIG. 22. FIG. 22 is a block diagram schematically showing the configuration of the drive circuit 320.

As shown in FIG. 22, the drive circuit 320 includes: n sampling circuits 6-1 to 6-n (hereinafter sometimes collectively referred to as “sampling circuits 6” in the present embodiment), which receive gray-scale data corresponding to n liquid crystal driving signal output terminals OUT1 to OUT n (hereinafter sometimes collectively referred to as “output terminals OUT” in the present embodiment) from a gray-scale data input terminal (not illustrated) through the data bus, respectively; n hold circuits 7-1 to 7-n and two spare hold circuits 7-C and 7-D (hereinafter sometimes collectively referred to as “hold circuits 7” in the present embodiment); n DAC circuits 8-1 to 8-n and two spare DAC circuits 8-C and 8-D (hereinafter sometimes collectively referred to as “DAC circuits 8” in the present embodiment), which convert gray-scale data into gray-scale voltage signals; n operational amplifiers 1-1 to 1-n and two spare operational amplifier 1-C and 1-D (hereinafter sometimes collectively referred to as “operational amplifiers 1” in the present embodiment), which serves as buffer circuits for the gray-scale voltage signals from the DAC circuits 8; n decision circuits 3-1 to 3-n and two spare decision circuits 3-C and 3-D (hereinafter sometimes collectively referred to as “decision circuits 3” in the present embodiment); n decision flags 4-1 to 4-n and two spare decision flags 4-C and 4-D (hereinafter sometimes collectively referred to as “decision flags 4” in the present embodiment); and n pull-up and pull-down circuits 5-1 to 5-n and two spare pull-up and pull-down circuits 5-C and 5-D (hereinafter sometimes collectively referred to as “pull-up and pull-down circuits 5” in the present embodiment).

Furthermore, as shown in FIG. 22, the drive circuit 320 includes: a plurality of switches 2a, which switch between ON and OFF according to test signals test (test0 to test(n−2)), respectively; and a plurality of switches 2b, which switch between ON and OFF according to inversion test signals testB (testB0 to testB(n−2)) obtained by inverting the test signals test, respectively. Each of the switches 2a and 2b becomes ON upon receiving a “H” level signal and becomes OFF upon receiving a “L” level signal. It should be noted that in the present embodiment, too, the test signals test and the inversion test signals testB are outputted from the test signal generation circuit 53 shown in FIG. 18, as in the third embodiment.

(Normal Operation of the Drive Circuit 320)

During a normal operation, as in the case of a normal operation in the third embodiment, the test signal test0 to test(n−2) are all at a “L” level, and the inversion test signals testB0 to testB(n−2) are all at a “H” level. Therefore, the sampling circuits 6-1 to 6-n are connected to the hold circuits 7-1 to 7-n, respectively, and the spare hold circuits 7-C and 7-D are not connected any of the sampling circuits 6.

See FIG. 22. In order to sample the gray-scale data supplied to the data bus, the sampling circuits 6-1 to 6-n receive sampling signals STR1 to STRn (hereinafter sometimes collectively referred to as “sampling signals STR” in the present embodiment) from a pointer shift register (not illustrated) through their gates as the sampling signals STR1 to STRn rise to a “H” level in sequence. The sampling circuits 6 are constituted by latch circuits that load the gray-scale data during a period of time when their gates are at a “H” level. During a period of time when the sampling signals are at a “H” level, the sampling circuits 6 load the data from the data bus, and during a period of time when the gate signals are at a “L” level, the sampling circuits retain the data loaded during the “H” level period.

After the sampling circuits 6-1 to 6-n have finished loading the data, a signal LS line connected to the hold circuits 7-1 to 7-n is supplied with a signal LS at a “H” level. At this point in time, the inversion test signals testB are all at a “H” level; therefore, the signal LS is supplied to the gates of the hold circuits 7-1 to 7-n, and during a period of time when the gates are at a “H” level, the hold circuits 7-1 to 7-n load the gray-scale data retained by the sampling circuits 6-1 to 6-n connected thereto, respectively. Further, the hold circuits 7-1 to 7-n retain the loaded gray-scale data after the signal LS has fallen to a “L” level.

This causes the DAC circuits 8-1 to 8-n to convert the gray-scale data retained in the hold circuits 7-1 to 7-n into gray-scale voltage signals and send them as gray-scale voltages to the positive input terminals of the operational amplifiers 1-1 to 1-n, respectively. It should be noted here that since the switches 2b are ON, the operational amplifiers 1-1 to 1-n have their outputs fed negatively back to their negative input terminals, respectively. This allows the operational amplifiers 1-1 to 1-n to function as voltage followers. As such, the operational amplifiers 1-1 to 1-n buffer the gray-scale voltages sent from the DAC circuits 8-1 to 8-n and send them to the corresponding output terminals OUT1 to OUTn, respectively.

(Outline of an Operation Check Test)

An operation check test is started by raising the signal TESTSP to a “H” level in the test signal generation circuit 53 shown in FIG. 18. This causes the test signals test0 to test(n/2) to rise to a “H” level in sequence as shown in FIG. 19

When the test signal test0 rises to a “H” level, the inversion test signal testB0 falls to a “L” level. Therefore, in the spare output circuits, the spare hold circuits 7-C and 7-D both come to have their input terminals connected to the test data bus. Meanwhile, in the other output circuits, the hold circuits 7-1 to 7-n are connected to the sampling circuits 6-1 to 6-n, respectively. Therefore, the display panel 80 is driven by the same output circuits as in the case of a normal operation. That is, as in the third embodiment, the period of time when the test signal test0 is at a “H” level is a period of time during which an operation check test is performed on the spare output circuits, and the checking of operations of the spare output circuits are identical in concrete content to that of the third embodiment.

Then, when the test signal test1 is raised to a “H” level and the inversion test signal testB1 is lowered to a “L” level, the sampling circuits 6-1 and 6-2 are connected to the spare hold circuits 7-C and 7-D, respectively. Meanwhile, the output terminals OUT1 and OUT2 are connected to the spare operational amplifiers 1-C and 1-D, respectively.

It should be noted here that in the present embodiment, there is no change in state of connection in the other output circuits even if the test signal test1 is raised to a “H” level. That is, even during a period of time when the test signal test1 is at a “H” level, the sampling circuits 6-3 to 6-n and the output terminals OUT3 to OUTn are connected to the hold circuits 7-3 to 7-n and the operational amplifiers 1-3 to 1-n, respectively, in the same manner as during a period of time when the test signal test0 is at a “H” level.

By thus changing the states of connection in the switches 2a and 2b, the sampling circuits 6-1 and 6-2 are disconnected from the hold circuits 7-1 and 7-2, respectively, and the output terminal OUT1 and OUT2 are disconnected from the operational amplifiers 1-1 and 1-2, respectively, whereby the hold circuit 7-1, the DAC circuit 8-1, the output terminal OUT1, the hold circuit 7-2, the DAC circuit 8-2, and the output terminal OUT2 become irrelevant to the driving of the display panel and checking of operations of the first and second columns of output circuits is carried out. It should be noted that this checking of operations are identical in concrete content to that of the third embodiment.

During this period of time, the sampling circuits 6-3 to 6-n, the hold circuits 7-3 to 7-n and spare hold circuits 7-C and 7-D, the DAC circuits 8-3 to 8-n and spare DAC circuits 8-C and 8-D, the operational amplifiers 1-3 to 1-n and spare operational amplifiers 1-C and 1-D, and the output terminals OUT1 to OUTn are connected to one another, respectively. Further, during this period of time, the operational amplifiers 1-3 to 1-n and spare operational amplifiers 1-C and 1-D function as buffers to amplify gray-scale voltages from the DAC circuits 8-3 to 8-n and spare DAC circuits 8-C and 8-D, respectively. This makes it possible to check the operations of the hold circuits 7-1 and 7-1, DAC circuits 8-1 and 8-2, and operational amplifiers 1-1 and 1-2 while driving the display panel 80.

As with the drive circuit 220 shown in FIG. 17, the drive circuit 320 shown in FIG. 22 makes a switch in gray-scale data input between the sampling circuits 6 and the hold circuits 7. For this reason, as mentioned in the third embodiment, the test signals test and the signal LS need to be signals synchronized with each other.

Next, when the test signal test2 is raised to a “H” level and the inversion test signal testB2 is lowered to a “L” level, the sampling circuits 6-3 and 6-4 are connected to the spare hold circuits 7-C and 7-D, respectively. Further, the output terminals OUT3 and OUT4 are connected to the spare operational amplifiers 1-C and 1-D, respectively.

By thus changing the states of connection in the switches 2a and 2b, the sampling circuits 6-3 and 6-4 are disconnected from the hold circuits 7-3 and 7-4, respectively, and the output terminal OUT3 and OUT4 are disconnected from the operational amplifiers 1-3 and 1-4, respectively, whereby the hold circuits 7-3 and 7-4, the DAC circuits 8-3 and 8-4, and the operational amplifiers 1-3 and 1-4 become irrelevant to the driving of the display panel 80.

This is how checking of operations of the third and fourth columns of output circuits and their self-repairing are carried out. During periods of time when the test signals test 3 to test(n/2) are at a “H” level, respectively, the checking of operations of all the output circuits is terminated by making a similar switch in state of connection. This process is substantially identical in content to an operation check test of the first embodiment although there are a few minor differences in circuitry when the signals Flag outputted from the decision flags 4 are all at a “L” level or when any of the signals Flag rises to a “H” level in the middle of the checking of operations.

### Embodiment 5

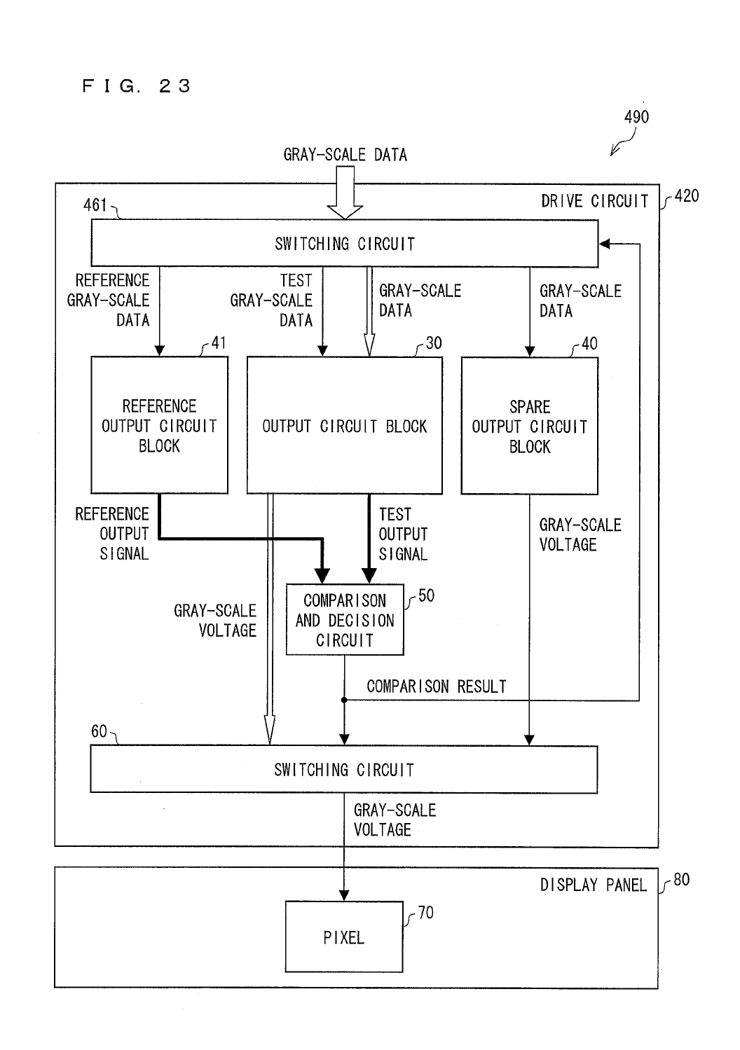

A fifth embodiment of the present invention is described below with reference to FIGS. 23 through 27. The present embodiment describes a display device 490, which is still another modification of the display device 90 according to the first embodiment.

(Configuration of the Display Device 190)

The configuration of the display device 490 according to the present embodiment is schematically described with reference to FIG. 23. FIG. 23 is a block diagram schematically showing the configuration of the display device 490. The display device 490 includes a display panel 80 and a drive circuit 420. The drive circuit 420 is configured by replacing the switching circuit 61 of the drive circuit 20 shown in FIG. 2 with a switching circuit 461.

The drive circuits 20, 120, 220, and 320 according to the first to fourth embodiments are each configured such that test gray-scale data and reference gray-scale data are supplied to the output circuit blocks through a dedicated test bus for use in an operation check test. On the other hand, the drive circuit 420 according to the present embodiment is configured such that test gray-scale data and reference gray-scale data are supplied to the output circuit blocks through a data bus through which gray-scale data is supplied during a normal operation.

(Configuration of the Drive Circuit 420)

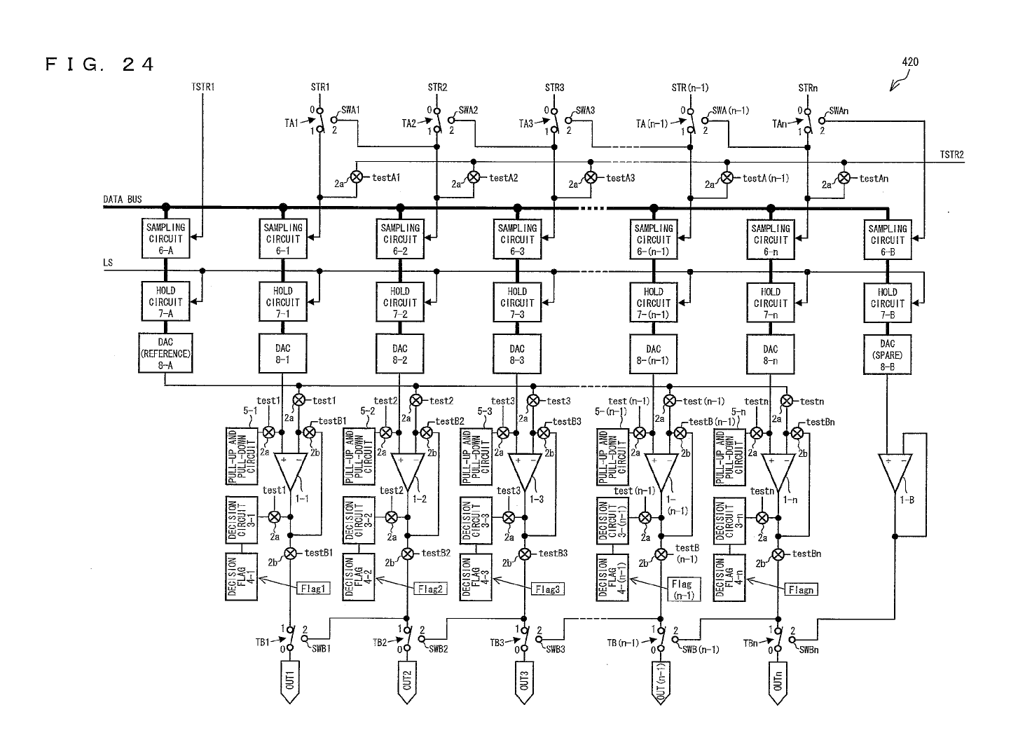

The configuration of the drive circuit 420 is described with reference to FIG. 24. FIG. 24 is a block diagram schematically showing the configuration of the drive circuit 420.

As shown in FIG. 24, the drive circuit 420 includes: n sampling circuits 6-1 to 6-n (hereinafter sometimes collectively referred to as “sampling circuits 6” in the present embodiment), which receive gray-scale data corresponding to n liquid crystal driving signal output terminals OUT1 to OUT n (hereinafter sometimes collectively referred to as “output terminals OUT” in the present embodiment) from a gray-scale data input terminal (not illustrated) through the data bus, respectively; a reference sampling circuit 6-A and a spare sampling circuit 6-B; n hold circuits 7-1 to 7-n (hereinafter sometimes collectively referred to as “hold circuits 7” in the present embodiment); a reference hold circuit 7-A and a spare hold circuit 7-B; n DAC circuits 8-1 to 8-n and a spare DAC circuit 8-B (hereinafter sometimes collectively referred to as “DAC circuits 8” in the present embodiment), which convert gray-scale data into gray-scale voltage signals; and a reference DAC circuit 8-A and a spare DAC circuit 8-B; n operational amplifiers 1-1 to 1-n and a spare operational amplifier 1-B (hereinafter sometimes collectively referred to as “operational amplifiers 1” in the present embodiment), which serves as buffer circuits for the gray-scale voltage signals from the DAC circuits 8; n decision circuits 3-1 to 3-n (hereinafter sometimes collectively referred to as “decision circuits 3” in the present embodiment); n decision flags 4-1 to 4-n (hereinafter sometimes collectively referred to as “decision flags 4” in the present embodiment); and n pull-up and pull-down circuits 5-1 to 5-n (hereinafter sometimes collectively referred to as “pull-up and pull-down circuits 5” in the present embodiment).

Furthermore, as shown in FIG. 24, the drive circuit 420 includes: a plurality of switches 2a, which switch between ON and OFF according to test signals test (test1 to testn) or test signals testA (testA1 to testAn), respectively; a plurality of switches 2b, which switch between ON and OFF according to inversion test signals testB (testB1 to testBn) obtained by inverting the test signals test, respectively; n switches SWA1 to SWAn (hereinafter sometimes collectively referred to as “switches SWA” in the present embodiment), which change connections according to gate signals TA1 to TAn, respectively; and n switches SWB1 to SWBn) (hereinafter sometimes collectively referred to as “switches SWB” in the present embodiment), which change connections according to the gate signals TB1 to TBn, respectively.

Each of the switches 2a and 2b becomes ON upon receiving a “H” level signal and becomes OFF upon receiving a “L” level signal.

Further, each of the switches SWA and SWB is a switch circuit which includes a terminal 0, a terminal 1, and a terminal 2 and which has two states of connection, namely a state of connection where the terminal 0 is connected to the terminal 1 and a state of connection where the terminal 0 is connected to the terminal 2. Specifically, the switch SWAk (k=1 to n) has its terminals 0 connected to the data bus through which sampling signals STR1 to STRn are supplied, and its terminal 1 to the sampling circuit 6-k. Further, the switches SWAi (i=1 to n−1) has its terminal 2 connected to the sampling circuit 6-(i+1), and the switch SWAn has its terminal 2 connected to the spare sampling circuit 6-B. Meanwhile, the switch SWBk (k=1 to n) has its terminals 0 and 1 connected to the output terminal OUTk and the output terminal of the operational amplifier 1-k, respectively. Further, the switch SWBi (i=1 to n−1) has its terminal 2 connected to the output terminal of the operational amplifier 1-(i+1), and the switch SWBn has its terminal 2 connected to the output terminal of the spare operational amplifier 1-B.

Further, the points of connection between the terminals 1 of the switches SWA1 to SWAn an the sampling circuits 6-1 to 6-n are connected through switches 2a to a data bus through which a signal TSTR2 serving as a sampling signal for use in an operation check test is supplied.

Each of the switches SWA and SWB switches its states of connection according to the value of a gate signal. Specifically, the terminal 0 is connected (conducted) to the terminal 2 when the gate signal is “H”, and the terminal 0 is connected (conducted) to the terminal 1 when the gate signal is “L”. The gate signals TA1 to TAn and the gate signals TB1 to TBn are represented by logical formulas shown in Math. 3 and Math. 4, respectively, as follows:

$$\begin{matrix}\begin{matrix}\begin{matrix}\begin{matrix}\begin{matrix}\begin{matrix}TA 1 = testA 1 \\ TA 2 = test A1 + testA 2\end{matrix} \\ TA 3 = testA 1 + testA 2 + testA 3\end{matrix} \\ ⋮\end{matrix} \\ TA ( n - 1 ) = testA 1 + testA 2 + testA 3 + … + testA ( n - 1 )\end{matrix} \\ TAn = testA 1 + testA 2 + testA 3 + … + testAn\end{matrix} & [ Math . 3 ] \\ \begin{matrix}\begin{matrix}\begin{matrix}\begin{matrix}\begin{matrix}TB 1 = test 1 \\ TB 2 = test 1 + test 2\end{matrix} \\ TB 3 = test 1 + test 2 + test 3\end{matrix} \\ ⋮\end{matrix} \\ TB ( n - 1 ) = test 1 + test 2 + test 3 + … + test ( n - 1 )\end{matrix} \\ TBn = test 1 + test 2 + test 3 + … + testn\end{matrix} & [ Math . 4 ]\end{matrix}$$

(Sampling of Gray-scale Data during a Normal Operation)

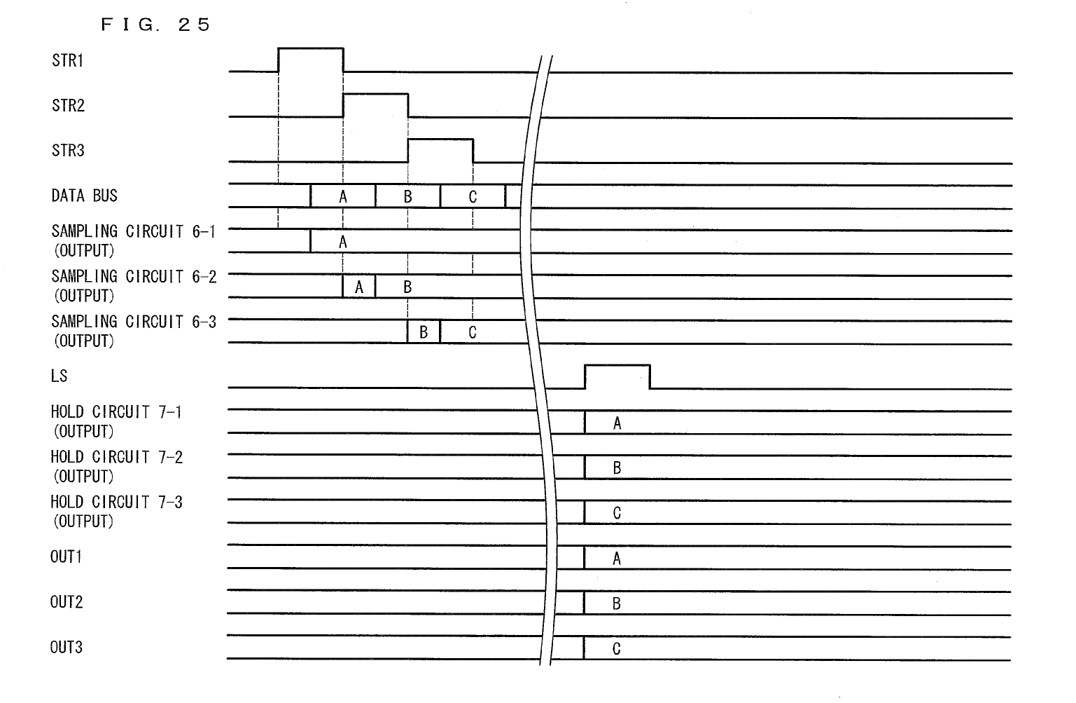

FIG. 25 shows the waveforms of sampling signals STR1 to STR3, outputs from sampling circuits 6-1 to 6-3, a signal LS, outputs from hold circuits 7-1 to 7-3, and outputs from output terminals OUT during an operation check test in the drive circuit 420. The sampling signals STR1 to STR3, which are pulse signals created by a pointer shift register (not illustrated), are sent to the gates of the sampling circuits 6-1 to 6-3, respectively, to control the operations of the sampling circuits 6-1 to 6-3. In FIG. 25, only the sampling signals up to STR3 are shown; however, in the drive circuit 420, the sampling signals STR1 to STRn are sent to the gates of the sampling circuits 6-1 to 6-n, respectively. It should be noted that a signal TSTR1 serving as a sampling signal for use in an operation check test is sent to the gate of the reference sampling circuit 6-A.

During a period of time when the sampling signal STR1 is at a “H” level, the sampling circuit 6-1 samples gray-scale data A from the data bus and sends it to the hold circuit 7-1. After the sampling signal STR1 falls to a “L” level, the sampling circuit 6-1 retains gray-scale data (the gray-scale data in FIG. 25) sampled immediately before the sampling signal STR1 rose to a “L” level. Similarly, the sampling signal STR2 determines gray-scale data to be retained in the sampling circuit 6-2, and the sampling signal STR3 determines gray-scale data that is to be retained in the sampling circuit 6-3.

When the sampling circuits 6-1 to 6-n finish retaining the data from the data bus, the signal LS is raised to a “H” level. The signal LS is sent to the gates of the hold circuits 7 to control the operations of the hold circuits 7. While the signal LS is at a “H” level, the hold circuits 7 load and retain the gray-scale data from the sampling circuits 6 connected thereto, respectively. Because, the hold circuits 7 retain the loaded data even after the signal LS falls to a “L” level, it is possible to continue to output, from the output terminals OUT, gray-scale voltages based on the gray-scale data retained by the hold circuits 7. It should be noted that as is clear from the above operation, it is usual for the data bus to be continuously supplied with display data, excluding a period of time during which LS is “H”.

(Sampling of Gray-scale Data during an Operation Check)

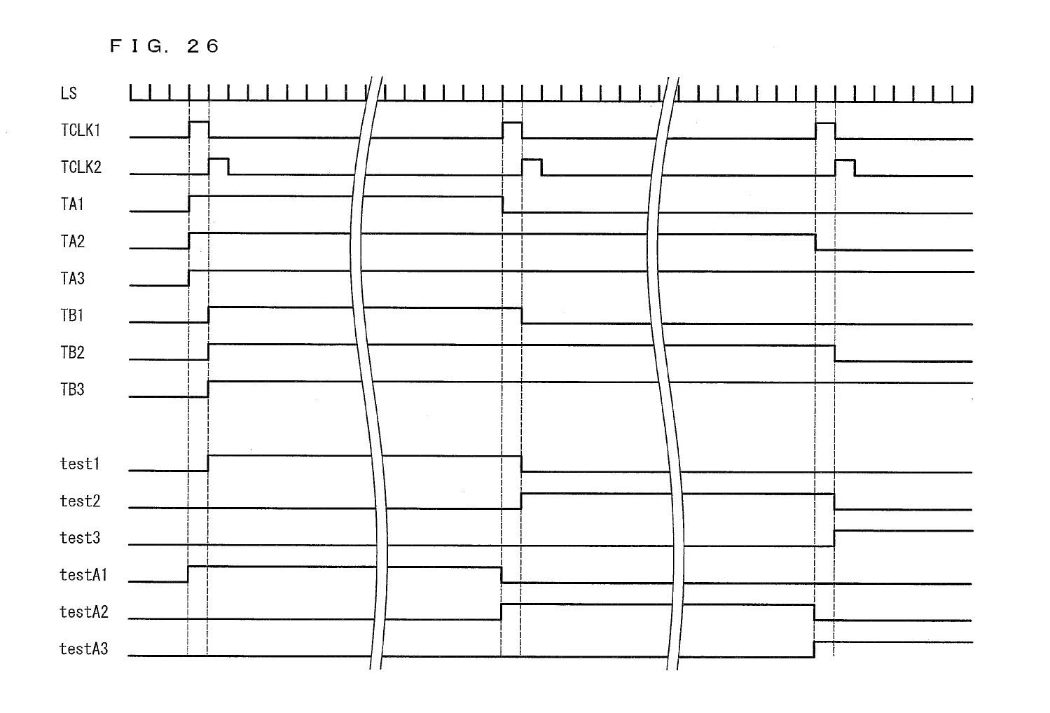

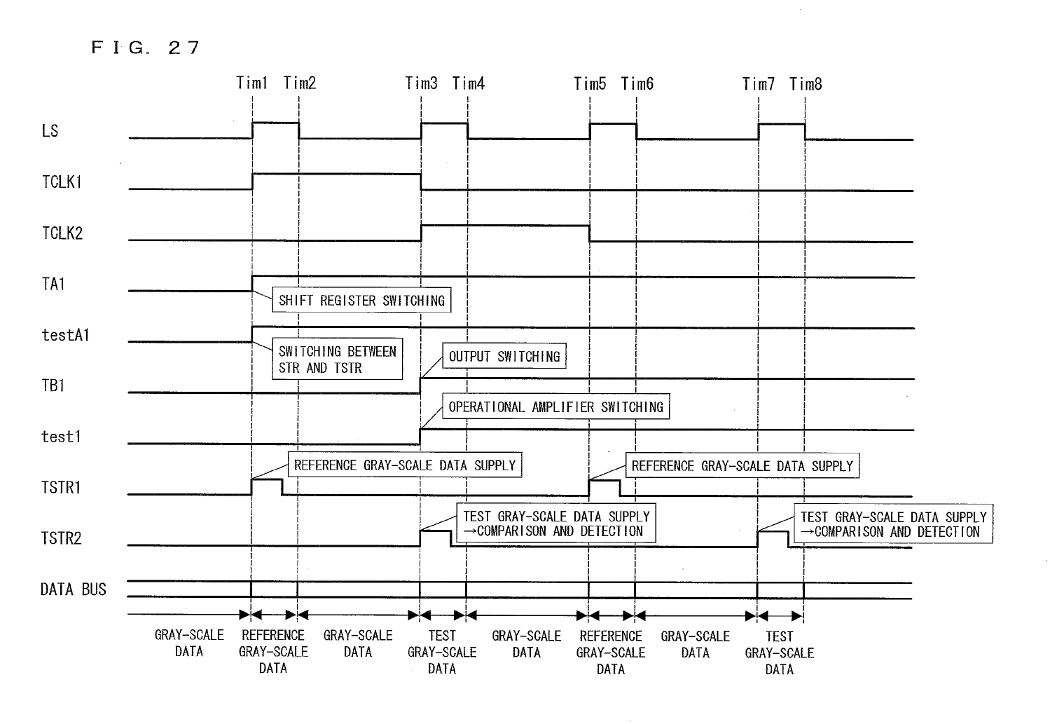

During an operation check test, the data bus is supplied reference gray-scale data and test gray-scale data as well as gray-scale data for use in normal display. The timing of supply of the gray-scale data for use in normal display, the reference gray-scale data, and the test gray-scale data is described with reference to FIGS. 26 and 27.

FIG. 26 shows the waveforms of the signal LS, the signals TCLK1 and TCLK2, the gate signals TA1 to TA3 and TB1 to TB3, the test signals test1 to test3, and the test signals testA1 to testA3.

Each of the signals TCLK1 and TCLK2 shown in FIG. 26 is a signal that rises to a “H” level every time the signal LS is counted a predetermined number of times. The test signals test1 to testn rise to a “H” level in sequence every time the test signal TCLK2 rises. Such test1 to testn can be generated by a circuit similar to the shift register 301 shown in FIG. 4.

Detection of a failure in the sampling circuit 6-1, the hold circuit 7-1, the DAC circuit 8-1, and the operational amplifier 1-1 is described here with reference to FIG. 27.

FIG. 27 shows the waveforms of the signal LS, the signals TCLK1 and TCLK2, the gate signal TA1, the test signal testA1, the gate signal TB1, the test signal test1, and the signals TSTR1 and TSTR2 before and after a period of time during which the signals TCLK1 and TCLK2 shown in FIG. 26 rise a “H” level alternately. Until the timing Tim1, at which the signal LS rises first, these signals are all at a “L” level, and the data bus is supplied with gray-scale data for use in normal driving.

(Timing Tim1)

At the timing Tim1, at which the signal LS rises first, the drive circuit 420 shown in FIG. 24 operates as follows:

(1) The signal LS rises to a “H” level, and the gray-scale data retained in the sampling circuits 6 is transferred to the hold circuits 7.

(2) The test signal testA1 rises to a “H” level, and the gate signals TA1 to TAn switch from a “L” level to a “H” level according to Math. 3. This causes each of the switches SWA1 to SWAn to connect its terminal 0 to its terminal 2, whereby the sampling signals STRi (i=1 to n−1) are inputted to the sampling circuits 6-(i+1) and the sampling signal STRn is inputted to the spare sampling circuit 6-B.

(3) The data bus is supplied with reference gray-scale data for use in self-detection instead of being supplied with gray-scale data for use in normal driving.

(4) When the signal TSTR1, which is inputted to the gate of the reference sampling circuit 6-A, is raised to a “H” level, the reference sampling circuit 6-A loads the reference gray-scale data from the data bus. Since the signal LS, which is inputted to the reference hold circuit 7-A, is at a H″ level, the reference sampling circuit 6-A sends the reference gray-scale data to the reference hold circuit 7-A simultaneously, and the reference hold circuit 7-A retains the reference gray-scale data.

(Timing Tim2)

Then, at the timing Tim2, at which the signal LS falls, there is no change in connection between the hold circuits 7 and the DAC circuits 8; therefore, the gray-scale data retained in the hold circuit 7-1 is converted by the DAC circuit 8-1 into a gray-scale voltage, and the gray-scale voltage is outputted from the output terminal OUT1. The gray-scale voltage that is outputted from the output terminal OUT1 is identical to a gray-scale voltage that is outputted from the output terminal OUT1 with the retention of a connection between the sampling circuit 6-1 and the output terminal OUT1 prior to the timing Tim1. Similarly, those gray-scale voltages from the output terminals OUT2 to OUTn are identical to gray-scale voltages that are outputted from the output terminals OUT2 to OUTn with the retention of connections between the sampling circuits 6-2 to 6-n and the output terminals OUT2 to OUTn prior to the timing Tim1, respectively.

(Timing Tim3)

At the timing Tim3, at which the signal LS rises next, the drive circuit 420 shown in FIG. 24 operates as follows:

(1) The signal LS rises to a “H” level, and the gray-scale data retained in the sampling circuits 6 is transferred to the hold circuits 7.

(2) The test signal test1 rises to a “H” level, and the gate signals TB1 to TBn switch from a “L” level to a “H” level according to Math. 4. This causes each of the switches SWB1 to SWBn to connect its terminal 0 to its terminal 2, whereby the output terminals OUTi (i=1 to n−1) receive inputs from the operational amplifiers 1-(i+1) and the output terminal OUTn receive an input from the spare operational amplifier 1-B. Thus, the sampling circuit 6-1, the hold circuit 7-1, the DAC circuit 8-1, and the operational amplifier 1-1 become irrelevant to the driving of the display panel 80.

(3) The data bus is supplied with test gray-scale data for use in self-detection instead of being supplied with the gray-scale data for use in normal driving.

(4) Since the signal TSTR2 rises to a “H” level and the test testA1 is at a “H” level, the signal TSTR2 is inputted to the gate of the sampling circuit 6-1, whereby the sampling circuit 6-1 loads the test gray-scale data from the data bus. Further, since the signal LS, which is inputted to the hold circuit 7-1, is at a “H” level, the sampling circuit 6-1 sends the test gray-scale data to the hold circuit 7-1 simultaneously, and the hold circuit 7-1 retains the test gray-scale data.

(5) Since the test signal test1 is at a “H” level and the inversion test signal testB1 is at a “L” level, the operational amplifier 1-1 functions as a comparator. This allows the operational amplifier 1-1 to receive a test output signal from the DAC circuit 8-1 through its positive input terminal and receive a reference output signal from the reference DAC circuit 8-A through its negative input terminal.

(6) The operational amplifier 1-1 sends its output to the decision circuit 3-1, and the decision circuit 3-1 compares the output of the operational amplifier 1-1 with an expected value stored in the decision circuit 3-1. The expected value can be set based on the reference gray-scale data and the test gray-scale data. This allows detection of a failure in the first column of output circuits.

Since the sampling circuit 6-1, the hold circuit 7-1, the DAC circuit 8-1, and the operational amplifier 1-1 are irrelevant to the driving of the display panel 80 during a period of time between the timing Tim3 and the timing Tim4, at which the signal LS falls next, it becomes possible to check the functional operation of the first column of output circuit while driving the display panel 80.

(Timing Tim4)

The data bus is supplied with the gray-scale data for use in normal driving instead of being supplied with the test gray-scale data. It should be noted that the drive circuit 420 continues the output of gray-scale voltages to the display panel in the state of connection established at the timing Tim3.

(Timing Tim5)

At the timing Tim5, at which the signal LS rises further next, the data bus is supplied with reference gray-scale data instead of being supplied with the gray-scale data for use in normal driving. Further, the signal TSTR1, which is inputted to the gate of the reference sampling circuit 6-A, rises to a “H” level again, and the reference gray-scale data is retained in the reference sampling circuit 6-A and the reference hold circuit 7-A.

(Timing Tim6)

At the timing Tim6, at which the signal LS falls after the timing Tim5, the data bus is supplied with the gray-scale data for use in normal driving instead of being supplied with the reference gray-scale data. The drive circuit 420 continues the output of gray-scale voltages to the display panel in the state of connection established at the timing Tim3.

(Timing Tim7)

At the timing Tim7, at which the signal LS rises after the timing Tim6, the data bus is supplied with test gray-scale data instead of being supplied with the gray-scale data for use in normal driving. At the same time, the signal TSTR2 is raised to a “H” level to cause the sampling circuit 6-1 and the hold circuit 7-1 to retain the test gray-scale data, whereby the reference gray-scale data is retained in the reference hold circuit 7-A and the test gray-scale data is retained in the hold circuit 7-1, as in the case of the timing Tim3. The operational amplifier 1-1 functions as a comparator to detect a failure in the first column of output circuits as in the case of the timing Tim3.

It should be noted here by causing the reference gray-scale data and test gray-scale data that are supplied to the data bus at the timings and Tim 5 and Tim7 to be different from those supplied to the data bus at the timings Tim1 and Tim3, the detection of a failure in the first column of output circuits can be carried out a plurality of times by using different reference gray-scale data and test gray-scale data. The number of times reference gray-scale data and test gray-scale data can be changed is determined by the number times the signal LS is generated as included in the cycles of the signals TCLK1 and TCLK2. Therefore, the number of times needs only be determined by appropriately changing circuits for generating the signals TCLK1 and TCLK2 and the signal LS.

Since, as shown in FIG. 26, the test signal testA2 rises when the signal TCLK1 rises for the second time, the connection between the data bus, which supplies the sampling signals STR, and the sampling circuits 6 is changed, so that a change is made from checking the operation of an output circuit to checking the operation of another output circuit. By thus changing from checking the operation of an output circuit to checking the operation of another output circuit in sequence and comparing them with the reference output circuit, detection of a failure can be carried out for each of the output circuits.

Although, in the drive circuit 420 shown in FIG. 24, the reference sampling circuit 6-A connected to the reference DAC circuit 8-A is connected to the same data bus as the other sampling circuits 6, it is possible to provide, separately from such a common data bus, a dedicated data bus to which the reference sampling circuit 6-A is connected.

However, as for the sampling circuits 6-1 to 6-n, hold circuits 7-1 to 7-n, and DAC circuits 8-1 to 8-n, whose operations are to be checked, provision of a dedicated data bus causes an increase in space that is occupied by a chip. Therefore, in term of space that is occupied by a chip, it is advantageous to use a common data bus.

However, if a dedicated data bus to which the reference sampling circuit 6-A is connected is provided separately from the common data bus, a chip on which the drive circuit 420 has been mounted will occupy more space. Therefore, if both the reference sampling circuit 6-A and the sampling circuits 6-1 to 6-n are connected to a common data bus, the chip will occupy less space. However, since the reference DAC circuit 8-A is not used for driving of the display panel 80 and the drive circuit 420 is provided with only one such reference DAC circuit 8-A, provision of a dedicated data bus to which the reference sampling circuit 6-A is connected does not causes a big increase in space that is occupied by the chip. Therefore, it not necessary to connect both the reference sampling circuit 6-A and the sampling circuits 6-1 to 6-n to a common data bus.

Further, provision of a dedicated data bus to which the reference sampling circuit 6-A is connected makes it unnecessary to supply reference gray-scale data at the timing Tim5 shown in FIG. 27. Therefore, since detection of a failure in an output circuit can be carried out a plurality of times by supplying, at the timing Tim5, test gray-scale data different from the test gray-scale data supplied at the timing Tim3, it becomes possible to shorten a period of time for an operation check test.

### General Overview of the Embodiments

Each of Embodiments 1 and 2 above includes normal output circuits, a spare output circuit, and a reference output circuit, compares the output circuits while driving a display panel and, by switching connections between DAC circuits and hold circuits and between operational amplifiers and output terminals, changes from using one group of output circuits to using another to drive the display panel. Further, each of Embodiments 3 and 4 includes normal output circuits and spare output circuits, compares the output circuits while driving a display panel and, by switching connections between sampling circuits and hold circuits and between operational amplifiers and output terminals, changes from using one group of output circuits to using another to drive the display panel. Embodiment 5 includes normal output circuits, a spare output circuit, and a reference output circuit, compares the output circuits while driving a display panel and, by switching connections between a data bus and sampling circuits and between operational amplifiers and output terminals, changes from using one group of output circuits to using another to drive the display panel.

However, the change from using one group of output circuits to using another to drive the display panel is not limited to Embodiments 1 to 5. For example, it is possible to include normal output circuits, a spare output circuit, and a reference output circuit, compares the output circuits while driving a display panel and, by switching connections between sampling circuits and hold circuits and between operational amplifiers and output terminals, changes from using one group of output circuits to using another to drive the display panel. Alternatively, it is possible to include normal output circuits and spare output circuits, compares the output circuits while driving a display panel and, by switching connections between hold circuits and sampling circuits and between operational amplifiers and output terminals, changes from using one group of output circuits to using another to drive the display panel. The method for changing from using one group of output circuits to using another to drive a display panel can be varied appropriately within such a range as to be able to compare the output circuits while driving the display panel.

Further, although each of Embodiments 1, 2, and 5 is configured to select one from among the normal output circuits and compare the selected output circuit with the reference output circuit, and the number of output circuits that are selected may range from 2 to n. Further, although each of Embodiments 3 and 4 is configured to select two output circuits from among the normal output circuits and compare the selected output circuits with each other, the number of output circuits that are selected may range from 4 to n. In either case, by providing the same number of spare output circuits as the number of output circuits that are selected and changing from connecting the selected output circuits to the output terminals to connecting the spare output circuits to the output terminals, checking of operations can be carried out without causing a defect in display.

In each of Embodiments 1, 2, and 5, when the number output circuits that are selected is two or greater, there may be provided two or more reference output circuits or only one reference output circuit. When the number output circuits that are selected is two or greater and there is provided only one reference output circuit, it is possible to compare the selected output circuits one by one with the reference circuit by changing from one of the selected output circuits to another or to compare them at the same time by connecting the reference output circuits to a plurality of comparing means.

Further, although each of the embodiments above is configured such that each output circuit outputs a gray-scale voltage, this does not imply any limitation. In the case of a liquid crystal display device of the STN type, each output circuit may be configured to output a video signal other than a gray-scale voltage.

The present invention is not limited to the description of the embodiments above, but may be altered by a skilled person within the scope of the claims. An embodiment based on a proper combination of technical means disclosed in different embodiments is encompassed in the technical scope of the present invention.

### INDUSTRIAL APPLICABILITY

The present invention provides a display device including a display driving integrated circuit which has concrete means for detecting and self-repairing a defect in an output circuit and which can deal with a failure in the output circuit more easily. In particular, the present invention is suitable to a liquid crystal display device capable of carrying out self-detection and self-repairing without causing a defect in display while normally driving a display panel. Further, the present invention is applicable to other types of display devices as well as liquid crystal display devices.

### REFERENCE SIGNS LIST

1-1 to 1-n, 1-A to 1-D Operational amplifier
3-1 to 3-n, 3-C, 3-D Decision circuit (decision means)
6-1 to 6-n, 6-A, 6-B Sampling circuit
7-1 to 7-n, 7-A to 7-D Hold circuit
8-1 to 8-n, 8-A to 8-D DAC circuit (digital-analog converter)
10 Source driver (drive circuit)
20, 120, 220, 320, 420 Driver circuit
30 Output circuit block (first output circuit)
40 Spare output circuit block (second output circuit)
41 Reference output circuit block (third output circuit)
50 Comparison and decision circuit (comparing means, decision means, self-detecting and self-repairing means)
60, 160, 260, 360 Switching circuit (switching means, self-detecting and self-repairing means)
61, 161, 261, 361, 461 Switching circuit (control means, self-detecting and self-repairing means)
80 Display panel
90, 190, 290, 390, 490 Display device
SWA1 to SWAn Switch (control circuit)
SWB1 to SWBn Switch (switching circuit)
TDATA Test data bus (data bus)

1.-23. (canceled)

24. A drive circuit having n (where n is a natural number of 2 or greater) output terminals through which video signals are outputted to a display device and means for detecting and repairing a defect in the drive circuit, the drive circuit comprising:
n first output circuits, connected disconnectably to the output terminals, which convert input data into video signals;
p or more (where p is a natural number of 1 to n) second output terminals, connected disconnectably to the output terminals, which convert input data into video signals;
a third output circuit, not connected to any of the output terminals, which coverts input data into a video signal;
switching means for selecting p output circuit(s) from among the first output circuits, disconnecting the p output circuit(s) from the output terminal(s), and connecting p output circuit(s) from among the second output circuits to the output terminal(s);
comparing means for comparing the video signal from the first output circuit thus selected or each of the video signals from the first output circuits thus selected with the video signal from the third output circuit; and
decision means for determining, in accordance with a comparison result sent from the comparing means, whether the first output circuit thus selected or any of the first output circuits thus selected is defective or not.

25. The drive circuit as set forth in claim 24, wherein when the switching means selects the qth to q+p−1th (where q+p−1 is a natural number that is less than or equal to n) ones of the first output circuits, the switching means connects the rth (where r is a natural number that is less than q) one of the first output circuits to the rth one of the output terminals, connects the s+pth (where s is a natural number of q to n−p) one of the first output circuits to the sth one of the output terminals, and connects the second output circuit(s) to the tth (t is a natural number that is greater than n−p and less than or equal to n) one of the output terminals.

26. The drive circuit as set forth in claim 24, wherein the switching means connects the second output circuit(s) to the output terminal(s) from which the first output circuit(s) thus selected has/have been disconnected.

27. The drive circuit as set forth in claim 24, further comprising control means for inputting the input data to the first to third output circuits through a data bus through which the input data is supplied, wherein
the control means carries out control so that the input data that is inputted to the first output circuit(s) thus selected and the input data that is inputted to the third output circuit take on different values.

28. The drive circuit as set forth in clam 27, wherein:
the data bus is constituted by first to third data buses; and
the control means inputs the input data through the first data bus to the first output circuits excluding the first output circuit(s) thus selected and to the second output circuit(s), inputs the input data through the second data bus to the first output circuit(s) thus selected, and inputs the input data through the third data bus to the third output circuit.

29. The drive circuit as set forth in claim 27, wherein the control means inputs the input data to the first to third output circuits through a single data bus.

30. The drive circuit as set forth in claim 24, wherein:
the video signals are gray-scale voltages and the first to third output circuits include digital analog converters that convert the input data into the gray-scale voltages; and
the comparing compares the gray-scale voltage(s) from the digital analog converter(s) included in the first output circuit(s) thus selected with the gray-scale voltage from the digital analog converter included in the third output circuit.

31. The drive circuit as set forth in claim 30, wherein:
the first output circuits include operational amplifiers as output buffers for the digital analog converters;
each of the operational amplifiers operates as a comparator when that one of the first output circuits which includes that operational amplifier is selected by the switching means and is not connected to any one of the output terminals; and
the comparing means is an operational amplifier that operates as the comparator.

32. The drive circuit as set forth in claim 31, wherein the third output circuit is connected to the operational amplifier that operates as the comparator.

33. The drive circuit as set forth in claim 31, wherein each of the operational amplifiers operates as a voltage follower when that one of the first output circuits which includes that operational amplifier is connected to one of the output terminals.

34. The drive circuit as set forth in claim 24, wherein the decision means has a comparison result from the comparing means stored therein as an expected value in association with the input data inputted to the first output circuit thus selected or each of the first outputs thus selected and the third output circuit and, when the comparison result and the expected value are different, determines that the first output circuit thus selected is defective.

35. A drive circuit having n (where n is a natural number of 2 or greater) output terminals through which video signals are outputted to a display device and means for detecting and repairing a defect in the drive circuit, the drive circuit comprising:
n first output circuits, connected disconnectably to the output terminals, which convert input data into video signals;
u or more (where u is an even number of 2 to n) second output terminals, connected disconnectably to the output terminals, which convert input data into video signals;
switching means for selecting u output circuits from among the first output circuits, disconnecting the u output circuits from the output terminals, and connecting u output circuits from among the second output circuits to the output terminals;
comparing means for, with any two of the first output circuits thus selected serving as first and second selected output circuits respectively, comparing the video signal from the first selected output circuit and the video signal from the second selected output circuit; and
decision means for determining, in accordance with a comparison result sent from the comparing means, whether any of the first output circuits thus selected is defective or not.

36. The drive circuit as set forth in claim 35, wherein when the switching means selects the with to v+u−1th (where v+u−1 is a natural number that is less than or equal to n) ones of the first output circuits, the switching means connects the wth (where w is a natural number that is less than v) one of the first output circuits to the wth one of the output terminals, connects the x+uth (where x is a natural number of v to n−u) one of the first output circuits to the xth one of the output terminals, and connects the second output circuit(s) to the yth (y is a natural number that is greater than n−u and less than or equal to n) one of the output terminals.

37. The drive circuit as set forth in claim 35, wherein the switching means connects the second output circuits to the output terminals from which the first output circuits thus selected have been disconnected.

38. The drive circuit as set forth in claim 35, further comprising control means for inputting the input data to the first and second output circuits, wherein
the control means carries out control so that the input data that is inputted to the first selected output circuit and the input data that is inputted to the second selected output circuit take on different values.

39. The drive circuit as set forth in claim 35, wherein:
the video signals are gray-scale voltages and the first output circuits include digital analog converters that convert the input data into the gray-scale voltages; and
the comparing means compares the gray-scale voltage from the digital analog converter included in the first selected output circuit and the gray-scale voltage from the digital analog converter included in the second selected output circuit.

40. The drive circuit as set forth in claim 39, wherein:
the first output circuits include operational amplifiers as output buffers for the digital analog converters;
each of the operational amplifiers operates as a comparator when that one of the first output circuits which includes that operational amplifier is selected by the switching means and is not connected to any one of the output terminals; and
the comparing means is an operational amplifier that operates as the comparator.

41. The drive circuit as set forth in claim 40, wherein each of the operational amplifiers operates as a voltage follower when that one of the first output circuits which includes that operational amplifier is connected to one of the output terminals.

42. The drive circuit as set forth in claim 35, wherein the decision means has a comparison result from the comparing means stored therein as an expected value in association with the input data inputted to the first selected output circuit and the second selected output circuit and, when the comparison result and the expected value are different, determines that the first output circuit thus selected is defective.

43. The drive circuit as set forth in claim 39, further comprising control means for inputting the first and second output circuits, wherein:
the control means carries out control so that the input data that is inputted to the first selected output circuit and the input data that is inputted to the second selected output circuit take on different values; and
the first output circuits include (i) sampling circuits that load the input data in a time-sharing manner and retain the input data and (ii) hold circuits that load in a time-sharing manner the input data retained in the sampling circuits and output the input data to the digital analog converters; and
the control means inputs the input data to the sampling circuits during normal driving and, during self-detection, inputs the input data to the digital analog converters of the first output circuits thus selected.

44. A display device comprising a drive circuit as set forth in claim 24.

45. A display device comprising a drive circuit as set forth in claim 35.

46. A self-detecting and self-repairing method for detecting and repairing a defect in a drive circuit including (i) n (where n is a natural number of 2 or greater) output terminals through which video signals are outputted to a display device, (ii) n first output circuits, connected disconnectably to the output terminals, which convert input data into video signals, (iii) p or more (where p is a natural number of 1 to n) second output terminals, connected disconnectably to the output terminals, which convert input data into video signals, and (iv) a third output circuit, not connected to any of the output terminals, which coverts input data into a video signal, the self-detecting and self-repairing method comprising:
a switching step of selecting p output circuit(s) from among the first output circuits, disconnecting the p output circuit(s) from the output terminal(s), and connecting p output circuit(s) from among the second output circuits to the output terminal(s);
a comparing step of comparing the video signal from the first output circuit thus selected or each of the video signals from the first output circuits thus selected with the video signal from the third output circuit; and
a decision step of determining, in accordance with a comparison result of the comparing step, whether the first output circuit thus selected or any of the first output circuits thus selected is defective or not.

47. A self-detecting and self-repairing method for detecting and repairing a defect in a drive circuit including (i) n (where n is a natural number of 2 or greater) output terminals through which video signals are outputted to a display device, (ii) n first output circuits, connected disconnectably to the output terminals, which convert input data into video signals; (iii) u or more (where u is an even number of 2 to n) second output terminals, connected disconnectably to the output terminals, which convert input data into video signals, the self-detecting and self-repairing method comprising:
a switching step of selecting u output circuits from among the first output circuits, disconnecting the u output circuits from the output terminals, and connecting u output circuits from among the second output circuits to the output terminals;
a comparing step of, with any two of the first output circuits thus selected serving as first and second selected output circuits respectively, comparing the video signal from the first selected output circuit and the video signal from the second selected output circuit; and
a decision step of determining, in accordance with a comparison result of the comparing step, whether any of the first output circuits thus selected is defective or not.
